(19) United States
(12) Patent Application Publication
(10) Pub. No.: US 2025/0007687 A1
(43) Pub. Date: Jan. 2, 2025

(54) FULLY HOMOMORPHIC ENCRYPTION

(71) Applicant: Intel Corporation, Santa Clara, CA (US)

(72) Inventors: Sanu MATHEW, Portland, OR (US); Vikram SURESH, Portland, OR (US); Sachin TANEJA, Hillsboro, OR (US); Raghavan KUMAR, Hillsboro, OR (US); Christopher WILKERSON, Portland, OR (US)

(21) Appl. No.: 18/217,551

(22) Filed: Jul. 1, 2023

(51) Int. Cl. H04L 9/00

(52) U.S. Cl. CPC H04L 9/008

(57) ABSTRACT

Techniques for fully homomorphic encryption are described. In some examples, a register file to store polynomials is coupled to a butterfly compute path. The butterfly compute path includes a multiplier coupled to a first input and a second input to multiply the first and second input to, when enabled, generate a multiplication output, a first multiplexer coupled to an output of the multiplier and to the first input to output a selection between the output of the multiplier and the first input, an adder to add, when enabled, a third input to the selected output of the first multiplexer, a subtractor to subtract, when enabled, an output of the multiplier from the third input, and a second multiplexer coupled to an output of the multiplier and to the first input to, when enabled, output a selection between the output of the multiplier and the subtractor.

### BACKGROUND

Various applications have utilized modern public-key cryptographic systems to guarantee secrecy, data integrity, and authentication. Conventional public-key cryptography techniques derive their security from the hardness of nondeterministic polynomial time (NP)-complete problems such as factorization or discrete logarithms of large integers. However, when large-scale quantum computers are built (an event called “post-quantum”), Shor's algorithm could be used to solve these NP-complete problems.

### BRIEF DESCRIPTION OF DRAWINGS

Various examples in accordance with the present disclosure will be described with reference to the drawings, in which:

FIG. 1 illustrates examples of conventional encryption.

FIG. 2 illustrates examples of homomorphic encryption.

FIG. 3 illustrates examples acts for fully homomorphic encryption (FHE) using ring learning with errors.

FIG. 4 illustrates examples of an FHE accelerator.

FIG. 5 illustrates examples of public key generation.

FIG. 6 illustrates examples of an FHE compute engine.

FIG. 7 illustrates examples of a FHE compute engine tile.

FIG. 8 illustrates examples of register file bank to butterfly unit interconnection.

FIG. 9(A) illustrates examples of an 8×8 compute tile array.

FIG. 9(B) illustrates examples of a 6×7 compute tile array.

FIGS. 10(A)-(B) illustrate examples of a reconfigurable decimation-in-time (DIT)/decimation-in-frequency (DIF) butterfly circuit.

FIGS. 11(A)-(D) illustrate examples of the butterfly circuit configured to perform a specific operation.

FIGS. 12(A)-(C) illustrate examples of a DIF-Number Theoretic Transform (NTT) network and a DIF butterfly unit.

FIGS. 13(A)-(C) illustrate examples of a DIT-inverseNTT (iNTT) network and a DIT butterfly unit.

FIG. 14 illustrates examples of NTT-based multiplication configuration.

FIG. 15 illustrates examples of NTT-based multiplication configuration using only DIT networks.

FIG. 16 illustrates examples of NTT-based multiplication configuration using only DIF networks.

FIGS. 17(A)-(B) illustrate examples of implicit bit reversal.

FIG. 18 illustrates examples of an improved Montgomery multiplication.

FIG. 19 illustrates examples of an NTT-optimized Montgomery multiplier that uses postponed carry-propagation.

FIG. 20 illustrates examples of the use of NTT-optimized Montgomery multiplication in NTT or iNTT.

FIG. 21 illustrates examples of the use of NTT-optimized Montgomery multiplication in modular multiply-accumulate.

FIG. 22 illustrates examples of the use of NTT-optimized Montgomery multiplication in modular multiplication.

FIG. 23 illustrates examples of the use of NTT-optimized Montgomery multiplication in modular addition.

FIG. 24 illustrates examples of a butterfly datapath with carry save adder (CSA) and Montgomery reduction.

FIG. 25 illustrates an example method to process FHE accelerator instruction either directly or using emulation or binary translation.

FIG. 26 illustrates an example computing system.

FIG. 27 illustrates a block diagram of an example processor and/or System on a Chip (SoC) that may have one or more cores and an integrated memory controller.

FIG. 28 is a block diagram illustrating a computing system 2800 configured to implement one or more aspects of the examples described herein.

FIG. 29A illustrates examples of a parallel processor.

FIG. 29B illustrates examples of a block diagram of a partition unit.

FIG. 29C illustrates examples of a block diagram of a processing cluster within a parallel processing unit.

FIG. 29D illustrates examples of a graphics multiprocessor in which the graphics multiprocessor couples with the pipeline manager of the processing cluster.

FIGS. 30A-30C illustrate additional graphics multiprocessors, according to examples.

FIG. 31 shows a parallel compute system, according to some examples.

FIGS. 32A-32B illustrate a hybrid logical/physical view of a disaggregated parallel processor, according to examples described herein.

FIG. 33(A) is a block diagram illustrating both an example in-order pipeline and an example register renaming, out-of-order issue/execution pipeline according to examples.

FIG. 33(B) is a block diagram illustrating both an example in-order architecture core and an example register renaming, out-of-order issue/execution architecture core to be included in a processor according to examples.

FIG. 34 illustrates examples of execution unit(s) circuitry, such as execution unit(s) circuitry.

FIG. 35 is a block diagram of a register architecture according to some examples.

FIG. 36 illustrates examples of an instruction format.

FIG. 37 illustrates examples of an addressing information field.

FIG. 38 illustrates examples of a first prefix.

FIGS. 39(A)-(D) illustrate examples of how the R, X, and B fields of the first prefix are used.

FIGS. 40(A)-(B) illustrate examples of a second prefix.

FIG. 41 illustrates examples of a third prefix.

FIGS. 42A-42B illustrate thread execution logic including an array of processing elements employed in a graphics processor core according to examples described herein.

FIG. 43 illustrates an additional execution unit, according to an example.

FIG. 44 is a block diagram illustrating graphics processor instruction formats according to some examples.

FIG. 45 is a block diagram of another example of a graphics processor.

FIG. 46A is a block diagram illustrating a graphics processor command format according to some examples.

FIG. 46B is a block diagram illustrating a graphics processor command sequence according to an example.

FIG. 47 is a block diagram illustrating the use of a software instruction converter to convert binary instructions in a source ISA to binary instructions in a target ISA according to examples.

FIG. 48 is a block diagram illustrating an IP core development system that may be used to manufacture an integrated circuit to perform operations according to some examples.

### DETAILED DESCRIPTION

The present disclosure relates to methods, apparatus, systems, and non-transitory computer-readable storage media for fully homomorphic encryption.

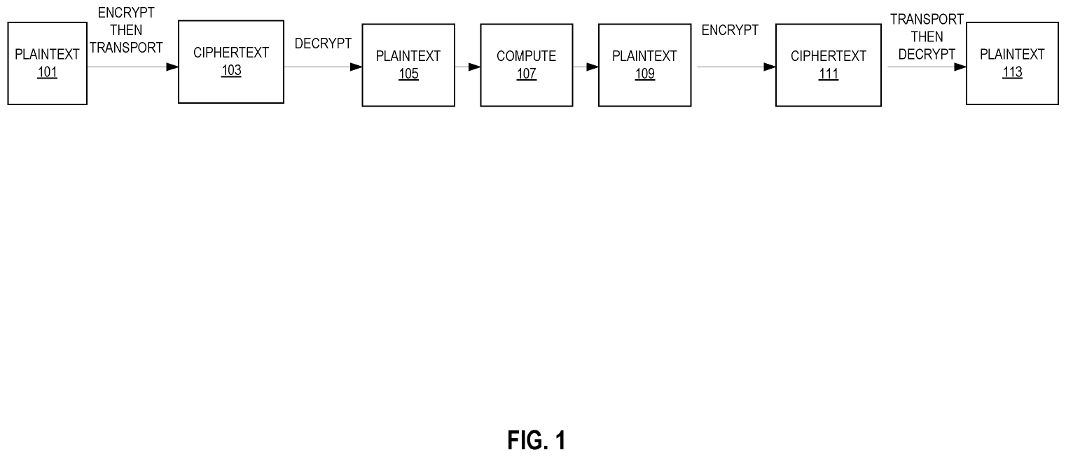

FIG. 1 illustrates examples of conventional encryption. As shown, plaintext 101 (e.g., “126”) is encrypted and then transported as ciphertext 103 (e.g., “E7L”). To perform a computation on the encrypted text, it first has to be decrypted back to plaintext 105. A computation 107 (such as multiply by 2) is performed on that plaintext 105 and the result is in plaintext 109 (e.g., “252”). This result is encrypted into ciphertext 111 to be transported and finally decrypted into plaintext 113. Unfortunately, during the computation portion the data is in plaintext (105 and 109) and is vulnerable.

Quantum computing may break this conventional encryption scheme. Improved schemes are being developed to replace the conventional scheme and allow for Fully Homomorphic Encryption (FHE) where the data is encrypted even during a compute operation. Some improved encryption schemes use lattice-based cryptography. A benefit of lattice-based cryptography is that lattice problem hardness enables cryptographic schemes to be resistant to quantum attacks. Additionally, lattice-based cryptosystem algorithms are relatively simple and able to be run in parallel due to their dependency on operations on rings of integers for certain cryptosystems.

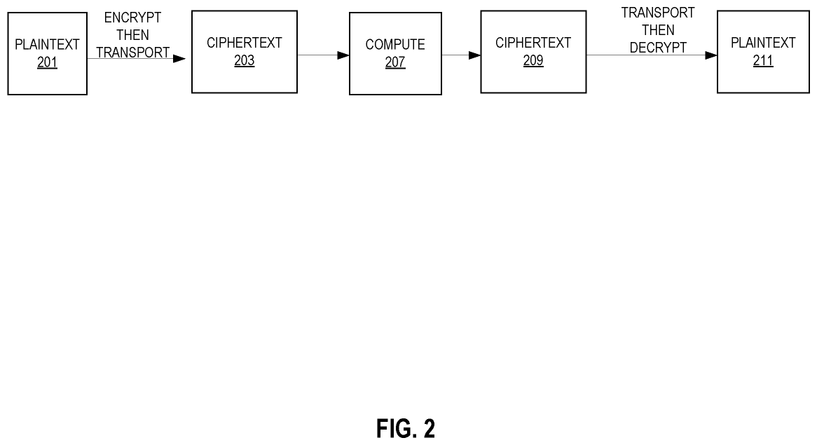

FHE may be paired with lattice based cryptographic systems. FHE enables arbitrary calculations on encrypted data while maintaining correct intermediate results without decrypting the data to plaintext. FIG. 2 illustrates examples of homomorphic encryption. FHE solves the problem of protecting data at all times including against an honest-but-curious attacker. FHE allows for the protection of input data, intermediate data, and output data. Hence, data is not vulnerable when it is used. As shown, plaintext 201 (e.g., “126”) is encrypted and then transported as ciphertext 203 (e.g., “E7L”). Unlike the conventional encryption scheme, the ciphertext 203 does not need to be decrypted to be operated on. Rather, a compute function 207 is applied to the ciphertext 203 directly and the result of the compute function 207 is ciphertext 209. This ciphertext 209 can be transported and decrypted into plaintext 211.

A bottleneck in FHE and/or lattice-based cryptography is efficient modular polynomial multiplication. Lattice-based cryptography algorithms rely on a significant amount polynomial multiplications to encode and decode polynomial plaintext/ciphertext using key values. These keys then rely on a large number of Gaussian samples because they are required to be random polynomials.

In some examples, detailed herein a Residue Number System-based (RNS) Number Theoretic Transform (NTT) polynomial multiplier for application in lattice-based cryptography, FHE, etc. In some examples, the data comes into the system in a double CRT format described in detail below.

A lattice L⊂ [symbol] ⁿ is the set of all integer linear combination of basis vectors b₁, . . . bₙ∈ [symbol] n such that L={Σaᵢbᵢ:aᵢ∈ [symbol] }. L is a subgroup of [symbol] ⁿ that is isomorphic to [symbol] ⁿ. Cryptography based on lattices exploits the hardness of two problems: Short integer Solution (SIS) and Learning With Errors (LWE). LWE requires large keys which may be impractical in current architectures. A derivation of LWE called Ring-LWE (RLWE or ring-LWE) is used in some examples detailed herein.

Cryptosysterns based on the LWE problem, the most used one, have their foundation in the difficulty of finding the secret key sk given (A, pk), where pk=A*sk+e mod q with pk being a public key, e an error vector with Gaussian distribution, and A a matrix of constants in [symbol] _{w}^{r×n} chosen randomly from a uniform distribution. LWE requires large keys that in general are impractical for current designs. In RWLE A is implicitly defined as a vector a in a ring [symbol] ≡ [symbol] _{q}[x]/(xⁿ+1). For a ciphertext modulus q, the ciphertext space is defined as [symbol] _{q}= [symbol] /q [symbol] . The plaintext space is [symbol] ₚ meaning plaintexts are represented as length n vectors of integers modulus p.

The RLWE distribution on [symbol] _{q}× [symbol] _{q} consists of pairs (a,t) with a∈ [symbol] _{q} chosen uniformly random and t=a×s+e∈ [symbol] _{q} where s is a secret element and e is sampled from a discrete Gaussian distribution [symbol] _{σ} with a standard deviation U.

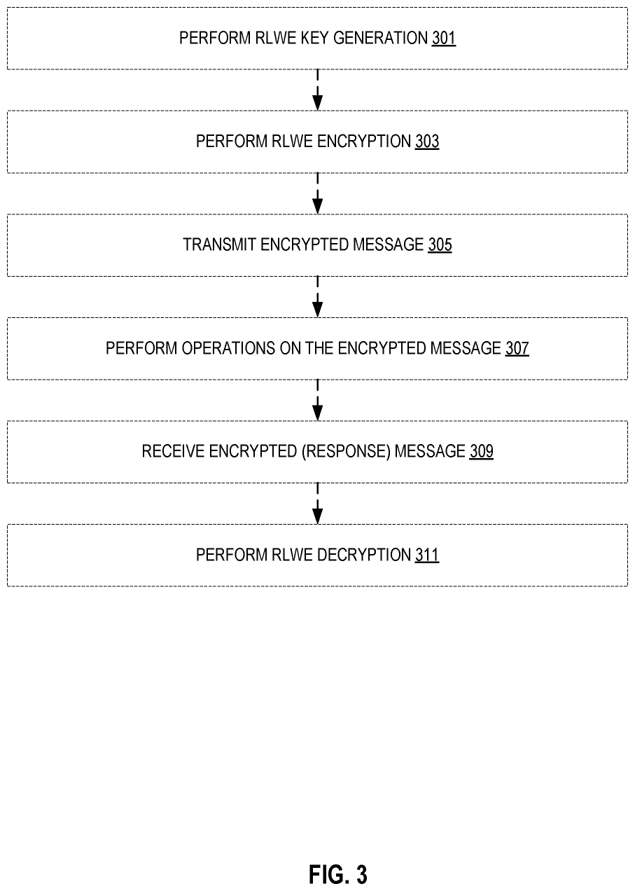

Generically, RWLE utilizes three acts—key generation, encryption, and decryption. FIG. 3 illustrates examples acts for FHE using RWLE. In some examples, at 301, RWLE key generation is performed. Key generation generates a private key and a public key. In some examples, a polynomial a is chosen uniformly and two polynomials r₁ and r₂ are sampled from the Gaussian distribution [symbol] _{σ}. Polynomial r₂ is the private key and the two polynomials participate in the public key generation process p←r₁−a×r₂.

In some examples, at 303, RWLE encryption is performed. Encryption encrypts an input message m to cipher text (c₁, c₂). In some examples, the input message is encoded into a polynomial me using an encoder. In some examples, the cipher text (c₁, c₂) is calculated based on the public key, the encoded message, and sampled error polynomials (e.g., (e₁, e₂, and e₃).

$${c}_{1} ← a \times {e}_{1} + {e}_{2} \\ {c}_{2} ← p \times {e}_{1} + {e}_{3} + {m}_{e}$$

In some examples, at 305, an encrypted message is transmitted to a recipient. In some examples, one or more operations are performed on the encrypted message such as performing a mathematical operation on the message at 307. Note that the performance could be done by the sender before transmission, by an intermediate third party (not the final recipient), or by the recipient itself.

In some examples, at 309, the encrypted message or a response thereto is received. The received message or response message is decrypted, in some examples, at 311. Decryption recovers an original message m from the ciphertext (c₁, c₂). In some examples, decryption starts with the calculation of a pre-decoded polynomial m_{d}

$${m}_{d} ← {c}_{1} \times {r}_{2} + {c}_{2}$$

The original message is recovered from the pre-decoded polynomial m_{d} using a decoder. In some examples, relinearization is required during decryption.

One or more of the above acts utilizes instructions for performing the multiplication, addition, etc. using an FHE accelerator.

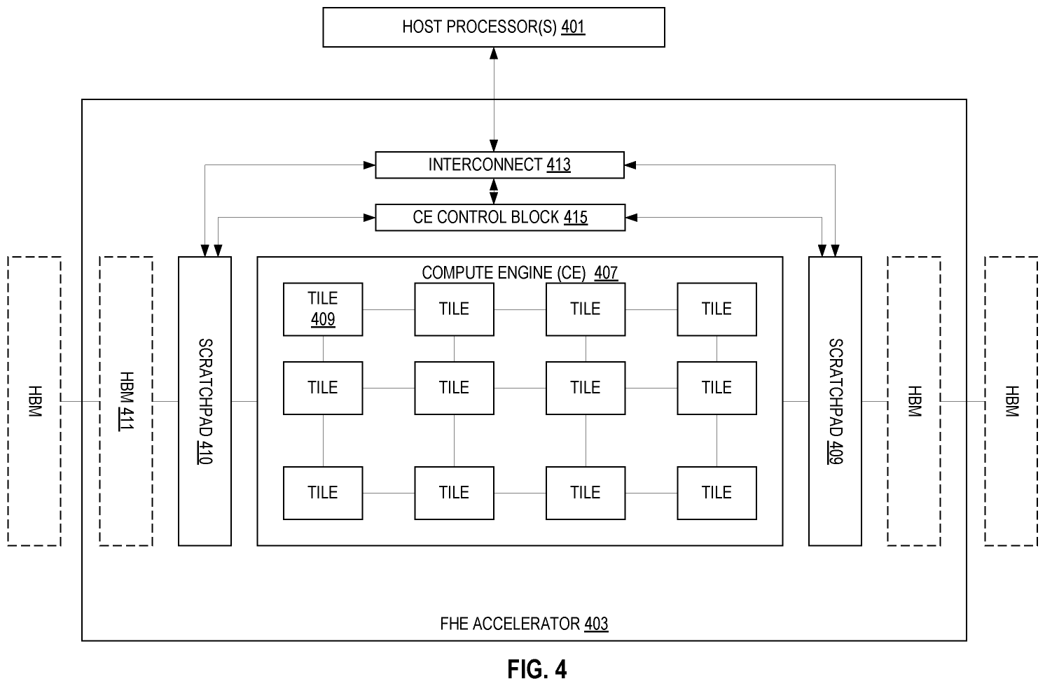

FIG. 4 illustrates examples of an FHE accelerator. As shown, the FHE accelerator 403 couples to one or more host processors 401 such as one or more central processing unit (CPU) cores via one or more interconnects 413.

The one or more interconnects 413 coupled to scratchpad memory 410 which handles load/stores of data and provides data for execution by the compute engine (CE) 407 comprising a plurality of CE blocks 409. In some examples, the CE blocks 409 are coupled to memory, the interconnect 413, and/or a CE control block 415.

The scratchpad memory 410 is coupled to high bandwidth memory (HBM) 411 which stores a larger amount of data. In some examples, the data is distributed across HBM 411 and banks of scratchpad memory (SPAD) 410. In some examples, HBM is external to the FHE accelerator 403. In some examples, some HBM is external to the FHE accelerator 403 and some HBM is internal to the FHE accelerator 403.

In some examples, a CE control block (CCB) 415 dispatches instructions and handles synchronization of data from the HBM 411 and scratchpad memory 410 for the CE 407. In some examples, memory loads and stores are tracked in the CCB 415 and dispatched across SPAD 410 for coordinated data fetch. These loads and stares are handled locally in the SPAD 410 and written into the SPAD 410 and/or HBM 411. In some examples, the CCB 415 includes an instruction decoder to decode the instructions detailed herein. In some examples, a decoder of a host processor 401 decodes the instructions to be executed by the CE 407.

In some examples, the basic organization of the FHE compute engine (CE) 407 is a wide and flexible array of functional units organized in a butterfly configuration. The array of butterfly units is tightly coupled with a register file capable of storing one or more of an HE operands (e.g., entire input and output ciphertexts), twiddle factor constants, relevant public key material, etc.

In some examples, the HE operands, twiddle factors, key information, etc. are stored as polynomial coefficients.

The CE 407 performs polynomial multiplication, addition, modulo reduction, etc. Given aᵢ and bᵢ in [symbol] , two polynomials a(x) and b(x) over the ring can be expressed as

$$a ( x ) = {a}_{0} + {a}_{1} x + {a}_{2} {x}^{2} + … {a}_{n - 1} {x}^{n - 1} \\ b ( x ) = {b}_{0} + {b}_{1} x + {b}_{2} {x}^{2} + … {b}_{n - 1} {x}^{n - 1}$$

In some examples, an initial configuration of the array with respect to the register file allows full reuse of the register file while processing Ring-LWE polynomials with degree up to N=16,384 and log q=512-bit long coefficients; and partial reuse beyond such parameters, for which processing ciphertexts will require data movement from and to the upper levels in the memory hierarchy.

In some examples, the compute engine is composed of 512-bit Large Arithmetic Word Size (LAWS) units organized as vectored butterfly datapaths. The butterfly units (LAWS or not) are designed to natively support operations on operands in either their positional form or leveraging Chinese Remainder Theorem (CRT) representation. In some examples, a double-CRT representation is used. The first CRT layer uses the Residue Number System (RNS) to decompose a polynomial into a tuple of polynomials with smaller moduli. The second layer converts each of small polynomials into a vector of modulo integers via NTT. In the double-CRT representation, an arbitrary polynomial is identified with a matrix consisting of small integers, and this enables an efficient polynomial arithmetic by performing component-wise modulo operations. The RNS decomposition offers the dual promise of increased performance using SIMD operations along with a quadratic reduction in area with decreasing operand widths.

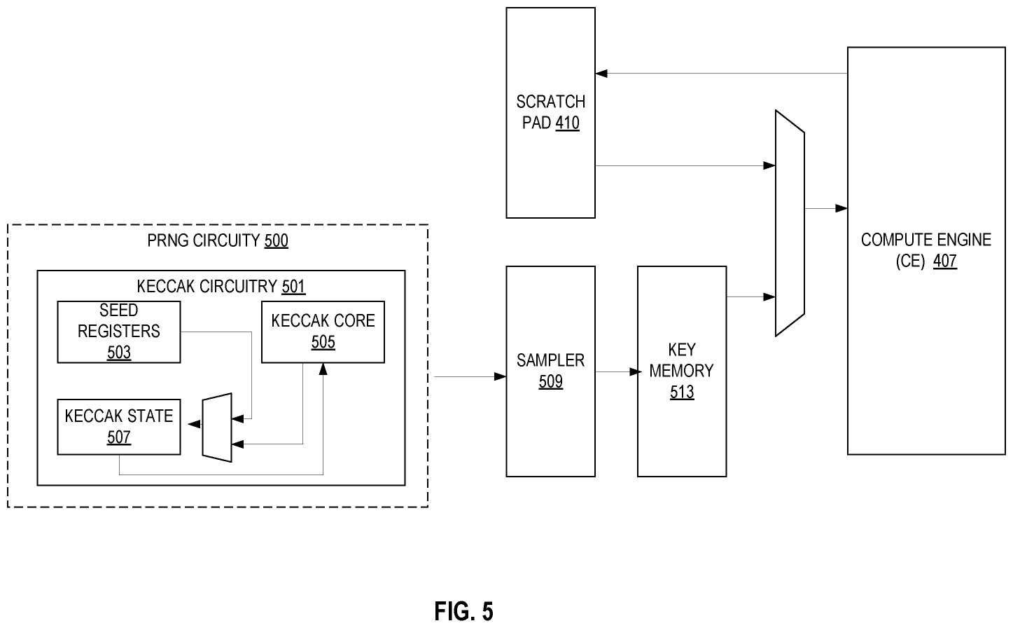

FIG. 5 illustrates examples of public key generation. Pseudo-random number generator (PRNG) circuitry 500 generates a pseudo-random number. In some examples, the PRNG circuitry 500 utilizes KECCAK circuitry 501 which uses a Keccak-f[ ] permutation (e.g., f[1600]) performed by Keccak core 505 to generate a value from seed values stored in seed register(s) 503 and Keccak state information 507. The Keccak core 505 can be configured in different SHA-3 modes. PRNG values output X bits (e.g., 32 bits) at a time as required by sampler 509 (e.g., one or more of a uniform sampler, a binomial sampler, a Gaussian sampler, a trinary sampler, and/or a rejection sampler). The sampler may AND the input bits with a mask. The sampled value(s) (mod q) are stored in key memory 513. The key memory 513 and scratchpad 410 are muxed to provide input for the CE 407.

For encryption, a public key A is sampled randomly from [symbol] _{q}[x]/(xⁿ+1). The ciphertext is [C₀, C₁]=[A*s+p*e+m, −A]. Decryption is performed by computing C₀+C₁*s and reduced to modulo p. Note that half of the ciphertext is a random sample in [symbol] _{q}.

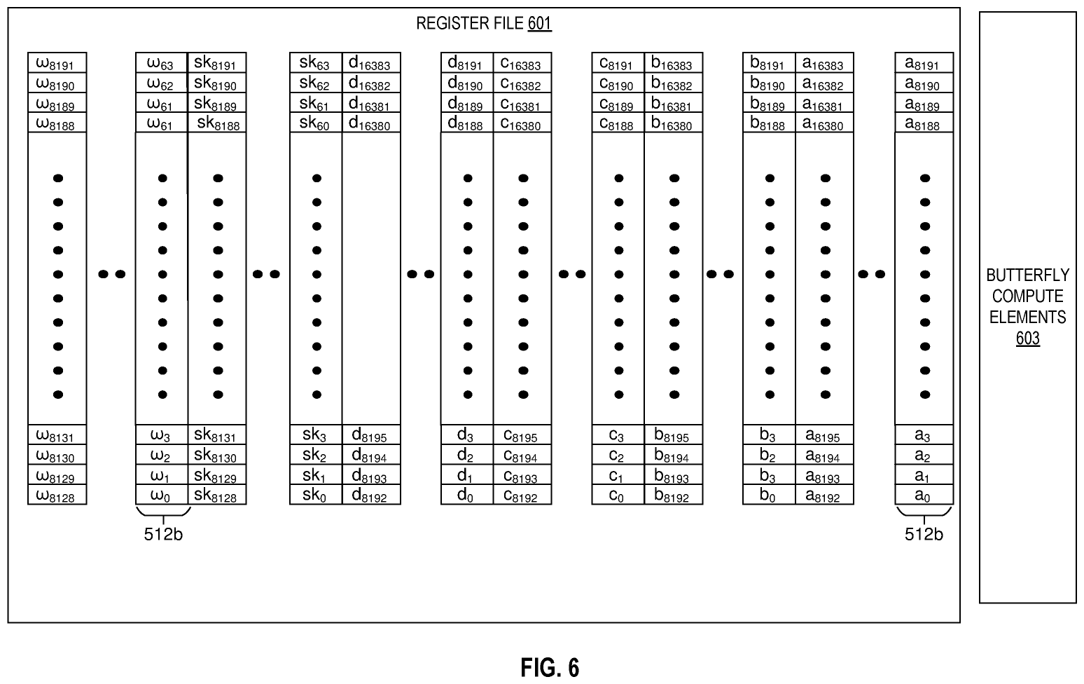

FIG. 6 illustrates examples of an FHE compute engine. In some examples, this illustrates CE 407. The CE 407 includes a plurality of butterfly compute elements 603 and a register file 601. For example, the butterfly compute elements 603 may be in one or more arrays of butterfly elements (e.g., 8,192 elements) each implementing a DIT circuit (e.g., a 32-bit DIT circuit) that is to be used to execute vector polynomial add/multiply/multiply accumulate (MAC) operations on a polynomial ring using residue coefficient (e.g., a 32-bit reside coefficient). Note that butterfly compute elements of different sizes (e.g., 512-bit) may be used.

The polynomial is stored in the local register file (RF) 601. The RF 601 is capable, in some examples, of single cycle read/write latency to the butterfly compute elements 603 to enable high throughput operations for polynomial instructions. In some examples, a separate read/write port is also provisioned to enable communications with higher levels of the memory hierarchy such as the SPAD 410 and/or HBM 411. The RF 601 serves as the local storage polynomials including operands (a, b, c, and d), keys (e.g., sk or pk), relinearization keys, NTT twiddle-factor constants (ω), etc.

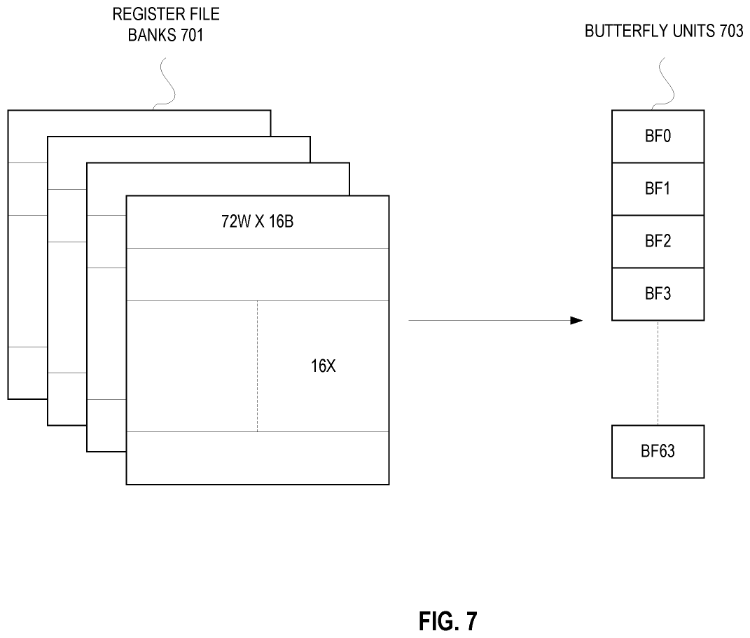

To efficiently move data between the RF 601 and the butterfly compute elements 603, in some examples, a tiled CE architecture is used where an array of smaller RFs are coupled with a proper subset of BF elements. FIG. 7 illustrates examples of a FHE compute engine tile. In some examples, this is an illustration of tile 409.

As illustrated, where each compute tile is composed of a subset of the register file (shown as a plurality of register file banks 701) are coupled with butterfly compute elements 703 (e.g. 64 such elements in this illustration allow different numbers of register file banks and compute elements may be used in some examples). In some examples, each butterfly unit consumes up to 3 input operands and produces 2 output operands each cycle.

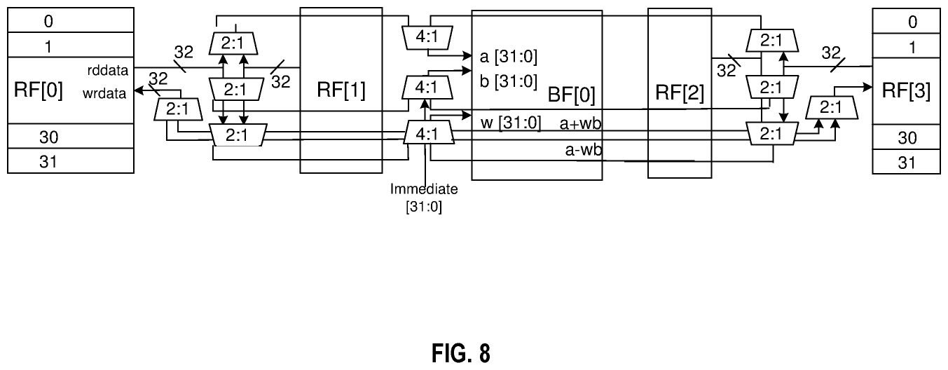

In some examples, the RF subset is organized into 4 banks of 18 KB each with each memory bank comprising 16 physical memory modules of 72 words depth with 128-bit 1-read/1-write ports. The 1-read/1-write ported RF banks 701 feed each butterfly unit with ‘a’, ‘b,’ ‘c,; and/or ‘ω’ inputs. With the two butterfly outputs (a+ω*b and a−ω*b) written to any of the four RF banks simultaneously for NTT or INTT. FIG. 8 illustrates examples of register file bank to butterfly unit interconnection showing inputs of 32-bit values of a, b, and ω from RF[1] and writes of a+ω*b and a−ω*b to RF[0] and RF[3]. In some examples, SPAD 410 can read/write to any of the RF banks that are not servicing a butterfly.

For ciphertexts represented in the double-Chinese Remainder Transform (CRT) format, multiplication, addition, and/or multiply-accumulate operations are performed coefficient-wise and do not require interaction between coefficients. NTT/iNTT operations require a coefficient order to be permuted after each stage and thus require data movement across the tiles in the CE 407. As a result, distribution of residue polynomials across compute tiles is important in the performance of NTT/iNTT operations. In a distributed computation, coefficients from each residue is distributed across a plurality (e.g., all) tiles and operations are performed on one residue at a time before moving on to subsequent residues. As a result, the latency of homomorphic operations decrease as the ciphertext modulus is scaled in the leveled HE schemes, due to fewer RNS residues. Further, corresponding coefficients of all residues are available in the same compute tile for operations such as fast base conversion, where coefficients from different residues interact with each other.

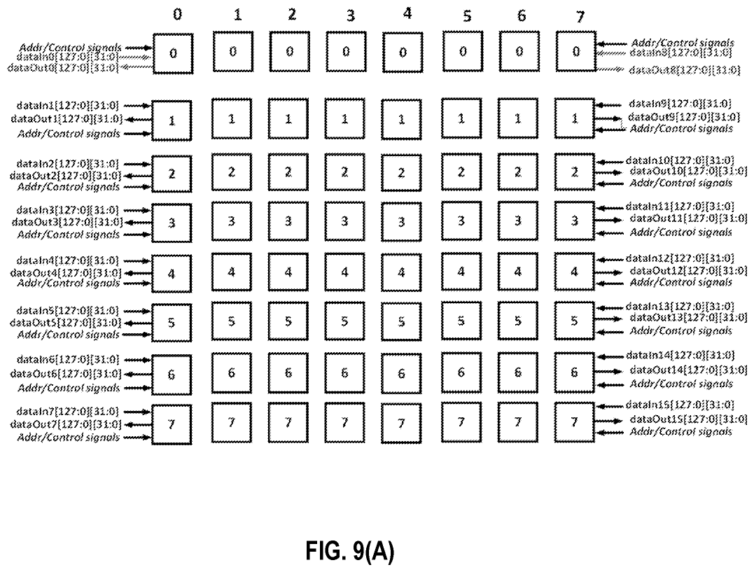

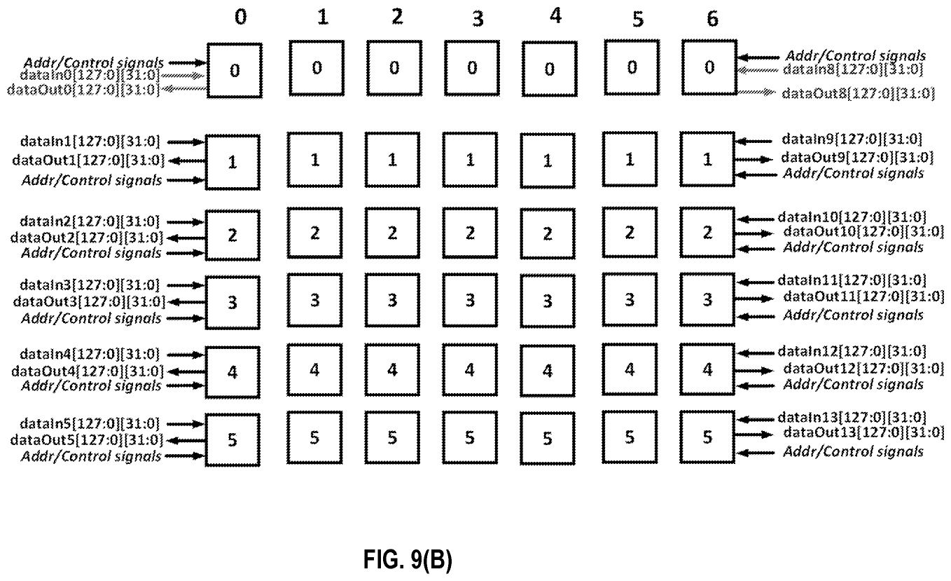

The modularity of the tile-base design allows for the scaling of the CE 407 based on the compute requirements of the workload. FIGS. 9(A)-(B) illustrate examples of scaling. FIG. 9(A) illustrates an 8×8 array which can be scaled down to the 6×7 array of FIG. 9(B). An extra column of tiles can be added or removed from a tile array without significantly modifying the compute element tile design. Similarly, extra rows of tiles can be added or removed from the tile array to scale the array dimension vertically. Since the inter-tile communication network is designed to connect by abutment, scaling tile array dimensions provides an elastic connectivity of tiles to neighboring tiles, while also providing an input/output path to connect to higher levels of memory.

As noted above, the compute elements use a butterfly datapath. In particular, the butterfly datapath is reconfigurable to performs polynomial arithmetic operations including decimation-in-time (DIT) and decimation-in-frequency (DIF) computations for NTT operations in FHE workloads. The butterfly datapath executes a SIMD polynomial instruction set architecture (or extension thereof) which includes instructions for polynomial addition, polynomial multiplication, polynomial multiply and accumulate, polynomial NTT, and polynomial INTT that cause a reconfiguration and polynomial operation. Note that polynomial load and store instructions may not need not to use the butterfly datapath.

In some examples, a polynomial load (pload) instruction includes an opcode for loading a polynomial and one or more fields to indicate a memory source location and one or more fields to indicate a destination for the load (e.g., scratchpad, HBM, register file, etc.).

In some examples, a polynomial store (pstore) instruction includes an opcode for storing a polynomial and one or more fields to indicate a memory destination location and one or more fields to indicate a source for the store (e.g., scratchpad, HBM, register file, etc.).

In some examples, a polynomial add (padd) instruction includes an opcode for adding to source polynomials and storing the result in a destination and one or more fields to indicate the source locations and one or more fields to indicate a destination for the result (e.g., scratchpad, HBM, register file, etc.). Note that the source polynomials are usually loaded before the operation. Note that the addition is of polynomial coefficients in some examples.

In some examples, a polynomial multiplication (pmul) instruction includes an opcode for multiplying to source polynomials and storing the result in a destination and one or more fields to indicate the source locations and one or more fields to indicate a destination for the result (e.g., scratchpad, HBM, register file, etc.). Note that the source polynomials are usually loaded before the operation. Note that multiplication is of polynomial coefficients in some examples.

In some examples, a polynomial multiply and accumulation (pmac) instruction includes an opcode for multiplying to source polynomials and accumulating the result with the existing value in the destination and storing the result in the destination and one or more fields to indicate the source locations and one or more fields to indicate the source/destination for the result (e.g., scratchpad, HBM, register file, etc.). Note that the source polynomials are usually loaded before the operation. Note that multiply-accumulate is of polynomial coefficients in some examples.

In some examples, a polynomial NTT (pNTT) instruction includes an opcode for performing a NTT operation on a polynomial (already loaded) using twiddle factors and storing the result in a destination and one or more fields to indicate the source location of one or more polynomials and an indication of the twiddle factors (or a location storing the twiddle factors) and one or more fields to indicate a destination for the result (e.g., scratchpad, HBM, register file, etc.). Note that the source polynomial(s) are usually loaded before the operation. Note that NTT is of polynomial coefficients in some examples.

In some examples, a polynomial INTT (pINTT) instruction includes an opcode for performing an INTT operation on a polynomial (already loaded) using twiddle factors and storing the result in a destination and one or more fields to indicate the source location of one or more polynomials and an indication of the twiddle factors (or a location storing the twiddle factors) and one or more fields to indicate a destination for the result (e.g., scratchpad, HBM, register file, etc.). Note that the source polynomial(s) are usually loaded before the operation. Note that NTT is of polynomial coefficients in some examples.

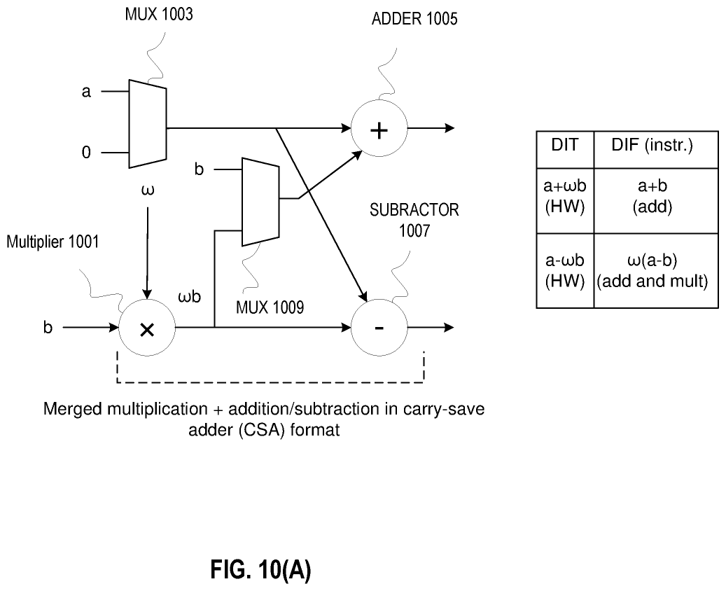

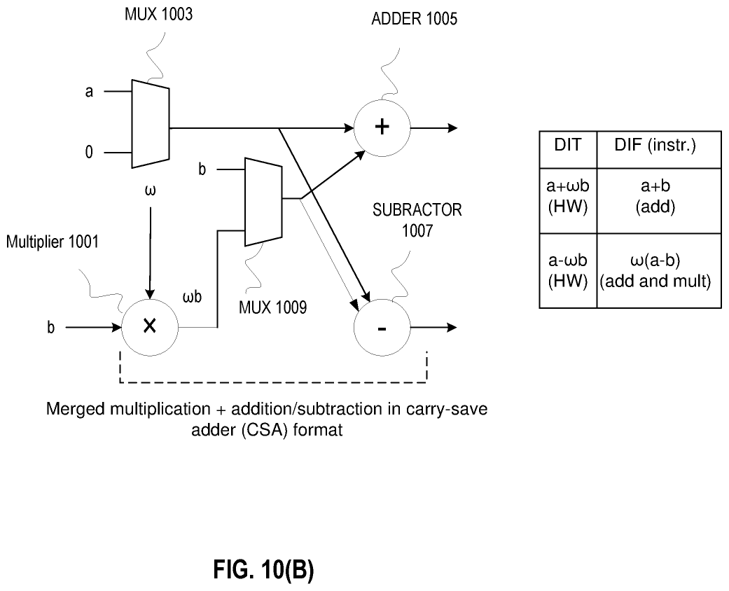

FIGS. 10(A)-(B) illustrate examples of a reconfigurable DIT/DIF butterfly circuit. This circuit natively computes only the DIT butterfly. A modular multiplier 1001 is coupled to an adder 1005 and subtractor 1007. Multiplexers (e.g., mux 1003 and mux 1009) are used to channel data appropriately during add, multiply, multiply-accumulate, NTT, and inverse-NTT operations. Sequential computations of DIF are supported by calculating a+b and a−b outputs followed by ω*(a−b) in a subsequent cycle. Simplifying the datapath to compute only DIT natively results in a compact implementation by enabling the entire datapath to remain in carry-save format with carry-propagation relegated to the very end of the logic. FIGS. 10(A) and 10(B) differ in how data gets to the subtractor 1007.

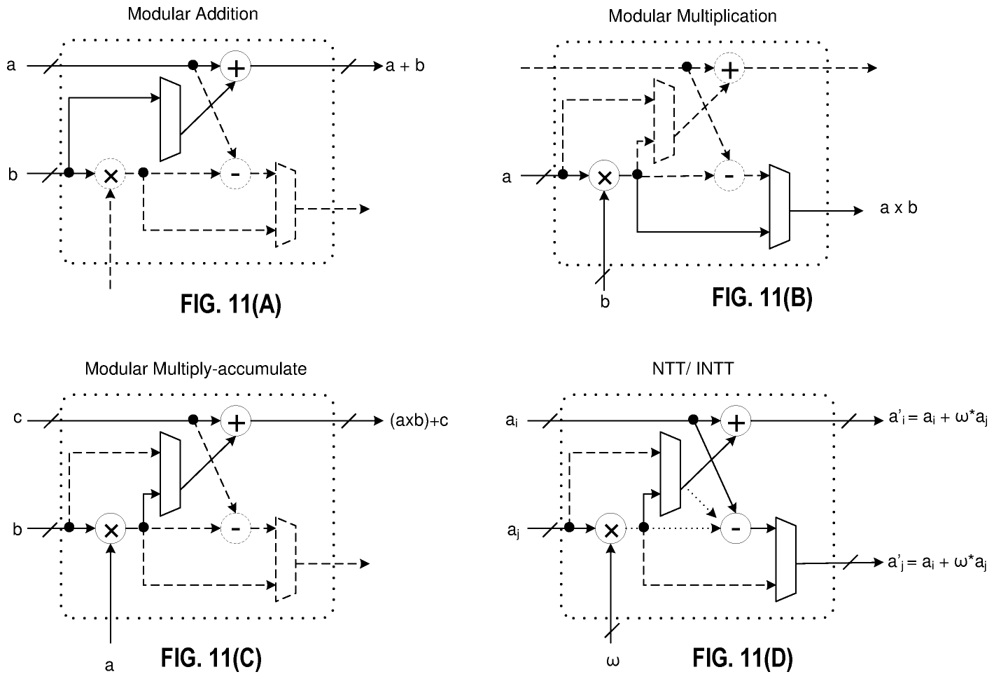

FIGS. 11(A)-(D) illustrate examples of the butterfly circuit configured to perform a specific operation. Note that these examples are based off of FIG. 10(A) but the changes to be based on FIG. 10(B) are minimal and really only factor into FIG. 11(D) and both paths ae shown using dotted lines. In these illustrations aspects that are dashed are configured to not be used. In some examples, the subtractor is performed with using 2's complement addition.

FIG. 11(A) illustrates examples of the butterfly circuit configured to perform a modular addition of a+b. The values of a and b may be of any size such as 32-bit, 512-bit, etc. Typically, the values of a and b are integers.

FIG. 11(B) illustrates examples of the butterfly circuit configured to perform a modular multiplication of a×b. The values of a and b may be of any size such as 32-bit, 512-bit, etc. Typically, the values of a and b are integers.

FIG. 11(C) illustrates examples of the butterfly circuit configured to perform a modular multiply-accumulate of (a x b)+c. The values of a, b, and c may be of any size such as 32-bit, 512-bit, etc. Typically, the values of a, b, and c are integers.

FIG. 11(D) illustrates examples of the butterfly circuit configured to perform NTT or iNTT to generate a+ω*b and a−ω*b. The values of a, b, and w may be of any size such as 32-bit, 512-bit, etc. Typically, the values of a, b, and w are integers.

Both NTT and iNTT operations are important computations in FHE workloads. For this reason previously published works use multiplexers to reconfigure a datapath to support both DIF and DIT operations. Unfortunately, this results in a substantial increase in delay and area overheads.

Using the butterfly circuit of FIG. 11(D), for a DIT operation, inputs w and b are multiplied to obtain w*b and then added to or subtracted from input a to produce outputs a+ωb and a−ωb. A multiplexor routes inputs directly to the adder during a polynomial add operation (note that a mux is not used in the subtraction).

Using the butterfly circuit of FIG. 11(D) a DIF operation is a two-step process. In the first step, the output a+b and a−b are computed using the adder and subtractor respectively. In the second step, the subtractor output is fed back into the multiplier to generate ω*(a−b).

In some examples, the DIT butterfly is implemented by first computing the multiplier output (ω*b) in a carry-save format. This output is then reduced using Montgomery reduction, again in carry-save format. The adder input ‘a’ is then added into the reduced product in carry-save format using a carry-save adder (CSA) and then the carry-propagation is completed in the final output adder to generate a+ω*b.

NTT and iNTT are critical operations for accelerating FHE workloads. NTTs convert polynomial ring operands into their CRT equivalents, thereby speeding up polynomial multiplication operations from O(n²) to O(n).

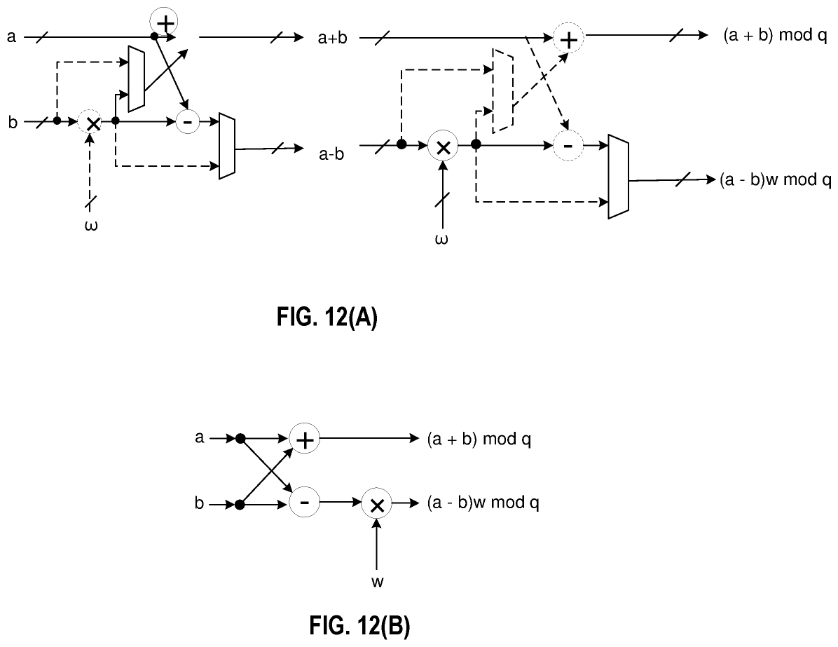

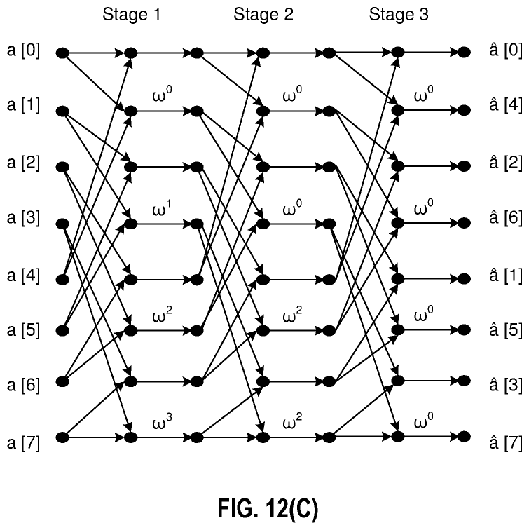

FIGS. 12(A)-(C) illustrate examples of a DIF-NTT network and a DIF butterfly unit. As noted above, performing DIF is a two stage operation, and this illustration is a logical representation of the operation using the described butterfly circuit. FIG. 12(A) illustrates examples of two stages of DIF. As before, dashed items are turned off. FIG. 12(B) illustrates examples of a DIF circuit. This illustration is a logical view of the DIF and does not show the two stages as separate items. FIG. 12(C) illustrates examples of a DIF-NTT network. For an 8-point DIF there are three stages, but other sized operations would require a different number of states. Note the regular index order on the input and the bit-reversed order on the output. In some examples, each stage uses 4 butterfly units.

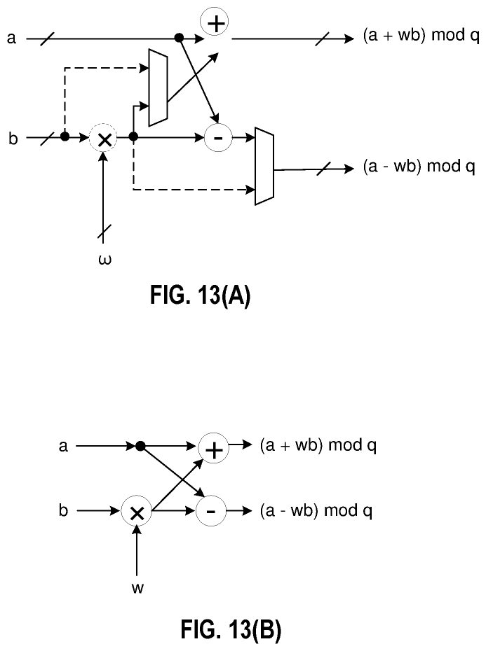

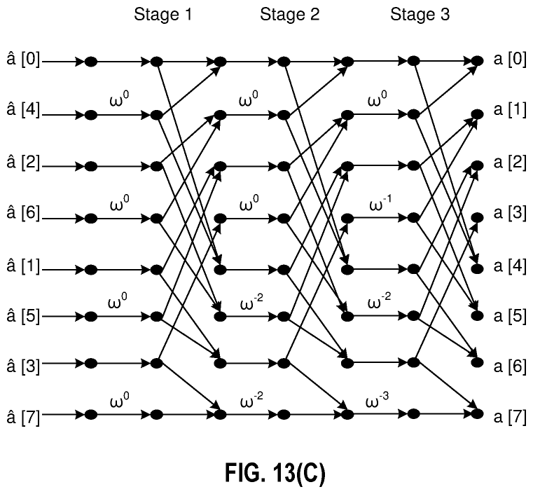

FIGS. 13(A)-(C) illustrate examples of a DIT-iNTT network and a DIT butterfly unit. FIG. 13(A) illustrates examples of a DIT circuit. As before, dashed items are turned off. FIG. 13(B) illustrates examples of a DIT circuit. This illustration is a logical view of the DIT and does not show the two stages as separate items. FIG. 13(C) illustrates examples of a DIT-iNTT network. For an 8-point DIT there are three stages, but other sized operations would require a different number of states. In some examples, each stage uses 4 butterfly units. Note the regular index order on the output and the bit-reversed order on the input.

NTT-multiplication may be performed using many different combinations including, but not limited to a DIT NTT coupled to a DIT iNTT, a DIT iNTT coupled to a DIT NTT, a DIF NTT coupled to a DIF iNTT, a DIF iNTT coupled to a DIF NTT, etc. In some examples, these combinations require bit reversal. In some examples, iNTT and NTT are considered to be NTT-based.

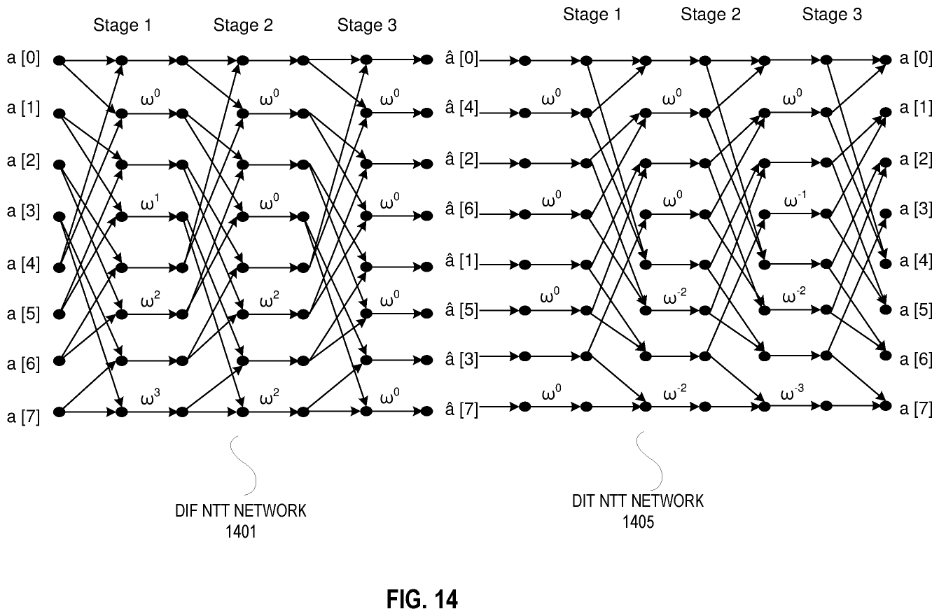

FIG. 14 illustrates examples of NTT-based multiplication configuration using the above described DIF NTT 1401 and DIT iNTT 1405. Conventional n-point NTT networks using DIF butterflies consume the ‘n’ polynomial coefficients in the regular index order and produce outputs after log n stages of computation in the bit-reversed index order. For example, an 8-point DIF NTT network consumes input coefficients in the regular order of 0, 1 . . . 7 and produces NTT outputs after 3 stages of butterfly computation in the bit reversed order of 0, 4 . . . 7. Similarly, a conventional n-point iNTT network would use a DIT butterfly with a DIT interconnect network and takes inputs in bit-reversed order and produces iNTT outputs in regular order. Since typical FHE workloads cascade NTT and iNTT operations back-to-back this data flow works well with DIF NTT operations followed by DIT iNTT operations with primary inputs and primary outputs consumed and produced in regular index order. However, in conventional systems, NTT and iNTT butterflies are different and also require separate interconnect networks to exchange computation results between source/destination tiles and switch modes of operation between NTT and iNTT instructions. This imposes significant area, power, and/or delay overheads.

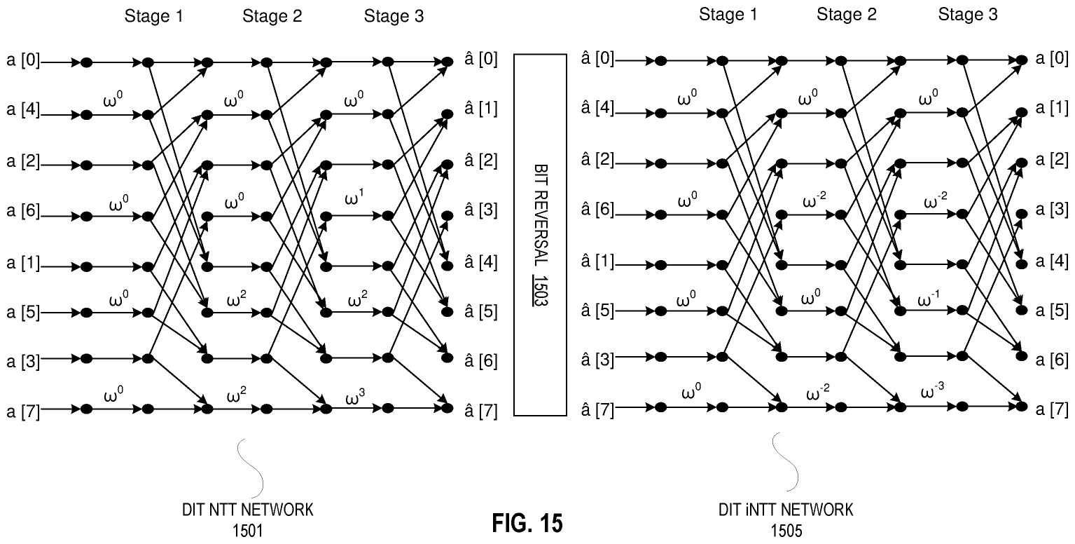

FIG. 15 illustrates examples of NTT-based multiplication configuration using only DIT networks. As shown, a DIT butterfly network is used for the NTT (DIT network 1501) and iNTT (DIT network 1505) operations. The datapath consumes primary inputs in bit-reversed index format. However, the use of DIT for both NTT and iNTT requires bit-reversals of intermediate outputs (using bit reversal circuitry 1503) when switching data from the NTT output to the iNTT input. This bit-reversal may require complex, expensive permutations of coefficients between the various tiles in the compute element array.

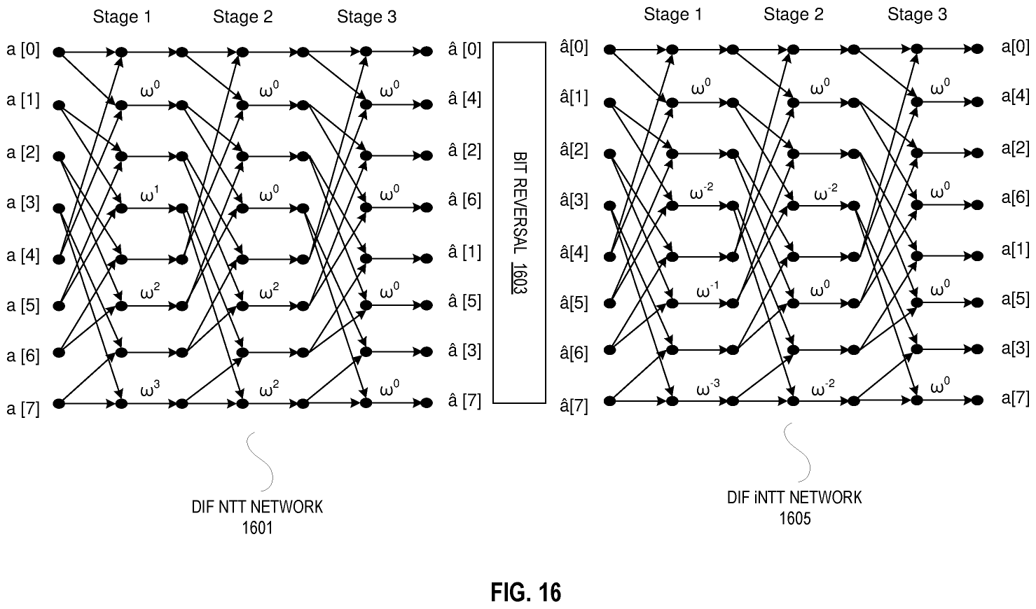

FIG. 16 illustrates examples of NTT-based multiplication configuration using only DIF networks. As shown, a DIF butterfly network is used for the NTT (DIF network 1601) and iNTT (DIT network 1605) operations. The datapath consumes primary inputs in regular index format. However, the use of DIF for both NTT and iNTT requires bit-reversals of intermediate outputs (using bit reversal circuitry 1603) when switching data from the NTT output to the iNTT input. This bit-reversal may require complex, expensive permutations of coefficients between the various tiles in the compute element array.

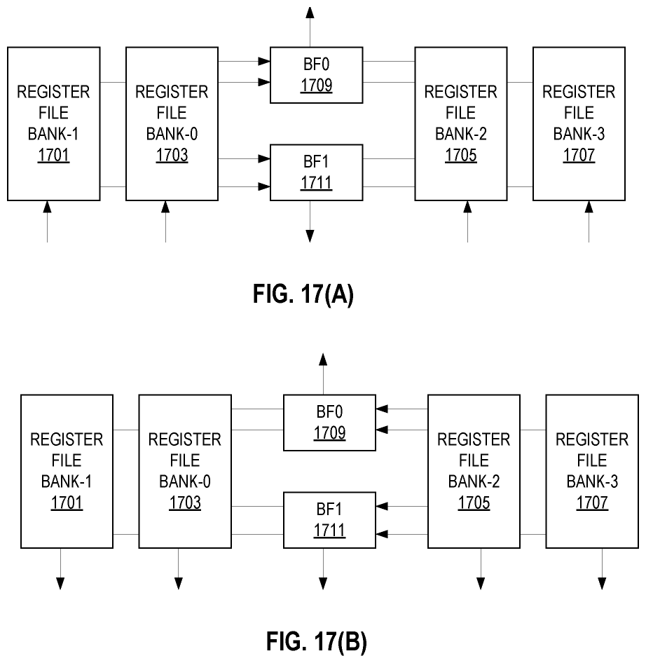

In some examples, the bit reversal is done implicitly using bit-reversed addressing during NTT read/write operations. This avoids the need to have an explicit bit-reversal operation between NTT and iNTT operations. FIGS. 17(A)-(B) illustrate examples of implicit bit reversal. In some examples, during odd stage NTT operations (FIG. 17(A)) operands are read from a first set of local register file banks in bit-reversed form (e.g., register file banks 0-0 1701-1703 and written (after processing by butterflies 1INVJ09 and 1711)) to a remote destination tile in regular order.

In some examples, during even stage NTT operations (FIG. 17(B)) operands are read from a second set of local register file banks in bit-reversed form (e.g., register file banks 2-3 1705-1707 and written (after processing by butterflies 1INVJ09 and 1711)) to a remote destination tile in regular order.

The operations are reversed for iNTT, and operands are read from a distant tile and written to the local RF bank.

In some examples, polynomial multiplications in the NTT domain involve a pair-wise coefficient modular multiplication a*b mod q where a, b are n-bit coefficients, and the 2n bit product a*b is reduced to a n-bit residue with respect to the n-bit prime modulus ‘q’.

In some examples, the datapath takes advantage of both or either Montgomery and optimized Barrett algorithms. In both cases three n-bit multiplications and n-bit conditional subtracts are required to implement n-bit modular multiplication. In the case of Montgomery reduction, the additional overhead of converting to and from Montgomery domain may be amortized across long chains of finite arithmetic operations. In the case of Barrett, there exist opportunities for using optimal primes during Barrett reduction that may convert one of the multiplication steps to shift and add optimization.

Conventional 32-bit Montgomery multipliers compute the modular product a*b mod q by first converting 32-bit operands a and b to their residues in the Montgomery domain (a′ and b′ respectively). The 64-bit product a′*b′ is then reduced back to a 32-bit result contained within the range [0, q] through a series of multiplications with a constant k and the modulus q (as shown below), where k=−q⁻¹ mod 2³².

$$Inputs : {a}^{′} = ( a \times {2}^{32} ) mod q , {b}^{′} = ( b \times {2}^{32} ) mod q , q , k = - {q}^{- 2} mod {2}^{32} \\ Output : {c}^{′} = ( a \times b \times {2}^{32} ) mod q \\ 1. m [ 63 : 0 ] = {a}^{′} [ 31 : 0 ] \times {b}^{′} [ 31 : 0 ] \\ 2. m [ 63 : 0 ] = m [ 63 : 0 ] + [ ( m [ 31 : 0 ] \times k ) mod {2}^{32} ] \\ 3. m [ 63 : 0 ] = m [ 63 : 0 ] + [ ( m [ 31 : 0 ] \times q ) ≫ 32 ] \\ 4. {c}^{′} = m [ 64 : 32 ] \\ 5. if ( {c}^{′} \geq q ) \\ {c}^{′} = {c}^{′} - q$$

A word-based implementation of the above multiplier shown below uses a pair of cascaded 16-bit multipliers to implement the 32-bit reduction in a 2-step process. Compared to the three 32-bit multipliers that the 32b Montgomery multiplier above requires, the word-based reduction approach (below) uses one 32b multiplier and four 16b multipliers, thus effectively reducing total area consumption by 33%.

Conventional ‘w-bit’ word-based reduction Montgomery multipliers utilize one 2w-bit multiplier and four w-bit multipliers, resulting in a long critical path delay with significant area and power overheads.

$$Inputs : {a}^{′} = ( a \times {2}^{32} ) mod q , {b}^{′} = ( b \times {2}^{32} ) mod q , q , k = - {q}^{- 1} mod {2}^{16} \\ Output : {c}^{′} = ( a \times b \times {2}^{32} ) mod q \\ 1. m [ 63 : 0 ] = {a}^{′} [ 31 : 0 ] \times {b}^{′} [ 31 : 0 ] \\ 2. m 1 [ 63 : 0 ] = m [ 63 : 0 ] + [ ( m [ 15 : 0 ] \times k ) mod {2}^{16} ] \\ 3. m 1 [ 63 : 0 ] = m 1 [ 63 : 0 ] + [ ( m 1 [ 15 : 0 ] \times q ) ≫ 16 ] \\ 4. m 2 [ 47 : 0 ] = m 1 [ 63 : 16 ] \\ 5. m 2 [ 47 : 0 ] = m 2 [ 47 : 0 ] + [ ( m 2 [ 15 : 0 ] \times k ) mod {2}^{16} ] \\ 6. m 2 [ 47 : 0 ] = m 2 [ 63 : 0 ] + [ ( m 2 [ 15 : 0 ] \times q ) ≫ 16 ] \\ 7. {c}^{′} = m 2 [ 47 : 16 ] \\ 8. if ( {c}^{′} \geq q ) \\ {c}^{′} = {c}^{′} - q$$

In some examples, the word-based reduction implementation is improved by employing a specific NTT-optimal moduli ‘q’ that eliminates two 16-bit multipliers from the critical path. In particular, the multipliers of lines 2 and 5 above.

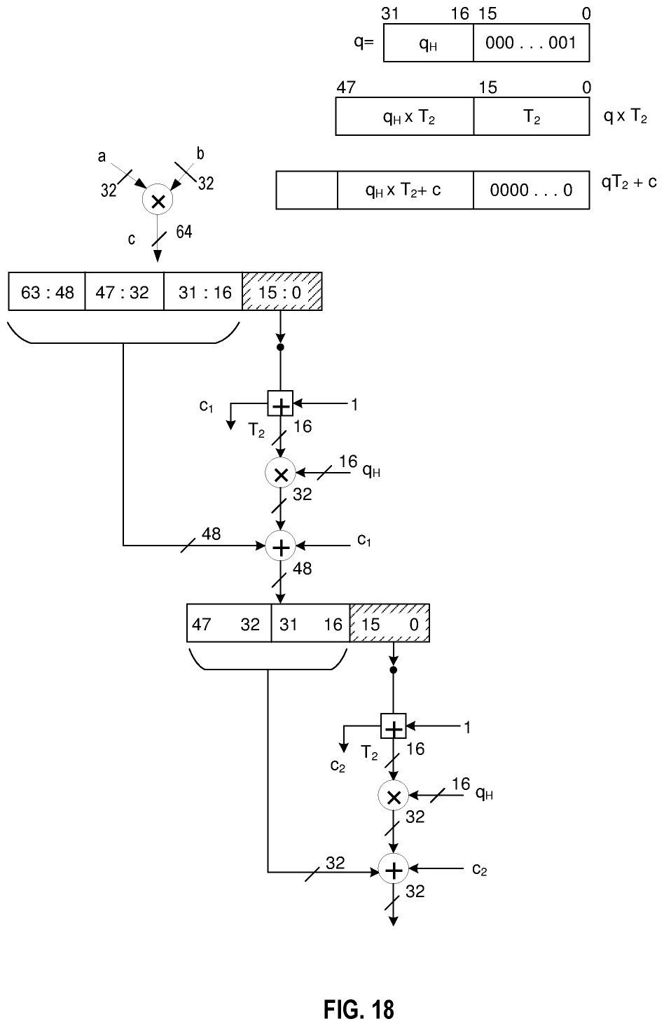

FIG. 18 illustrates examples of an improved Montgomery multiplication. NTT-optimal primes are selected as the modulus q, with the property that q mod 2^{w}=1. As a result of this constraint, the constant k=−1 and this reduces the two w-bit multipliers shown in stages (lines) 2 and 5 of the Montgomery multiplication into a simple 2's complement calculation (the c₁ and c₂ are carry values and the sum is a 16-bit value. All other calculations are the same as before. The NTT-optimal Montgomery multiplier thus reduces to a 2w-bit multiplier and two w-bit multipliers. Note that the 16-bit shifts are not explicitly shown in the diagram. The diagram also shows values for q (including a notation for the upper 16 bits of q), q*T₂ (the 2's complement of the lower 16 bits of c), and q*T₂+c₁. Note that the two illustrated T₂ values do not need to be the seam value.

This 2-stage reduction of the 64-bit product uses a 16-bit word reduction thus necessitating the constraint that q mod 2¹⁶=1. Note that the first stage occurs after the first multiplication and ends with the 48-bit output of the addition of c1 to the upper 48 bits of c. The second stage takes in that 48-bit value and ends with the 32-bit addition with c2. What is not shown is a conditional subtraction (e.g., aligning with lines 8 and 9 above).

An alternate implementation could use a 3-step reduction with 15-bit word reduction, with the NTT-optimal constraint of q mod 2¹⁵=1.

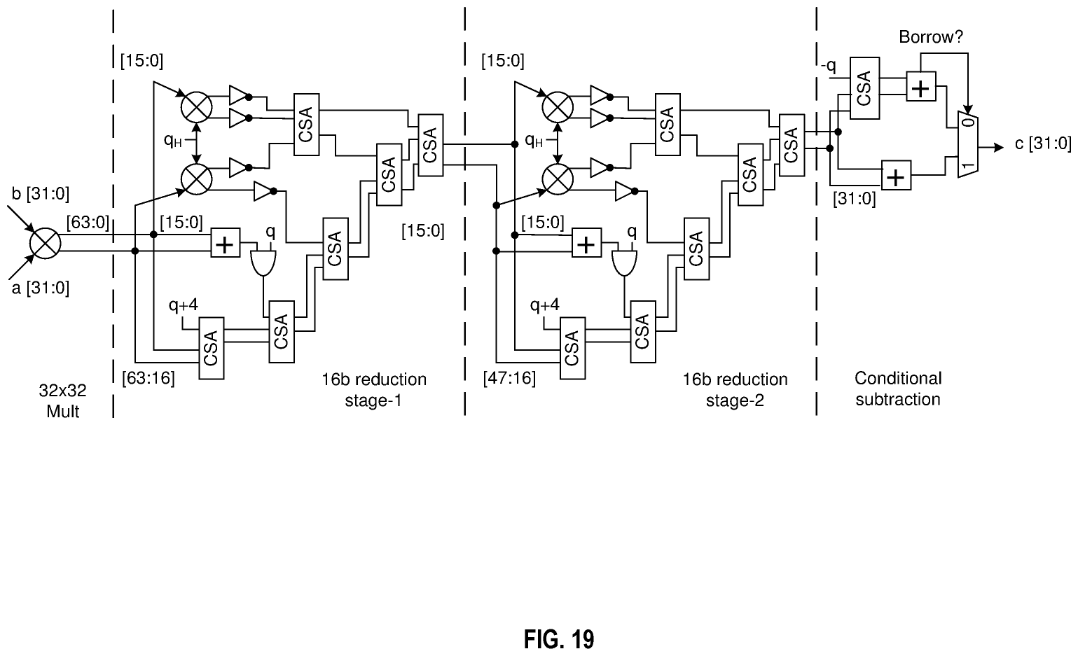

In some examples, the Montgomery-reduction in a carry-save format. A conventional Montgomery multiplier would first compute the product a*b in positional format by propagating the carries during partial product addition resulting in a 64-bit product (labelled ‘C’ in FIG. 18). This requires a fast 64-bit parallel-prefix adder as the last stage of the 64-bit multiplier that computes c=a*b. In some examples, the carry-propagation is postponed in the multiplier and the product is left ‘c’ in the carry-save format (having a carry and save portion). FIG. 19 illustrates examples of an NTT-optimized Montgomery multiplier that uses postponed carry-propagation. In some examples, the input values are stored in a register file and the destination is to be written to a register file, scratch pad, or high-bandwidth memory. Instead of a 64-bit product, a pair of 64-bit values that represent ‘c’ in carry-save format are generated. Subsequent multiplications with q_{H} are then done with both the carry and sum values of ‘c.’ Carry-propagation is now postponed to the end of the datapath using a single 32-bit parallel-prefix adder. Note that other data sizes may be used (e.g., non-32-bit, etc.).

In some examples, the NTT-optimal butterfly supports HE polynomial operations by gating inputs and sub-modules when simpler polynomial instructions (e.g., add, multiply) are executed. The use of NTT-optimal moduli simplify the datapath by eliminating two word-sized multipliers from the critical path. The use of carry-save reduction further eliminates a parallel-prefix carry-propagating adder.

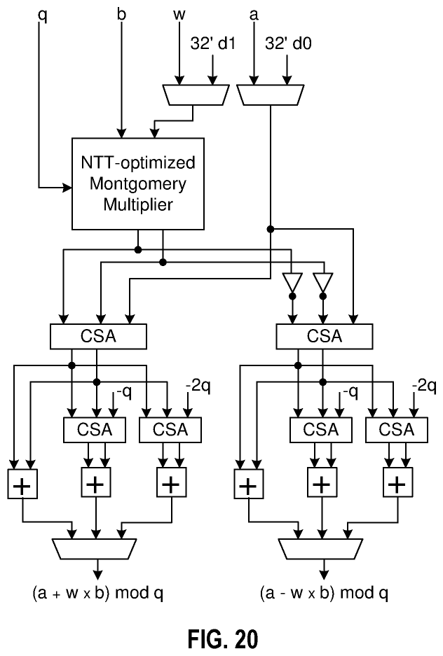

FIG. 20 illustrates examples of the use of NTT-optimized Montgomery multiplication in NTT or iNTT. Note that nothing is gated. In some examples, the input values are stored in a register file and the destination is to be written to a register file, scratch pad, or high-bandwidth memory.

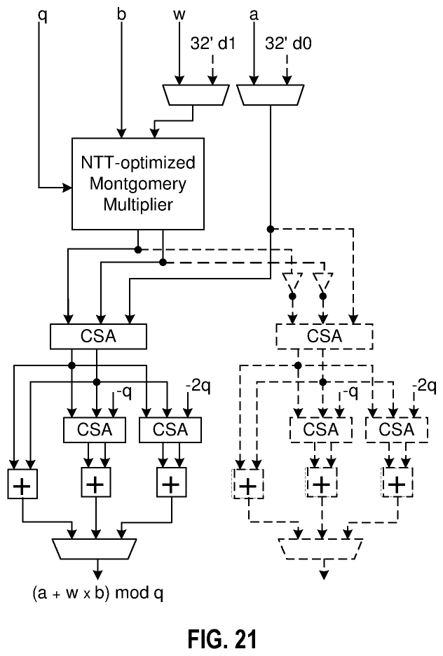

FIG. 21 illustrates examples of the use of NTT-optimized Montgomery multiplication in modular multiply-accumulate. In some examples, the input values are stored in a register file and the destination is to be written to a register file, scratch pad, or high bandwidth memory

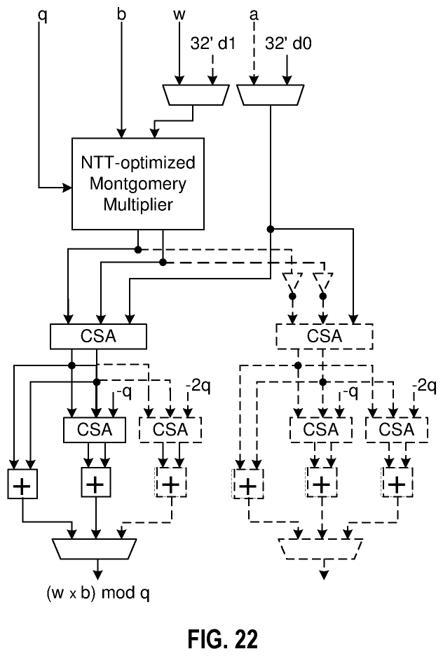

FIG. 22 illustrates examples of the use of NTT-optimized Montgomery multiplication in modular multiplication. In some examples, the input values are stored in a register file and the destination is to be written to a register file, scratch pad, or high bandwidth memory

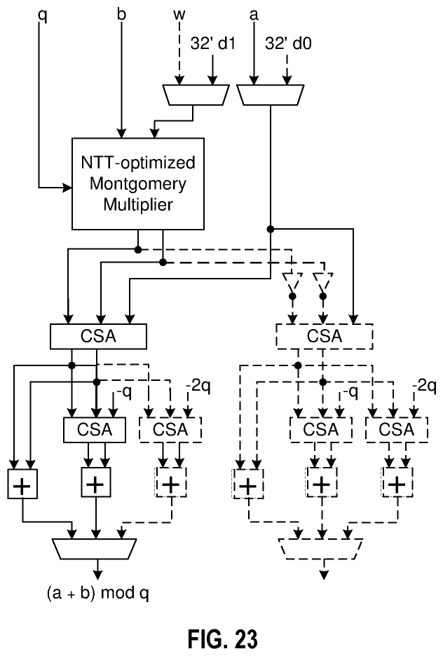

FIG. 23 illustrates examples of the use of NTT-optimized Montgomery multiplication in modular addition. In some examples, the input values are stored in a register file and the destination is to be written to a register file, scratch pad, or high bandwidth memory

In some examples, the use of NTT-optimal prime numbers as the modulus ‘q’ is specified such that the user is aware of q. Further, in some examples, the datapath will only work for prime moduli that satisfy the constraint q mod 2^{w}=1. The user will have to use a prime number that satisfies this constraint as the ciphertext modulus during encryption.

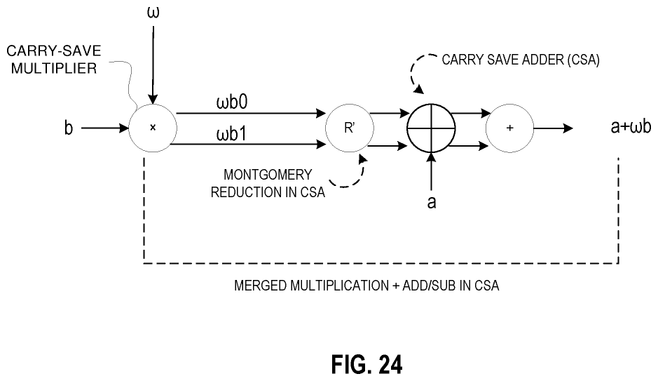

FIG. 24 illustrates examples of a butterfly datapath with CSA and Montgomery reduction. The native DIT butterfly is implemented by first computing the multiplier output (w*b) in carry-save format (using carry-save adders or a carry-save multiplier). This output is then reduced using Montgomery reduction (in carry-save format). The adder input ‘a’ is then added into the reduced product in carry-save format using a carry-save adder (CSA) and then finally, the carry-propagation is completed in the final output adder to generate a+ω*b.

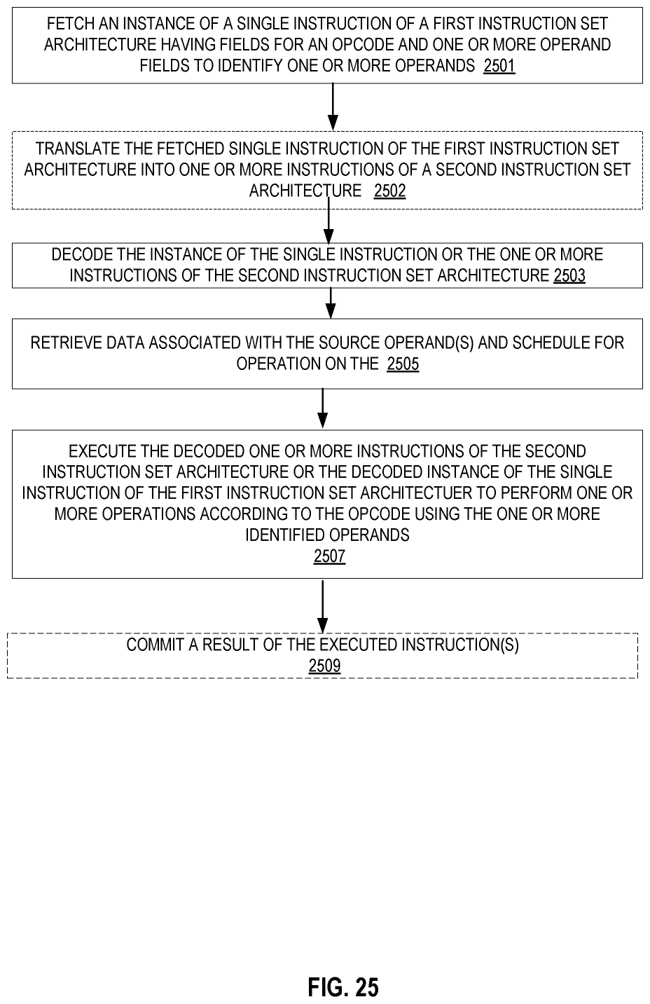

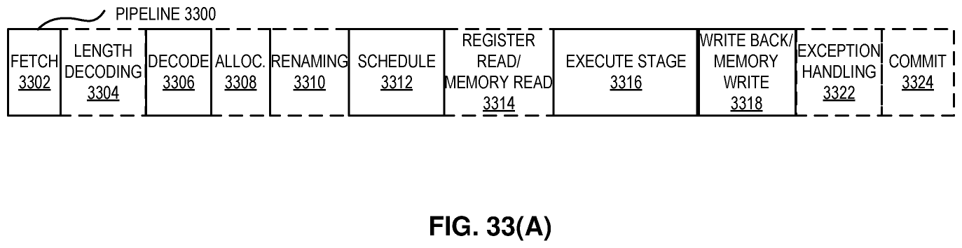

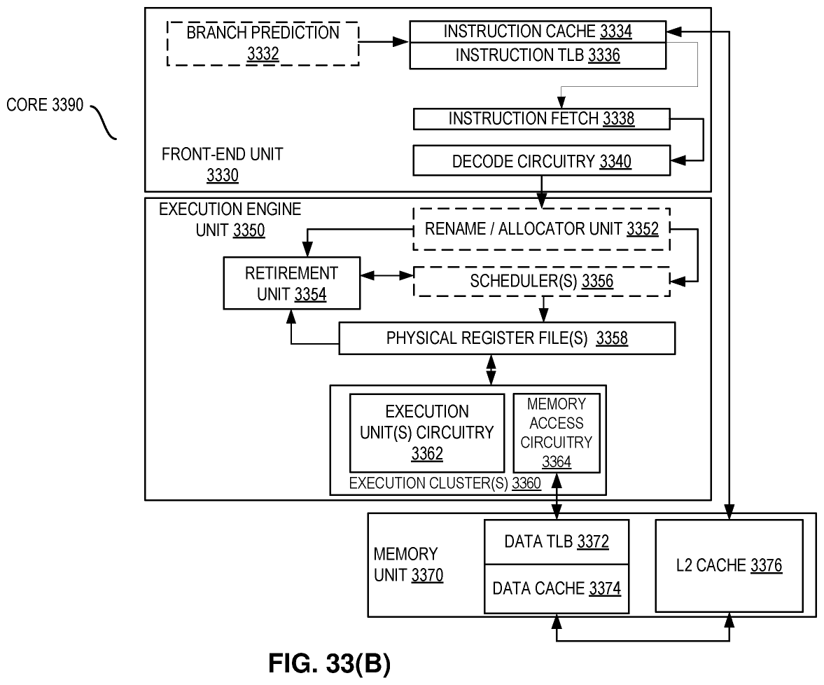

FIG. 25 illustrates an example method to process FHE accelerator instruction either directly or using emulation or binary translation. For example, a processor core as shown in FIG. 33(B), FHE accelerator 403, a pipeline, and/or emulation/translation layer perform aspects of this method.

An instance of a single instruction of a first instruction set architecture is fetched at 2501. The instance of the single instruction of the first instruction set architecture includes fields for an opcode and one or more operand fields to identify one or more operands (e.g., the operands indicated for the polynomial instructions (add, multiply, NTT, iNTT, etc.) detailed above). The opcode indicates one or more operations to perform.

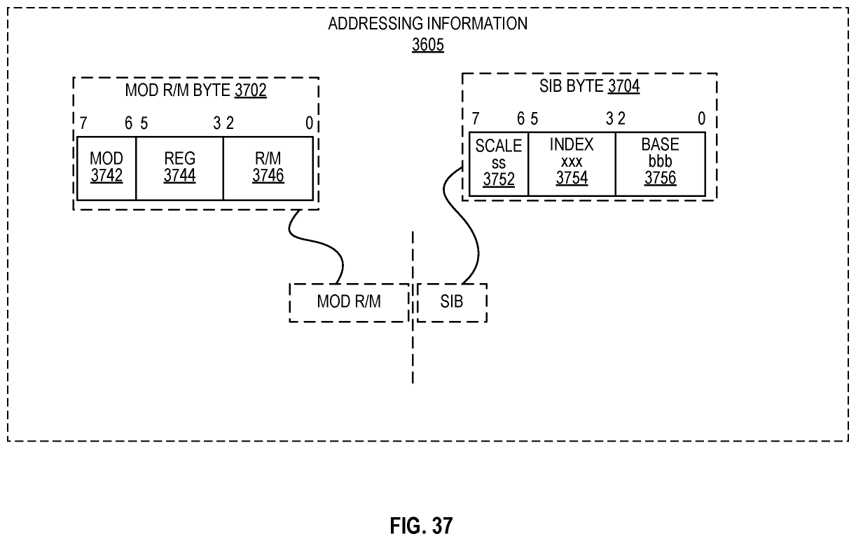

In some examples, the fetched single instruction of the first instruction set architecture is translated into one or more instructions of a second instruction set architecture at 2502. This translation is performed by a translation and/or emulation layer of software in some examples. In some examples, this translation is performed by an instruction converter 3712 as shown in FIG. 37. In some examples, the translation is performed by hardware translation circuitry.

The one or more translated instructions of the second instruction set architecture, or the instance of the single instruction of the first instruction set architecture, are/is decoded at 2503. For example, the translated instructions are decoded by decoder circuitry such as decoder circuitry ‘ISAB05 or decode circuitry 3340 detailed herein. In some examples, the operations of translation and decoding at 2502 and 2503 are merged.

Data values associated with the source operand(s) of the decoded one or more instructions of the second instruction set architecture or instances of the single instruction of the first ISA are retrieved (if needed, but in general non-memory instructions should have the data in the register file)) and the one or more instructions are scheduled at 2505.

At 2507, the decoded instruction(s) is/are executed by execution circuitry (hardware) such as execution circuitry the FHE accelerator 403 to perform the operation(s) indicated by the opcode using the indicated operands.

In some examples, the instruction is committed or retired at 2509.

Some examples utilize instruction formats described herein. Some examples are implemented in one or more computer architectures, cores, accelerators, etc. Some examples are generated or are IP cores. Some examples utilize emulation and/or translation.

### Example Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

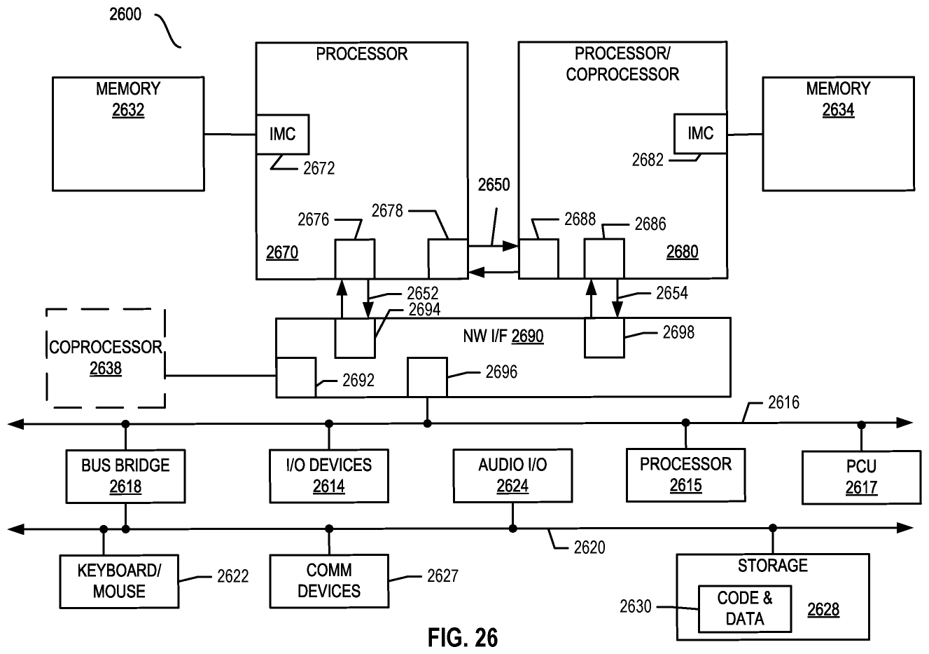

FIG. 26 illustrates an example computing system. Multiprocessor system 2600 is an interfaced system and includes a plurality of processors or cores including a first processor 2670 and a second processor 2680 coupled via an interface 2650 such as a point-to-point (P-P) interconnect, a fabric, and/or bus. In some examples, the first processor 2670 and the second processor 2680 are homogeneous. In some examples, first processor 2670 and the second processor 2680 are heterogenous. Though the example system 2600 is shown to have two processors, the system may have three or more processors, or may be a single processor system. In some examples, the computing system is a system on a chip (SoC).

Processors 2670 and 2680 are shown including integrated memory controller (IMC) circuitry 2672 and 2682, respectively. Processor 2670 also includes interface circuits 2676 and 2678; similarly, second processor 2680 includes interface circuits 2686 and 2688. Processors 2670, 2680 may exchange information via the interface 2650 using interface circuits 2678, 2688. IMCs 2672 and 2682 couple the processors 2670, 2680 to respective memories, namely a memory 2632 and a memory 2634, which may be portions of main memory locally attached to the respective processors.

Processors 2670, 2680 may each exchange information with a network interface (NW I/F) 2690 via individual interfaces 2652, 2654 using interface circuits 2676, 2694, 2686, 2698. The network interface 2690 (e.g., one or more of an interconnect, bus, and/or fabric, and in some examples is a chipset) may optionally exchange information with a coprocessor 2638 via an interface circuit 2692. In some examples, the coprocessor 2638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 2670, 2680 or outside of both processors, yet connected with the processors via an interface such as P-P interconnect, such that either or both processors' local cache information may be stored in the shared cache if a processor is placed into a low power mode.

Network interface 2690 may be coupled to a first interface 2616 via interface circuit 2696. In some examples, first interface 2616 may be an interface such as a Peripheral Component Interconnect (PCI) interconnect, a PCI Express interconnect or another I/O interconnect. In some examples, first interface 2616 is coupled to a power control unit (PCU) 2617, which may include circuitry, software, and/or firmware to perform power management operations with regard to the processors 2670, 2680 and/or co-processor 2638. PCU 2617 provides control information to a voltage regulator (not shown) to cause the voltage regulator to generate the appropriate regulated voltage. PCU 2617 also provides control information to control the operating voltage generated. In various examples, PCU 2617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 2617 is illustrated as being present as logic separate from the processor 2670 and/or processor 2680. In other cases, PCU 2617 may execute on a given one or more of cores (not shown) of processor 2670 or 2680. In some cases, PCU 2617 may be implemented as a microcontroller (dedicated or general-purpose) or other control logic configured to execute its own dedicated power management code, sometimes referred to as P-code. In yet other examples, power management operations to be performed by PCU 2617 may be implemented externally to a processor, such as by way of a separate power management integrated circuit (PMIC) or another component external to the processor. In yet other examples, power management operations to be performed by PCU 2617 may be implemented within BIOS or other system software.

Various I/O devices 2614 may be coupled to first interface 2616, along with a bus bridge 2618 which couples first interface 2616 to a second interface 2620. In some examples, one or more additional processor(s) 2615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 2616. In some examples, second interface 2620 may be a low pin count (LPC) interface. Various devices may be coupled to second interface 2620 including, for example, a keyboard and/or mouse 2622, communication devices 2627 and storage circuitry 2628. Storage circuitry 2628 may be one or more non-transitory machine-readable storage media as described below, such as a disk drive or other mass storage device which may include instructions/code and data 2630 and may implement the storage ‘ISAB03 in some examples. Further, an audio I/O 2624 may be coupled to second interface 2620. Note that other architectures than the point-to-point architecture described above are possible. For example, instead of the point-to-point architecture, a system such as multiprocessor system 2600 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

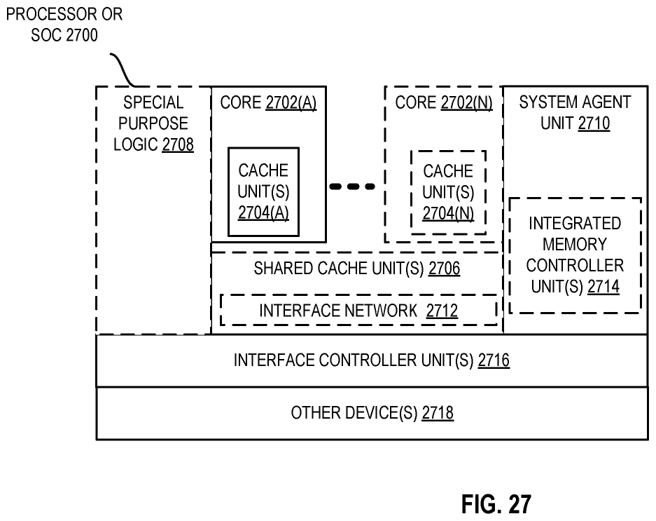

FIG. 27 illustrates a block diagram of an example processor and/or SoC 2700 that may have one or more cores and an integrated memory controller. The solid lined boxes illustrate a processor 2700 with a single core 2702(A), system agent unit circuitry 2710, and a set of one or more interface controller unit(s) circuitry 2716, while the optional addition of the dashed lined boxes illustrates an alternative processor 2700 with multiple cores 2702(A)-(N), a set of one or more integrated memory controller unit(s) circuitry 2714 in the system agent unit circuitry 2710, and special purpose logic 2708, as well as a set of one or more interface controller units circuitry 2716. Note that the processor 2700 may be one of the processors 2670 or 2680, or co-processor 2638 or 2615 of FIG. 26.

Thus, different implementations of the processor 2700 may include: 1) a CPU with the special purpose logic 2708 being integrated graphics and/or scientific (throughput) logic (which may include one or more cores, not shown), and the cores 2702(A)-(N) being one or more general purpose cores (e.g., general purpose in-order cores, general purpose out-of-order cores, or a combination of the two); 2) a coprocessor with the cores 2702(A)-(N) being a large number of special purpose cores intended primarily for graphics and/or scientific (throughput); and 3) a coprocessor with the cores 2702(A)-(N) being a large number of general purpose in-order cores. Thus, the processor 2700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 2700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 2704(A)-(N) within the cores 2702(A)-(N), a set of one or more shared cache unit(s) circuitry 2706, and external memory (not shown) coupled to the set of integrated memory controller unit(s) circuitry 2714. The set of one or more shared cache unit(s) circuitry 2706 may include one or more mid-level caches, such as level 2 (L2), level 3 (L3), level 4 (L4), or other levels of cache, such as a last level cache (LLC), and/or combinations thereof. While in some examples interface network circuitry 2712 (e.g., a ring interconnect) interfaces the special purpose logic 2708 (e.g., integrated graphics logic), the set of shared cache unit(s) circuitry 2706, and the system agent unit circuitry 2710, alternative examples use any number of well-known techniques for interfacing such units. In some examples, coherency is maintained between one or more of the shared cache unit(s) circuitry 2706 and cores 2702(A)-(N). In some examples, interface controller units circuitry 2716 couple the cores 2702 to one or more other devices 2718 such as one or more I/O devices, storage, one or more communication devices (e.g., wireless networking, wired networking, etc.), etc.

In some examples, one or more of the cores 2702(A)-(N) are capable of multi-threading. The system agent unit circuitry 2710 includes those components coordinating and operating cores 2702(A)-(N). The system agent unit circuitry 2710 may include, for example, power control unit (PCU) circuitry and/or display unit circuitry (not shown). The PCU may be or may include logic and components needed for regulating the power state of the cores 2702(A)-(N) and/or the special purpose logic 2708 (e.g., integrated graphics logic). The display unit circuitry is for driving one or more externally connected displays.

The cores 2702(A)-(N) may be homogenous in terms of instruction set architecture (ISA). Alternatively, the cores 2702(A)-(N) may be heterogeneous in terms of ISA; that is, a subset of the cores 2702(A)-(N) may be capable of executing an ISA, while other cores may be capable of executing only a subset of that ISA or another ISA.

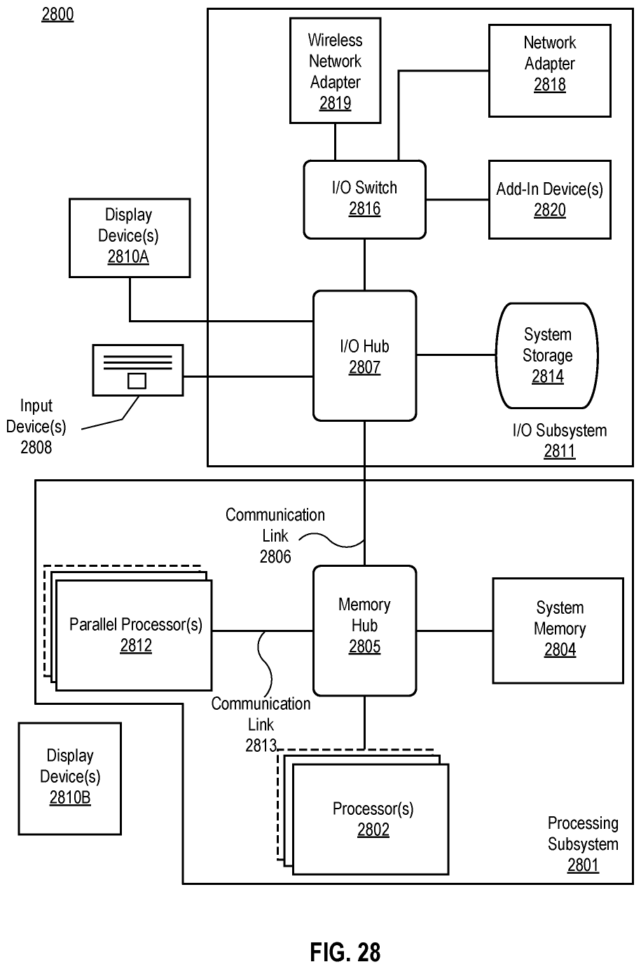

FIG. 28 is a block diagram illustrating a computing system 2800 configured to implement one or more aspects of the examples described herein. The computing system 2800 includes a processing subsystem 2801 having one or more processor(s) 2802 and a system memory 2804 communicating via an interconnection path that may include a memory hub 2805. The memory hub 2805 may be a separate component within a chipset component or may be integrated within the one or more processor(s) 2802. The memory hub 2805 couples with an I/O subsystem 2811 via a communication link 2806. The I/O subsystem 2811 includes an I/O hub 2807 that can enable the computing system 2800 to receive input from one or more input device(s) 2808. Additionally, the I/O hub 2807 can enable a display controller, which may be included in the one or more processor(s) 2802, to provide outputs to one or more display device(s) 2810A. In some examples the one or more display device(s) 2810A coupled with the I/O hub 2807 can include a local, internal, or embedded display device.

The processing subsystem 2801, for example, includes one or more parallel processor(s) 2812 coupled to memory hub 2805 via a bus or other communication link 2813. The communication link 2813 may be one of any number of standards-based communication link technologies or protocols, such as, but not limited to PCI Express, or may be a vendor specific communications interface or communications fabric. The one or more parallel processor(s) 2812 may form a computationally focused parallel or vector processing system that can include a large number of processing cores and/or processing clusters, such as a many integrated core (MIC) processor. For example, the one or more parallel processor(s) 2812 form a graphics processing subsystem that can output pixels to one of the one or more display device(s) 2810A coupled via the I/O hub 2807. The one or more parallel processor(s) 2812 can also include a display controller and display interface (not shown) to enable a direct connection to one or more display device(s) 2810B.

Within the I/O subsystem 2811, a system storage unit 2814 can connect to the I/O hub 2807 to provide a storage mechanism for the computing system 2800. An I/O switch 2816 can be used to provide an interface mechanism to enable connections between the I/O hub 2807 and other components, such as a network adapter 2818 and/or wireless network adapter 2819 that may be integrated into the platform, and various other devices that can be added via one or more add-in device(s) 2820. The add-in device(s) 2820 may also include, for example, one or more external graphics processor devices, graphics cards, and/or compute accelerators. The network adapter 2818 can be an Ethernet adapter or another wired network adapter. The wireless network adapter 2819 can include one or more of a Wi-Fi, Bluetooth, near field communication (NFC), or other network device that includes one or more wireless radios.

The computing system 2800 can include other components not explicitly shown, including USB or other port connections, optical storage drives, video capture devices, and the like, which may also be connected to the I/O hub 2807. Communication paths interconnecting the various components in FIG. 28 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, orwired orwireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 2812 may incorporate circuitry optimized for graphics and video processing, including, for example, video output circuitry, and constitutes a graphics processing unit (GPU). Alternatively or additionally, the one or more parallel processor(s) 2812 can incorporate circuitry optimized for general purpose processing, while preserving the underlying computational architecture, described in greater detail herein. Components of the computing system 2800 may be integrated with one or more other system elements on a single integrated circuit. For example, the one or more parallel processor(s) 2812, memory hub 2805, processor(s) 2802, and I/O hub 2807 can be integrated into a system on chip (SoC) integrated circuit. Alternatively, the components of the computing system 2800 can be integrated into a single package to form a system in package (SIP) configuration. In some examples at least a portion of the components of the computing system 2800 can be integrated into a multi-chip module (MCM), which can be interconnected with other multi-chip modules into a modular computing system.

It will be appreciated that the computing system 2800 shown herein is illustrative and that variations and modifications are possible. The connection topology, including the number and arrangement of bridges, the number of processor(s) 2802, and the number of parallel processor(s) 2812, may be modified as desired. For instance, system memory 2804 can be connected to the processor(s) 2802 directly rather than through a bridge, while other devices communicate with system memory 2804 via the memory hub 2805 and the processor(s) 2802. In other alternative topologies, the parallel processor(s) 2812 are connected to the I/O hub 2807 or directly to one of the one or more processor(s) 2802, rather than to the memory hub 2805. In other examples, the I/O hub 2807 and memory hub 2805 may be integrated into a single chip. It is also possible that two or more sets of processor(s) 2802 are attached via multiple sockets, which can couple with two or more instances of the parallel processor(s) 2812.

Some of the particular components shown herein are optional and may not be included in all implementations of the computing system 2800. For example, any number of add-in cards or peripherals may be supported, or some components may be eliminated. Furthermore, some architectures may use different terminology for components similar to those illustrated in FIG. 28. For example, the memory hub 2805 may be referred to as a Northbridge in some architectures, while the I/O hub 2807 may be referred to as a Southbridge.

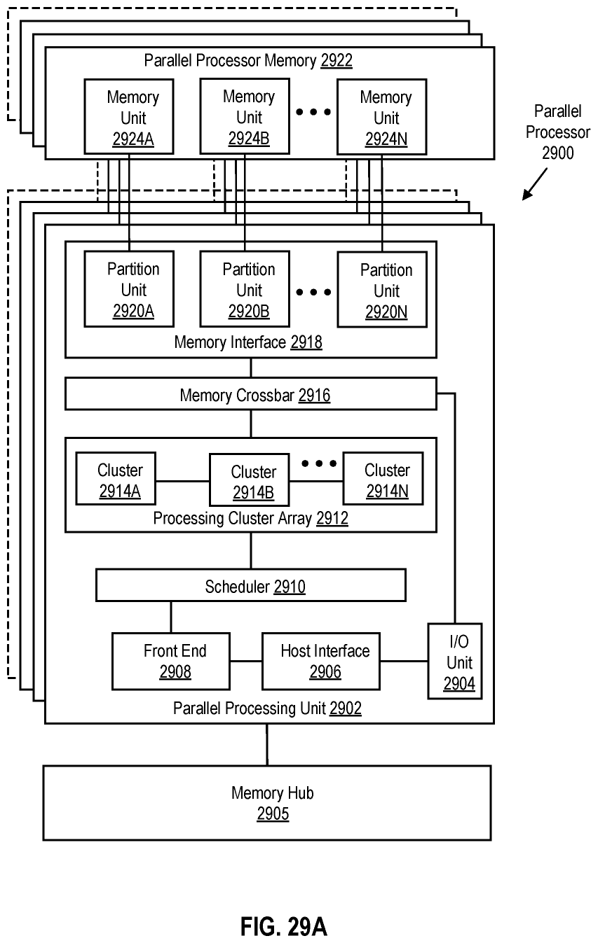

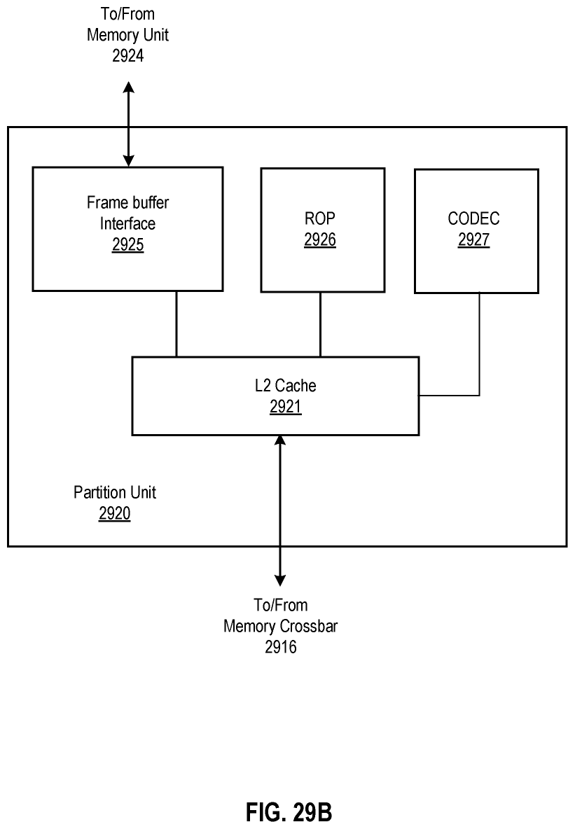

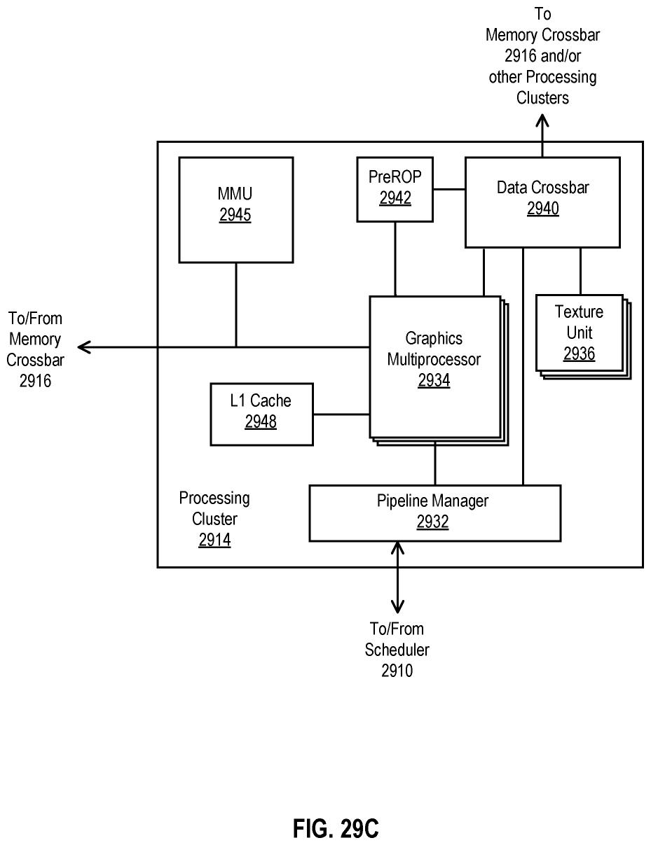

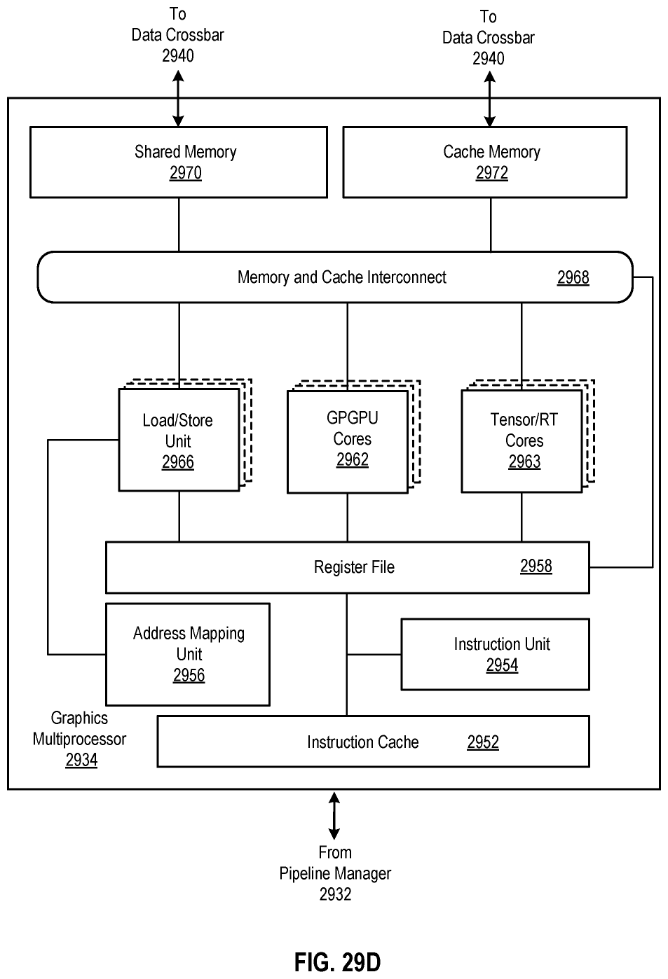

FIG. 29A illustrates examples of a parallel processor 2900. The parallel processor 2900 may be a GPU, GPGPU or the like as described herein. The various components of the parallel processor 2900 may be implemented using one or more integrated circuit devices, such as programmable processors, application specific integrated circuits (ASICs), or field programmable gate arrays (FPGA). The illustrated parallel processor 2900 may be one or more of the parallel processor(s) 2812 shown in FIG. 28.

The parallel processor 2900 includes a parallel processing unit 2902. The parallel processing unit includes an I/O unit 2904 that enables communication with other devices, including other instances of the parallel processing unit 2902. The I/O unit 2904 may be directly connected to other devices. For instance, the I/O unit 2904 connects with other devices via the use of a hub or switch interface, such as memory hub 2805. The connections between the memory hub 2805 and the I/O unit 2904 form a communication link 2813. Within the parallel processing unit 2902, the I/O unit 2904 connects with a host interface 2906 and a memory crossbar 2916, where the host interface 2906 receives commands directed to performing processing operations and the memory crossbar 2916 receives commands directed to performing memory operations.

When the host interface 2906 receives a command buffer via the I/O unit 2904, the host interface 2906 can direct work operations to perform those commands to a front end 2908. In some examples the front end 2908 couples with a scheduler 2910, which is configured to distribute commands or other work items to a processing cluster array 2912. The scheduler 2910 ensures that the processing cluster array 2912 is properly configured and in a valid state before tasks are distributed to the processing clusters of the processing cluster array 2912. The scheduler 2910 may be implemented via firmware logic executing on a microcontroller. The microcontroller implemented scheduler 2910 is configurable to perform complex scheduling and work distribution operations at coarse and fine granularity, enabling rapid preemption and context switching of threads executing on the processing cluster array 2912. Preferably, the host software can prove workloads for scheduling on the processing cluster array 2912 via one of multiple graphics processing doorbells. In other examples, polling for new workloads or interrupts can be used to identify or indicate availability of work to perform. The workloads can then be automatically distributed across the processing cluster array 2912 by the scheduler 2910 logic within the scheduler microcontroller.

The processing cluster array 2912 can include up to “N” processing clusters (e.g., cluster 2914A, cluster 2914B, through cluster 2914N). Each cluster 2914A-2914N of the processing cluster array 2912 can execute a large number of concurrent threads. The scheduler 2910 can allocate work to the clusters 2914A-2914N of the processing cluster array 2912 using various scheduling and/or work distribution algorithms, which may vary depending on the workload arising for each type of program or computation. The scheduling can be handled dynamically by the scheduler 2910 or can be assisted in part by compiler logic during compilation of program logic configured for execution by the processing cluster array 2912. Optionally, different clusters 2914A-2914N of the processing cluster array 2912 can be allocated for processing different types of programs or for performing different types of computations.

The processing cluster array 2912 can be configured to perform various types of parallel processing operations. For example, the processing cluster array 2912 is configured to perform general-purpose parallel compute operations. For example, the processing cluster array 2912 can include logic to execute processing tasks including filtering of video and/or audio data, performing modeling operations, including physics operations, and performing data transformations.

The processing cluster array 2912 is configured to perform parallel graphics processing operations. In such examples in which the parallel processor 2900 is configured to perform graphics processing operations, the processing cluster array 2912 can include additional logic to support the execution of such graphics processing operations, including, but not limited to texture sampling logic to perform texture operations, as well as tessellation logic and other vertex processing logic. Additionally, the processing cluster array 2912 can be configured to execute graphics processing related shader programs such as, but not limited to vertex shaders, tessellation shaders, geometry shaders, and pixel shaders. The parallel processing unit 2902 can transfer data from system memory via the I/O unit 2904 for processing. During processing the transferred data can be stored to on-chip memory (e.g., parallel processor memory 2922) during processing, then written back to system memory.

In examples in which the parallel processing unit 2902 is used to perform graphics processing, the scheduler 2910 may be configured to divide the processing workload into approximately equal sized tasks, to better enable distribution of the graphics processing operations to multiple clusters 2914A-2914N of the processing cluster array 2912. In some of these examples, portions of the processing cluster array 2912 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 2914A-2914N may be stored in buffers to allow the intermediate data to be transmitted between clusters 2914A-2914N for further processing.

During operation, the processing cluster array 2912 can receive processing tasks to be executed via the scheduler 2910, which receives commands defining processing tasks from front end 2908. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 2910 may be configured to fetch the indices corresponding to the tasks or may receive the indices from the front end 2908. The front end 2908 can be configured to ensure the processing cluster array 2912 is configured to a valid state before the workload specified by incoming command buffers (e.g., batch-buffers, push buffers, etc.) is initiated.

Each of the one or more instances of the parallel processing unit 2902 can couple with parallel processor memory 2922. The parallel processor memory 2922 can be accessed via the memory crossbar 2916, which can receive memory requests from the processing cluster array 2912 as well as the I/O unit 2904. The memory crossbar 2916 can access the parallel processor memory 2922 via a memory interface 2918. The memory interface 2918 can include multiple partition units (e.g., partition unit 2920A, partition unit 2920B, through partition unit 2920N) that can each couple to a portion (e.g., memory unit) of parallel processor memory 2922. The number of partition units 2920A-2920N may be configured to be equal to the number of memory units, such that a first partition unit 2920A has a corresponding first memory unit 2924A, a second partition unit 2920B has a corresponding second memory unit 2924B, and an Nth partition unit 2920N has a corresponding Nth memory unit 2924N. In other examples, the number of partition units 2920A-2920N may not be equal to the number of memory devices.

The memory units 2924A-2924N can include various types of memory devices, including dynamic random-access memory (DRAM) or graphics random access memory, such as synchronous graphics random access memory (SGRAM), including graphics double data rate (GDDR) memory. Optionally, the memory units 2924A-2924N may also include 3D stacked memory, including but not limited to high bandwidth memory (HBM). Persons skilled in the art will appreciate that the specific implementation of the memory units 2924A-2924N can vary and can be selected from one of various conventional designs. Render targets, such as frame buffers or texture maps may be stored across the memory units 2924A-2924N, allowing partition units 2920A-2920N to write portions of each render target in parallel to efficiently use the available bandwidth of parallel processor memory 2922. In some examples, a local instance of the parallel processor memory 2922 may be excluded in favor of a unified memory design that utilizes system memory in conjunction with local cache memory.

Optionally, any one of the clusters 2914A-2914N of the processing cluster array 2912 has the ability to process data that will be written to any of the memory units 2924A-2924N within parallel processor memory 2922. The memory crossbar 2916 can be configured to transfer the output of each cluster 2914A-2914N to any partition unit 2920A-2920N or to another cluster 2914A-2914N, which can perform additional processing operations on the output. Each cluster 2914A-2914N can communicate with the memory interface 2918 through the memory crossbar 2916 to read from or write to various external memory devices. In one of the examples with the memory crossbar 2916 the memory crossbar 2916 has a connection to the memory interface 2918 to communicate with the I/O unit 2904, as well as a connection to a local instance of the parallel processor memory 2922, enabling the processing units within the different processing clusters 2914A-2914N to communicate with system memory or other memory that is not local to the parallel processing unit 2902. Generally, the memory crossbar 2916 may, for example, be able to use virtual channels to separate traffic streams between the clusters 2914A-2914N and the partition units 2920A-2920N.

While a single instance of the parallel processing unit 2902 is illustrated within the parallel processor 2900, any number of instances of the parallel processing unit 2902 can be included. For example, multiple instances of the parallel processing unit 2902 can be provided on a single add-in card, or multiple add-in cards can be interconnected. For example, the parallel processor 2900 can be an add-in device, such as add-in device 2820 of FIG. 28, which may be a graphics card such as a discrete graphics card that includes one or more GPUs, one or more memory devices, and device-to-device or network or fabric interfaces. The different instances of the parallel processing unit 2902 can be configured to inter-operate even if the different instances have different numbers of processing cores, different amounts of local parallel processor memory, and/or other configuration differences. Optionally, some instances of the parallel processing unit 2902 can include higher precision floating point units relative to other instances. Systems incorporating one or more instances of the parallel processing unit 2902 or the parallel processor 2900 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

In some examples, the parallel processing unit 2902 can be partitioned into multiple instances. Those multiple instances can be configured to execute workloads associated with different clients in an isolated manner, enabling a pre-determined quality of service to be provided for each client. For example, each cluster 2914A-2914N can be compartmentalized and isolated from other clusters, allowing the processing cluster array 2912 to be divided into multiple compute partitions or instances. In such configuration, workloads that execute on an isolated partition are protected from faults or errors associated with a different workload that executes on a different partition. The partition units 2920A-2920N can be configured to enable a dedicated and/or isolated path to memory for the clusters 2914A-2914N associated with the respective compute partitions. This datapath isolation enables the compute resources within a partition can communicate with one or more assigned memory units 2924A-2924N without being subjected to inference by the activities of other partitions.

FIG. 29B is a block diagram of a partition unit 2920. The partition unit 2920 may be an instance of one of the partition units 2920A-2920N of FIG. 29A. As illustrated, the partition unit 2920 includes an L2 cache 2921, a frame buffer interface 2925, and a ROP 2926 (raster operations unit). The L2 cache 2921 is a read/write cache that is configured to perform load and store operations received from the memory crossbar 2916 and ROP 2926. Read misses and urgent write-back requests are output by L2 cache 2921 to frame buffer interface 2925 for processing. Updates can also be sent to the frame buffer via the frame buffer interface 2925 for processing. In some examples the frame buffer interface 2925 interfaces with one of the memory units in parallel processor memory, such as the memory units 2924A-2924N of FIG. 29A (e.g., within parallel processor memory 2922). The partition unit 2920 may additionally or alternatively also interface with one of the memory units in parallel processor memory via a memory controller (not shown).

In graphics applications, the ROP 2926 is a processing unit that performs raster operations such as stencil, z test, blending, and the like. The ROP 2926 then outputs processed graphics data that is stored in graphics memory. In some examples the ROP 2926 includes or couples with a CODEC 2927 that includes compression logic to compress depth or color data that is written to memory or the L2 cache 2921 and decompress depth or color data that is read from memory or the L2 cache 2921. The compression logic can be lossless compression logic that makes use of one or more of multiple compression algorithms. The type of compression that is performed by the CODEC 2927 can vary based on the statistical characteristics of the data to be compressed. For example, in some examples, delta color compression is performed on depth and color data on a per-tile basis. In some examples the CODEC 2927 includes compression and decompression logic that can compress and decompress compute data associated with machine learning operations. The CODEC 2927 can, for example, compress sparse matrix data for sparse machine learning operations. The CODEC 2927 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

The ROP 2926 may be included within each processing cluster (e.g., cluster 2914A-2914N of FIG. 29A) instead of within the partition unit 2920. In such example, read and write requests for pixel data are transmitted over the memory crossbar 2916 instead of pixel fragment data. The processed graphics data may be displayed on a display device, such as one of the one or more display device(s) 2810A-2810B of FIG. 28, routed for further processing by the processor(s) 2802, or routed for further processing by one of the processing entities within the parallel processor 2900 of FIG. 29A.

FIG. 29C is a block diagram of a processing cluster 2914 within a parallel processing unit. For example, the processing cluster is an instance of one of the processing clusters 2914A-2914N of FIG. 29A. The processing cluster 2914 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within each one of the processing clusters. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of the processing cluster 2914 can be controlled via a pipeline manager 2932 that distributes processing tasks to SIMT parallel processors. The pipeline manager 2932 receives instructions from the scheduler 2910 of FIG. 29A and manages execution of those instructions via a graphics multiprocessor 2934 and/or a texture unit 2936. The illustrated graphics multiprocessor 2934 is an exemplary instance of a SIMT parallel processor. However, various types of SIMT parallel processors of differing architectures may be included within the processing cluster 2914. One or more instances of the graphics multiprocessor 2934 can be included within a processing cluster 2914. The graphics multiprocessor 2934 can process data and a data crossbar 2940 can be used to distribute the processed data to one of multiple possible destinations, including other shader units. The pipeline manager 2932 can facilitate the distribution of processed data by specifying destinations for processed data to be distributed via the data crossbar 2940.

Each graphics multiprocessor 2934 within the processing cluster 2914 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 2914 constitute a thread. A set of threads executing across the set of parallel processing engines is a thread group. A thread group executes the same program on different input data. Each thread within a thread group can be assigned to a different processing engine within a graphics multiprocessor 2934. A thread group may include fewer threads than the number of processing engines within the graphics multiprocessor 2934. When a thread group includes fewer threads than the number of processing engines, one or more of the processing engines may be idle during cycles in which that thread group is being processed. A thread group may also include more threads than the number of processing engines within the graphics multiprocessor 2934. When the thread group includes more threads than the number of processing engines within the graphics multiprocessor 2934, processing can be performed over consecutive clock cycles. Optionally, multiple thread groups can be executed concurrently on the graphics multiprocessor 2934.

The graphics multiprocessor 2934 may include an internal cache memory to perform load and store operations. Optionally, the graphics multiprocessor 2934 can forego an internal cache and use a cache memory (e.g., level 1 (L1) cache 2948) within the processing cluster 2914. Each graphics multiprocessor 2934 also has access to level 2 (L2) caches within the partition units (e.g., partition units 2920A-2920N of FIG. 29A) that are shared among all processing clusters 2914 and may be used to transfer data between threads. The graphics multiprocessor 2934 may also access off-chip global memory, which can include one or more of local parallel processor memory and/or system memory. Any memory external to the parallel processing unit 2902 may be used as global memory. Embodiments in which the processing cluster 2914 includes multiple instances of the graphics multiprocessor 2934 can share common instructions and data, which may be stored in the L1 cache 2948.

Each processing cluster 2914 may include an MMU 2945 (memory management unit) that is configured to map virtual addresses into physical addresses. In other examples, one or more instances of the MMU 2945 may reside within the memory interface 2918 of FIG. 29A. The MMU 2945 includes a set of page table entries (PTEs) used to map a virtual address to a physical address of a tile and optionally a cache line index. The MMU 2945 may include address translation lookaside buffers (TLB) or caches that may reside within the graphics multiprocessor 2934 or the L1 cache 2948 of processing cluster 2914. The physical address is processed to distribute surface data access locality to allow efficient request interleaving among partition units. The cache line index may be used to determine whether a request for a cache line is a hit or miss.

In graphics and computing applications, a processing cluster 2914 may be configured such that each graphics multiprocessor 2934 is coupled to a texture unit 2936 for performing texture mapping operations, e.g., determining texture sample positions, reading texture data, and filtering the texture data. Texture data is read from an internal texture L1 cache (not shown) or in some examples from the L1 cache within graphics multiprocessor 2934 and is fetched from an L2 cache, local parallel processor memory, or system memory, as needed. Each graphics multiprocessor 2934 outputs processed tasks to the data crossbar 2940 to provide the processed task to another processing cluster 2914 for further processing or to store the processed task in an L2 cache, local parallel processor memory, or system memory via the memory crossbar 2916. A preROP 2942 (pre-raster operations unit) is configured to receive data from graphics multiprocessor 2934, direct data to ROP units, which may be located with partition units as described herein (e.g., partition units 2920A-2920N of FIG. 29A). The preROP 2942 unit can perform optimizations for color blending, organize pixel color data, and perform address translations.

It will be appreciated that the core architecture described herein is illustrative and that variations and modifications are possible. Any number of processing units, e.g., graphics multiprocessor 2934, texture units 2936, preROPs 2942, etc., may be included within a processing cluster 2914. Further, while only one processing cluster 2914 is shown, a parallel processing unit as described herein may include any number of instances of the processing cluster 2914. Optionally, each processing cluster 2914 can be configured to operate independently of other processing clusters 2914 using separate and distinct processing units, L1 caches, L2 caches, etc.

FIG. 29D shows an example of the graphics multiprocessor 2934 in which the graphics multiprocessor 2934 couples with the pipeline manager 2932 of the processing cluster 2914. The graphics multiprocessor 2934 has an execution pipeline including but not limited to an instruction cache 2952, an instruction unit 2954, an address mapping unit 2956, a register file 2958, one or more general purpose graphics processing unit (GPGPU) cores 2962, and one or more load/store units 2966. The GPGPU cores 2962 and load/store units 2966 are coupled with cache memory 2972 and shared memory 2970 via a memory and cache interconnect 2968. The graphics multiprocessor 2934 may additionally include tensor and/or ray-tracing cores 2963 that include hardware logic to accelerate matrix and/or ray-tracing operations.

The instruction cache 2952 may receive a stream of instructions to execute from the pipeline manager 2932. The instructions are cached in the instruction cache 2952 and dispatched for execution by the instruction unit 2954. The instruction unit 2954 can dispatch instructions as thread groups (e.g., warps), with each thread of the thread group assigned to a different execution unit within GPGPU core 2962. An instruction can access any of a local, shared, or global address space by specifying an address within a unified address space. The address mapping unit 2956 can be used to translate addresses in the unified address space into a distinct memory address that can be accessed by the load/store units 2966.

The register file 2958 provides a set of registers for the functional units of the graphics multiprocessor 2934. The register file 2958 provides temporary storage for operands connected to the data paths of the functional units (e.g., GPGPU cores 2962, load/store units 2966) of the graphics multiprocessor 2934. The register file 2958 may be divided between each of the functional units such that each functional unit is allocated a dedicated portion of the register file 2958. For example, the register file 2958 may be divided between the different warps being executed by the graphics multiprocessor 2934.

The GPGPU cores 2962 can each include floating point units (FPUs) and/or integer arithmetic logic units (ALUs) that are used to execute instructions of the graphics multiprocessor 2934. In some implementations, the GPGPU cores 2962 can include hardware logic that may otherwise reside within the tensor and/or ray-tracing cores 2963. The GPGPU cores 2962 can be similar in architecture or can differ in architecture. For example and in some examples, a first portion of the GPGPU cores 2962 include a single precision FPU and an integer ALU while a second portion of the GPGPU cores include a double precision FPU. Optionally, the FPUs can implement the IEEE 754-2008 standard for floating point arithmetic or enable variable precision floating point arithmetic. The graphics multiprocessor 2934 can additionally include one or more fixed function or special function units to perform specific functions such as copy rectangle or pixel blending operations. One or more of the GPGPU cores can also include fixed or special function logic.

The GPGPU cores 2962 may include SIMD logic capable of performing a single instruction on multiple sets of data. Optionally, GPGPU cores 2962 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in some examples, eight SIMT threads that perform the same or similar operations can be executed in parallel via a single SIMD8 logic unit.

The memory and cache interconnect 2968 is an interconnect network that connects each of the functional units of the graphics multiprocessor 2934 to the register file 2958 and to the shared memory 2970. For example, the memory and cache interconnect 2968 is a crossbar interconnect that allows the load/store unit 2966 to implement load and store operations between the shared memory 2970 and the register file 2958. The register file 2958 can operate at the same frequency as the GPGPU cores 2962, thus data transfer between the GPGPU cores 2962 and the register file 2958 is very low latency. The shared memory 2970 can be used to enable communication between threads that execute on the functional units within the graphics multiprocessor 2934. The cache memory 2972 can be used as a data cache for example, to cache texture data communicated between the functional units and the texture unit 2936. The shared memory 2970 can also be used as a program managed cached. The shared memory 2970 and the cache memory 2972 can couple with the data crossbar 2940 to enable communication with other components of the processing cluster. Threads executing on the GPGPU cores 2962 can programmatically store data within the shared memory in addition to the automatically cached data that is stored within the cache memory 2972.

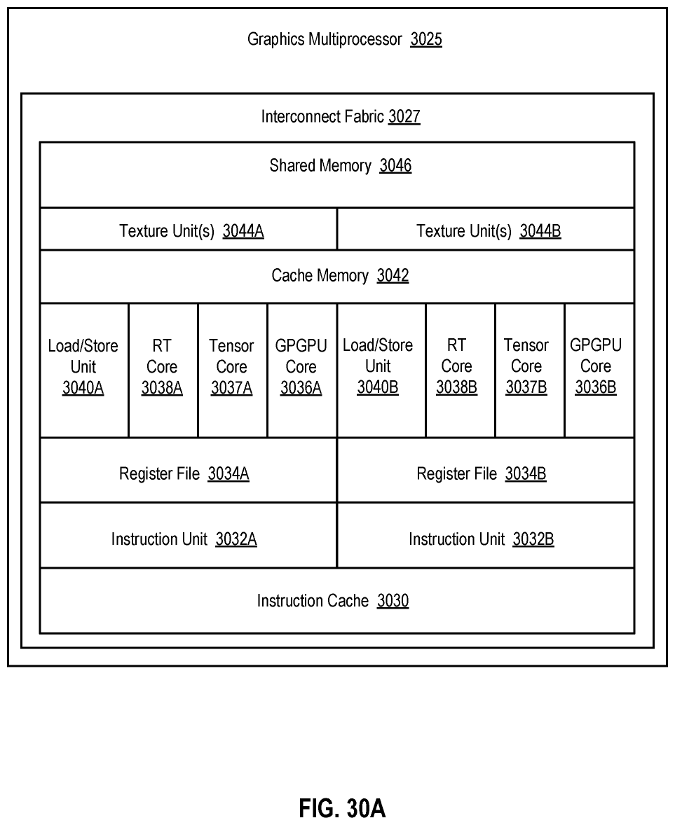

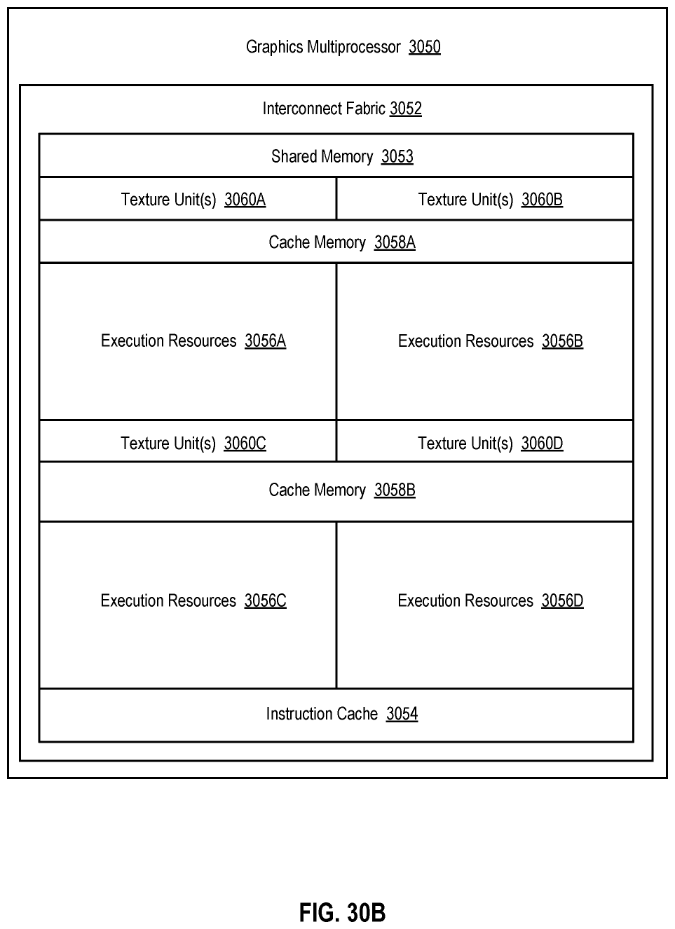

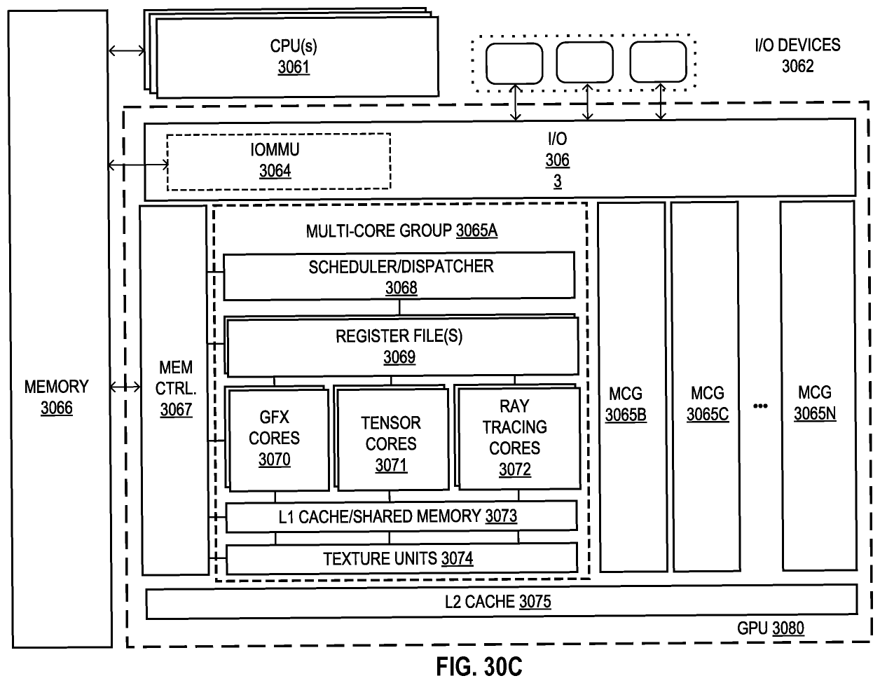

FIGS. 30A-30C illustrate additional graphics multiprocessors, according to examples. FIG. 30A-30B illustrate graphics multiprocessors 3025, 3050, which are related to the graphics multiprocessor 2934 of FIG. 29C and may be used in place of one of those. Therefore, the disclosure of any features in combination with the graphics multiprocessor 2934 herein also discloses a corresponding combination with the graphics multiprocessor(s) 3025, 3050, but is not limited to such. FIG. 30C illustrates a graphics processing unit (GPU) 3080 which includes dedicated sets of graphics processing resources arranged into multi-core groups 3065A-3065N, which correspond to the graphics multiprocessors 3025, 3050. The illustrated graphics multiprocessors 3025, 3050 and the multi-core groups 3065A-3065N can be streaming multiprocessors (SM) capable of simultaneous execution of a large number of execution threads.

The graphics multiprocessor 3025 of FIG. 30A includes multiple additional instances of execution resource units relative to the graphics multiprocessor 2934 of FIG. 29D. For example, the graphics multiprocessor 3025 can include multiple instances of the instruction unit 3032A-3032B, register file 3034A-3034B, and texture unit(s) 3044A-3044B. The graphics multiprocessor 3025 also includes multiple sets of graphics or compute execution units (e.g., GPGPU core 3036A-3036B, tensor core 3037A-3037B, ray-tracing core 3038A-3038B) and multiple sets of load/store units 3040A-3040B. The execution resource units have a common instruction cache 3030, texture and/or data cache memory 3042, and shared memory 3046.

The various components can communicate via an interconnect fabric 3027. The interconnect fabric 3027 may include one or more crossbar switches to enable communication between the various components of the graphics multiprocessor 3025. The interconnect fabric 3027 may be a separate, high-speed network fabric layer upon which each component of the graphics multiprocessor 3025 is stacked. The components of the graphics multiprocessor 3025 communicate with remote components via the interconnect fabric 3027. For example, the cores 3036A-3036B, 3037A-3037B, and 3038A-3038B can each communicate with shared memory 3046 via the interconnect fabric 3027. The interconnect fabric 3027 can arbitrate communication within the graphics multiprocessor 3025 to ensure a fair bandwidth allocation between components.

The graphics multiprocessor 3050 of FIG. 30B includes multiple sets of execution resources 3056A-3056D, where each set of execution resource includes multiple instruction units, register files, GPGPU cores, and load store units, as illustrated in FIG. 29D and FIG. 30A. The execution resources 3056A-3056D can work in concert with texture unit(s) 3060A-3060D for texture operations, while sharing an instruction cache 3054, and shared memory 3053. For example, the execution resources 3056A-3056D can share an instruction cache 3054 and shared memory 3053, as well as multiple instances of a texture and/or data cache memory 3058A-3058B. The various components can communicate via an interconnect fabric 3052 similar to the interconnect fabric 3027 of FIG. 30A.

Persons skilled in the art will understand that the architecture described in FIGS. 1, 29A-29D, and 30A-30B are descriptive and not limiting as to the scope of the present examples. Thus, the techniques described herein may be implemented on any properly configured processing unit, including, without limitation, one or more mobile application processors, one or more desktop or server central processing units (CPUs) including multi-core CPUs, one or more parallel processing units, such as the parallel processing unit 2902 of FIG. 29A, as well as one or more graphics processors or special purpose processing units, without departure from the scope of the examples described herein.

The parallel processor or GPGPU as described herein may be communicatively coupled to host/processor cores to accelerate graphics operations, machine-learning operations, pattern analysis operations, and various general-purpose GPU (GPGPU) functions. The GPU may be communicatively coupled to the host processor/cores over a bus or other interconnect (e.g., a high-speed interconnect such as PCIe, NVLink, or other known protocols, standardized protocols, or proprietary protocols). In other examples, the GPU may be integrated on the same package or chip as the cores and communicatively coupled to the cores over an internal processor bus/interconnect (i.e., internal to the package or chip). Regardless of the manner in which the GPU is connected, the processor cores may allocate work to the GPU in the form of sequences of commands/instructions contained in a work descriptor. The GPU then uses dedicated circuitry/logic for efficiently processing these commands/instructions.

FIG. 30C illustrates a graphics processing unit (GPU) 3080 which includes dedicated sets of graphics processing resources arranged into multi-core groups 3065A-3065N. While the details of only a single multi-core group 3065A are provided, it will be appreciated that the other multi-core groups 3065B-3065N may be equipped with the same or similar sets of graphics processing resources. Details described with respect to the multi-core groups 3065A-3065N may also apply to any graphics multiprocessor 2934, 3025, 3050 described herein.

As illustrated, a multi-core group 3065A may include a set of graphics cores 3070, a set of tensor cores 3071, and a set of ray tracing cores 3072. A scheduler/dispatcher 3068 schedules and dispatches the graphics threads for execution on the various cores 3070, 3071, 3072. A set of register files 3069 store operand values used by the cores 3070, 3071, 3072 when executing the graphics threads. These may include, for example, integer registers for storing integer values, floating point registers for storing floating point values, vector registers for storing packed data elements (integer and/or floating-point data elements) and tile registers for storing tensor/matrix values. The tile registers may be implemented as combined sets of vector registers.

One or more combined level 1 (L1) caches and shared memory units 3073 store graphics data such as texture data, vertex data, pixel data, ray data, bounding volume data, etc., locally within each multi-core group 3065A. One or more texture units 3074 can also be used to perform texturing operations, such as texture mapping and sampling. A Level 2 (L2) cache 3075 shared by all or a subset of the multi-core groups 3065A-3065N stores graphics data and/or instructions for multiple concurrent graphics threads. As illustrated, the L2 cache 3075 may be shared across a plurality of multi-core groups 3065A-3065N. One or more memory controllers 3067 couple the GPU 3080 to a memory 3066 which may be a system memory (e.g., DRAM) and/or a dedicated graphics memory (e.g., GDDR6 memory).

Input/output (1/O) circuitry 3063 couples the GPU 3080 to one or more I/O devices 3062 such as digital signal processors (DSPs), network controllers, or user input devices. An on-chip interconnect may be used to couple the I/O devices 3062 to the GPU 3080 and memory 3066. One or more I/O memory management units (IOMMUs) 3064 of the I/O circuitry 3063 couple the I/O devices 3062 directly to the system memory 3066. Optionally, the IOMMU 3064 manages multiple sets of page tables to map virtual addresses to physical addresses in system memory 3066. The I/O devices 3062, CPU(s) 3061, and GPU(s) 3080 may then share the same virtual address space.

In one implementation of the IOMMU 3064, the IOMMU 3064 supports virtualization. In this case, it may manage a first set of page tables to map guest/graphics virtual addresses to guest/graphics physical addresses and a second set of page tables to map the guest/graphics physical addresses to system/host physical addresses (e.g., within system memory 3066). The base addresses of each of the first and second sets of page tables may be stored in control registers and swapped out on a context switch (e.g., so that the new context is provided with access to the relevant set of page tables). While not illustrated in FIG. 30C, each of the cores 3070, 3071, 3072 and/or multi-core groups 3065A-3065N may include translation lookaside buffers (TLBs) to cache guest virtual to guest physical translations, guest physical to host physical translations, and guest virtual to host physical translations.

The CPU(s) 3061, GPUs 3080, and I/O devices 3062 may be integrated on a single semiconductor chip and/or chip package. The illustrated memory 3066 may be integrated on the same chip or may be coupled to the memory controllers 3067 via an off-chip interface. In one implementation, the memory 3066 comprises GDDR6 memory which shares the same virtual address space as other physical system-level memories, although the underlying principles described herein are not limited to this specific implementation.

The tensor cores 3071 may include a plurality of execution units specifically designed to perform matrix operations, which are the fundamental compute operation used to perform deep learning operations. For example, simultaneous matrix multiplication operations may be used for neural network training and inferencing. The tensor cores 3071 may perform matrix processing using a variety of operand precisions including single precision floating-point (e.g., 32 bits), half-precision floating point (e.g., 16 bits), integer words (16 bits), bytes (8 bits), and half-bytes (4 bits). For example, a neural network implementation extracts features of each rendered scene, potentially combining details from multiple frames, to construct a high-quality final image.

In deep learning implementations, parallel matrix multiplication work may be scheduled for execution on the tensor cores 3071. The training of neural networks, in particular, requires a significant number of matrix dot product operations. In order to process an inner-product formulation of an N×N×N matrix multiply, the tensor cores 3071 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 3071 to ensure that the most efficient precision is used for different workloads (e.g., such as inferencing workloads which can tolerate quantization to bytes and half-bytes). Supported formats additionally include 64-bit floating point (FP64) and non-IEEE floating point formats such as the bfloat16 format (e.g., Brain floating point), a 16-bit floating point format with one sign bit, eight exponent bits, and eight significand bits, of which seven are explicitly stored. One example includes support for a reduced precision tensor-float (TF32) mode, which performs computations using the range of FP32 (8-bits) and the precision of FP16 (10-bits). Reduced precision TF32 operations can be performed on FP32 inputs and produce FP32 outputs at higher performance relative to FP32 and increased precision relative to FP16. In some examples, one or more 8-bit floating point formats (FP8) are supported.

In some examples the tensor cores 3071 support a sparse mode of operation for matrices in which the vast majority of values are zero. The tensor cores 3071 include support for sparse input matrices that are encoded in a sparse matrix representation (e.g., coordinate list encoding (COO), compressed sparse row (CSR), compress sparse column (CSC), etc.). The tensor cores 3071 also include support for compressed sparse matrix representations in the event that the sparse matrix representation may be further compressed. Compressed, encoded, and/or compressed and encoded matrix data, along with associated compression and/or encoding metadata, can be read by the tensor cores 3071 and the non-zero values can be extracted. For example, for a given input matrix A, a non-zero value can be loaded from the compressed and/or encoded representation of at least a portion of matrix A. Based on the location in matrix A for the non-zero value, which may be determined from index or coordinate metadata associated with the non-zero value, a corresponding value in input matrix B may be loaded. Depending on the operation to be performed (e.g., multiply), the load of the value from input matrix B may be bypassed if the corresponding value is a zero value. In some examples, the pairings of values for certain operations, such as multiply operations, may be pre-scanned by scheduler logic and only operations between non-zero inputs are scheduled. Depending on the dimensions of matrix A and matrix B and the operation to be performed, output matrix C may be dense or sparse. Where output matrix C is sparse and depending on the configuration of the tensor cores 3071, output matrix C may be output in a compressed format, a sparse encoding, or a compressed sparse encoding.

The ray tracing cores 3072 may accelerate ray tracing operations for both real-time ray tracing and non-real-time ray tracing implementations. In particular, the ray tracing cores 3072 may include ray traversal/intersection circuitry for performing ray traversal using bounding volume hierarchies (BVHs) and identifying intersections between rays and primitives enclosed within the BVH volumes. The ray tracing cores 3072 may also include circuitry for performing depth testing and culling (e.g., using a Z buffer or similar arrangement). In one implementation, the ray tracing cores 3072 perform traversal and intersection operations in concert with the image denoising techniques described herein, at least a portion of which may be executed on the tensor cores 3071. For example, the tensor cores 3071 may implement a deep learning neural network to perform denoising of frames generated by the ray tracing cores 3072. However, the CPU(s) 3061, graphics cores 3070, and/or ray tracing cores 3072 may also implement all or a portion of the denoising and/or deep learning algorithms.

In addition, as described above, a distributed approach to denoising may be employed in which the GPU 3080 is in a computing device coupled to other computing devices over a network or high-speed interconnect. In this distributed approach, the interconnected computing devices may share neural network learning/training data to improve the speed with which the overall system learns to perform denoising for different types of image frames and/or different graphics applications.

The ray tracing cores 3072 may process all BVH traversal and/or ray-primitive intersections, saving the graphics cores 3070 from being overloaded with thousands of instructions per ray. For example, each ray tracing core 3072 includes a first set of specialized circuitry for performing bounding box tests (e.g., for traversal operations) and/or a second set of specialized circuitry for performing the ray-triangle intersection tests (e.g., intersecting rays which have been traversed). Thus, for example, the multi-core group 3065A can simply launch a ray probe, and the ray tracing cores 3072 independently perform ray traversal and intersection and return hit data (e.g., a hit, no hit, multiple hits, etc.) to the thread context. The other cores 3070, 3071 are freed to perform other graphics or compute work while the ray tracing cores 3072 perform the traversal and intersection operations.

Optionally, each ray tracing core 3072 may include a traversal unit to perform BVH testing operations and/or an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 3070 and tensor cores 3071) are freed to perform other forms of graphics work.

In some examples described below, a hybrid rasterization/ray tracing approach is used in which work is distributed between the graphics cores 3070 and ray tracing cores 3072.

The ray tracing cores 3072 (and/or other cores 3070, 3071) may include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 3072, graphics cores 3070 and tensor cores 3071 is Vulkan API (e.g., Vulkan version 1.1.85 and later). Note, however, that the underlying principles described herein are not limited to any particular ray tracing ISA.

In general, the various cores 3072, 3071, 3070 may support a ray tracing instruction set that includes instructions/functions for one or more of ray generation, closest hit, any hit, ray-primitive intersection, per-primitive and hierarchical bounding box construction, miss, visit, and exceptions. More specifically, some examples includes ray tracing instructions to perform one or more of the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per-primitive Bounding box Construction —This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In some examples the ray tracing cores 3072 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 3072 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 3072 can also be used to perform computations that are not directly analogous to ray tracing. For example, mesh projection, mesh refinement, and volume sampling computations can be accelerated using the ray tracing cores 3072. Generic coordinate space calculations, such as nearest neighbor calculations can also be performed. For example, the set of points near a given point can be discovered by defining a bounding box in the coordinate space around the point. BVH and ray probe logic within the ray tracing cores 3072 can then be used to determine the set of point intersections within the bounding box. The intersections constitute the origin point and the nearest neighbors to that origin point. Computations that are performed using the ray tracing cores 3072 can be performed in parallel with computations performed on the graphics cores 3072 and tensor cores 3071. A shader compiler can be configured to compile a compute shader or other general-purpose graphics processing program into low level primitives that can be parallelized across the graphics cores 3070, tensor cores 3071, and ray tracing cores 3072.

Building larger and larger silicon dies is challenging for a variety of reasons. As silicon dies become larger, manufacturing yields become smaller and process technology requirements for different components may diverge. On the other hand, in order to have a high-performance system, key components should be interconnected by high speed, high bandwidth, low latency interfaces. These contradicting needs pose a challenge to high performance chip development.

Embodiments described herein provide techniques to disaggregate an architecture of a system on a chip integrated circuit into multiple distinct chiplets that can be packaged onto a common chassis. In some examples, a graphics processing unit or parallel processor is composed from diverse silicon chiplets that are separately manufactured. A chiplet is an at least partially packaged integrated circuit that includes distinct units of logic that can be assembled with other chiplets into a larger package. A diverse set of chiplets with different IP core logic can be assembled into a single device. Additionally the chiplets can be integrated into a base die or base chiplet using active interposer technology. The concepts described herein enable the interconnection and communication between the different forms of IP within the GPU. The development of IPs on different process may be mixed. This avoids the complexity of converging multiple IPs, especially on a large SoC with several flavors IPs, to the same process.

Enabling the use of multiple process technologies improves the time to market and provides a cost-effective way to create multiple product SKUs. For customers, this means getting products that are more tailored to their requirements in a cost effective and timely manner. Additionally, the disaggregated IPs are more amenable to being power gated independently, components that are not in use on a given workload can be powered off, reducing overall power consumption.

FIG. 31 shows a parallel compute system 3100, according to some examples. In some examples the parallel compute system 3100 includes a parallel processor 3120, which can be a graphics processor or compute accelerator as described herein. The parallel processor 3120 includes a global logic unit 3101, an interface 3102, a thread dispatcher 3103, a media unit 3104, a set of compute units 3105A-3105H, and a cache/memory units 3106. The global logic unit 3101, in some examples, includes global functionality for the parallel processor 3120, including device configuration registers, global schedulers, power management logic, and the like. The interface 3102 can include a front-end interface for the parallel processor 3120. The thread dispatcher 3103 can receive workloads from the interface 3102 and dispatch threads for the workload to the compute units 3105A-3105H. If the workload includes any media operations, at least a portion of those operations can be performed by the media unit 3104. The media unit can also offload some operations to the compute units 3105A-3105H. The cache/memory units 3106 can include cache memory (e.g., L3 cache) and local memory (e.g., HBM, GDDR) for the parallel processor 3120.

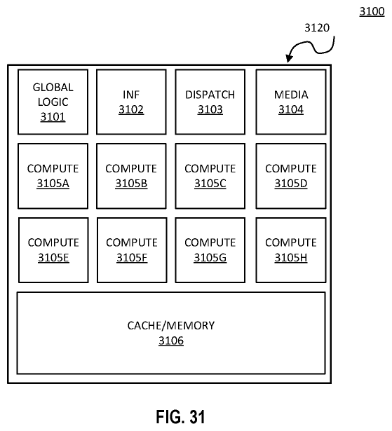

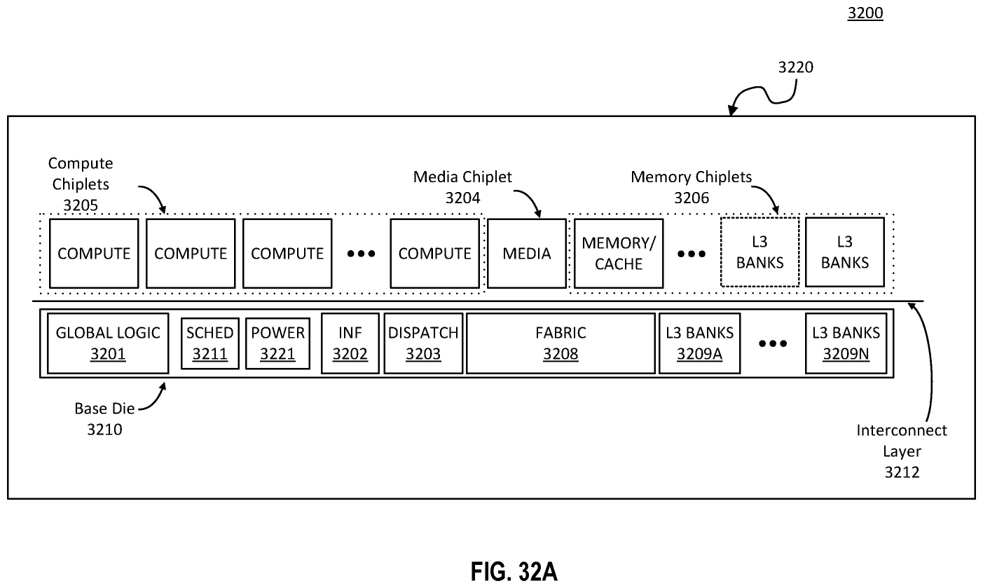

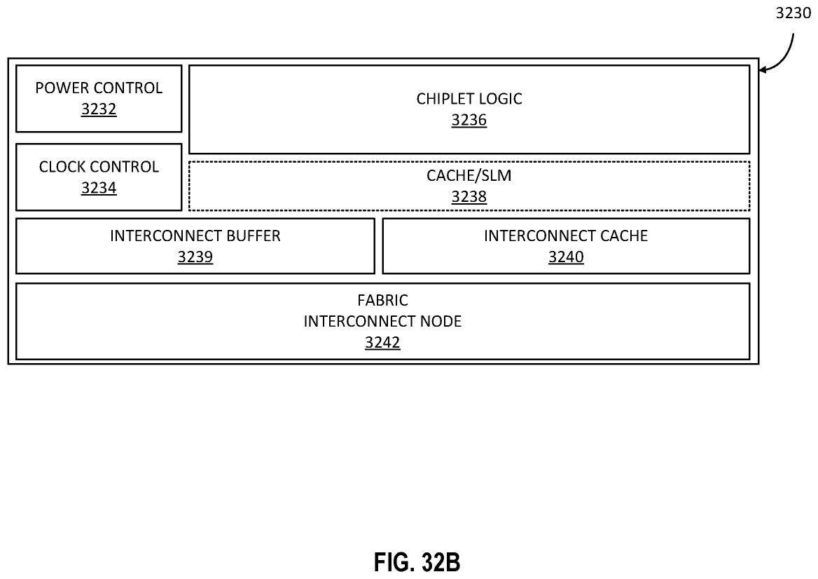

FIGS. 32A-32B illustrate a hybrid logical/physical view of a disaggregated parallel processor, according to examples described herein. FIG. 32A illustrates a disaggregated parallel compute system 3200. FIG. 32B illustrates a chiplet 3230 of the disaggregated parallel compute system 3200.

As shown in FIG. 32A, a disaggregated compute system 3200 can include a parallel processor 3220 in which the various components of the parallel processor SOC are distributed across multiple chiplets. Each chiplet can be a distinct IP core that is independently designed and configured to communicate with other chiplets via one or more common interfaces. The chiplets include but are not limited to compute chiplets 3205, a media chiplet 3204, and memory chiplets 3206. Each chiplet can be separately manufactured using different process technologies. For example, compute chiplets 3205 may be manufactured using the smallest or most advanced process technology available at the time of fabrication, while memory chiplets 3206 or other chiplets (e.g., I/O, networking, etc.) may be manufactured using a larger or less advanced process technologies.

The various chiplets can be bonded to a base die 3210 and configured to communicate with each other and logic within the base die 3210 via an interconnect layer 3212. In some examples, the base die 3210 can include global logic 3201, which can include scheduler 3211 and power management 3221 logic units, an interface 3202, a dispatch unit 3203, and an interconnect fabric module 3208 coupled with or integrated with one or more L3 cache banks 3209A-3209N. The interconnect fabric 3208 can be an inter-chiplet fabric that is integrated into the base die 3210. Logic chiplets can use the fabric 3208 to relay messages between the various chiplets. Additionally, L3 cache banks 3209A-3209N in the base die and/or L3 cache banks within the memory chiplets 3206 can cache data read from and transmitted to DRAM chiplets within the memory chiplets 3206 and to system memory of a host.

In some examples the global logic 3201 is a microcontroller that can execute firmware to perform scheduler 3211 and power management 3221 functionality for the parallel processor 3220. The microcontroller that executes the global logic can be tailored for the target use case of the parallel processor 3220. The scheduler 3211 can perform global scheduling operations for the parallel processor 3220. The power management 3221 functionality can be used to enable or disable individual chiplets within the parallel processor when those chiplets are not in use.

The various chiplets of the parallel processor 3220 can be designed to perform specific functionality that, in existing designs, would be integrated into a single die. A set of compute chiplets 3205 can include clusters of compute units (e.g., execution units, streaming multiprocessors, etc.) that include programmable logic to execute compute or graphics shader instructions. A media chiplet 3204 can include hardware logic to accelerate media encode and decode operations. Memory chiplets 3206 can include volatile memory (e.g., DRAM) and one or more SRAM cache memory banks (e.g., L3 banks).

As shown in FIG. 32B, each chiplet 3230 can include common components and application specific components. Chiplet logic 3236 within the chiplet 3230 can include the specific components of the chiplet, such as an array of streaming multiprocessors, compute units, or execution units described herein. The chiplet logic 3236 can couple with an optional cache or shared local memory 3238 or can include a cache or shared local memory within the chiplet logic 3236. The chiplet 3230 can include a fabric interconnect node 3242 that receives commands via the inter-chiplet fabric. Commands and data received via the fabric interconnect node 3242 can be stored temporarily within an interconnect buffer 3239. Data transmitted to and received from the fabric interconnect node 3242 can be stored in an interconnect cache 3240. Power control 3232 and clock control 3234 logic can also be included within the chiplet. The power control 3232 and clock control 3234 logic can receive configuration commands via the fabric can configure dynamic voltage and frequency scaling for the chiplet 3230. In some examples, each chiplet can have an independent clock domain and power domain and can be clock gated and power gated independently of other chiplets.

At least a portion of the components within the illustrated chiplet 3230 can also be included within logic embedded within the base die 3210 of FIG. 32A. For example, logic within the base die that communicates with the fabric can include a version of the fabric interconnect node 3242. Base die logic that can be independently clock or power gated can include a version of the power control 3232 and/or clock control 3234 logic.

Thus, while various examples described herein use the term SOC to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various examples of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).”

Example Core Architectures—In-order and out-of-order core block diagram.

FIG. 33(A) is a block diagram illustrating both an example in-order pipeline and an example register renaming, out-of-order issue/execution pipeline according to examples. FIG. 33(B) is a block diagram illustrating both an example in-order architecture core and an example register renaming, out-of-order issue/execution architecture core to be included in a processor according to examples. The solid lined boxes in FIGS. 33(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 33(A), a processor pipeline 3300 includes a fetch stage 3302, an optional length decoding stage 3304, a decode stage 3306, an optional allocation (Alloc) stage 3308, an optional renaming stage 3310, a schedule (also known as a dispatch or issue) stage 3312, an optional register read/memory read stage 3314, an execute stage 3316, a write back/memory write stage 3318, an optional exception handling stage 3322, and an optional commit stage 3324. One or more operations can be performed in each of these processor pipeline stages. For example, during the fetch stage 3302, one or more instructions are fetched from instruction memory, and during the decode stage 3306, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 3306 and the register read/memory read stage 3314 may be combined into one pipeline stage. In some examples, during the execute stage 3316, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 33(B) may implement the pipeline 3300 as follows: 1) the instruction fetch circuitry 3338 performs the fetch and length decoding stages 3302 and 3304; 2) the decode circuitry 3340 performs the decode stage 3306; 3) the rename/allocator unit circuitry 3352 performs the allocation stage 3308 and renaming stage 3310; 4) the scheduler(s) circuitry 3356 performs the schedule stage 3312; 5) the physical register file(s) circuitry 3358 and the memory unit circuitry 3370 perform the register read/memory read stage 3314; the execution cluster(s) 3360 perform the execute stage 3316; 6) the memory unit circuitry 3370 and the physical register file(s) circuitry 3358 perform the write back/memory write stage 3318; 7) various circuitry may be involved in the exception handling stage 3322; and 8) the retirement unit circuitry 3354 and the physical register file(s) circuitry 3358 perform the commit stage 3324.

FIG. 33(B) shows a processor core 3390 including front-end unit circuitry 3330 coupled to execution engine unit circuitry 3350, and both are coupled to memory unit circuitry 3370. The core 3390 may be a reduced instruction set architecture computing (RISC) core, a complex instruction set architecture computing (CISC) core, a very long instruction word (VLIW) core, or a hybrid or alternative core type. As yet another option, the core 3390 may be a special-purpose core, such as, for example, a network or communication core, compression engine, coprocessor core, general purpose computing graphics processing unit (GPGPU) core, graphics core, or the like.

The front-end unit circuitry 3330 may include branch prediction circuitry 3332 coupled to instruction cache circuitry 3334, which is coupled to an instruction translation lookaside buffer (TLB) 3336, which is coupled to instruction fetch circuitry 3338, which is coupled to decode circuitry 3340. In some examples, the instruction cache circuitry 3334 is included in the memory unit circuitry 3370 rather than the front-end circuitry 3330. The decode circuitry 3340 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 3340 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 3340 may be implemented using various different mechanisms. Examples of suitable mechanisms include, but are not limited to, look-up tables, hardware implementations, programmable logic arrays (PLAs), microcode read only memories (ROMs), etc. In some examples, the core 3390 includes a microcode ROM (not shown) or other medium that stores microcode for certain macroinstructions (e.g., in decode circuitry 3340 or otherwise within the front-end circuitry 3330). In some examples, the decode circuitry 3340 includes a micro-operation (micro-op) or operation cache (not shown) to hold/cache decoded operations, micro-tags, or micro-operations generated during the decode or other stages of the processor pipeline 3300. The decode circuitry 3340 may be coupled to rename/allocator unit circuitry 3352 in the execution engine circuitry 3350.

The execution engine circuitry 3350 includes the rename/allocator unit circuitry 3352 coupled to retirement unit circuitry 3354 and a set of one or more scheduler(s) circuitry 3356. The scheduler(s) circuitry 3356 represents any number of different schedulers, including reservations stations, central instruction window, etc. In some examples, the scheduler(s) circuitry 3356 can include arithmetic logic unit (ALU) scheduler/scheduling circuitry, ALU queues, address generation unit (AGU) scheduler/scheduling circuitry, AGU queues, etc. The scheduler(s) circuitry 3356 is coupled to the physical register file(s) circuitry 3358. Each of the physical register file(s) circuitry 3358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 3358 includes vector registers unit circuitry, writemask registers unit circuitry, and scalar register unit circuitry. These register units may provide architectural vector registers, vector mask registers, general-purpose registers, etc. The physical register file(s) circuitry 3358 is coupled to the retirement unit circuitry 3354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 3354 and the physical register file(s) circuitry 3358 are coupled to the execution cluster(s) 3360. The execution cluster(s) 3360 includes a set of one or more execution unit(s) circuitry 3362 and a set of one or more memory access circuitry 3364. The execution unit(s) circuitry 3362 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 3356, physical register file(s) circuitry 3358, and execution cluster(s) 3360 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster —and in the case of a separate memory access pipeline, certain examples are implemented in which only the execution cluster of this pipeline has the memory access unit(s) circuitry 3364). It should also be understood that where separate pipelines are used, one or more of these pipelines may be out-of-order issue/execution and the rest in-order.

In some examples, the execution engine unit circuitry 3350 may perform load store unit (LSU) address/data pipelining to an Advanced Microcontroller Bus (AMB) interface (not shown), and address phase and writeback, data phase load, store, and branches.

The set of memory access circuitry 3364 is coupled to the memory unit circuitry 3370, which includes data TLB circuitry 3372 coupled to data cache circuitry 3374 coupled to level 2 (L2) cache circuitry 3376. In some examples, the memory access circuitry 3364 may include load unit circuitry, store address unit circuitry, and store data unit circuitry, each of which is coupled to the data TLB circuitry 3372 in the memory unit circuitry 3370. The instruction cache circuitry 3334 is further coupled to the level 2 (L2) cache circuitry 3376 in the memory unit circuitry 3370. In some examples, the instruction cache 3334 and the data cache 3374 are combined into a single instruction and data cache (not shown) in L2 cache circuitry 3376, level 3 (L3) cache circuitry (not shown), and/or main memory. The L2 cache circuitry 3376 is coupled to one or more other levels of cache and eventually to a main memory.

The core 3390 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In some examples, the core 3390 includes logic to support a packed data instruction set architecture extension (e.g., AVX1, AVX2), thereby allowing the operations used by many multimedia applications to be performed using packed data.

### Example Execution Unit(s) Circuitry.

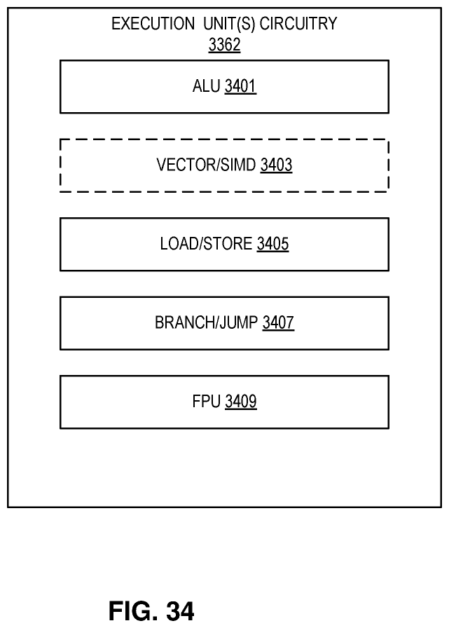

FIG. 34 illustrates examples of execution unit(s) circuitry, such as execution unit(s) circuitry 3362 of FIG. 33(B). As illustrated, execution unit(s) circuitry 3362 may include one or more ALU circuits 3401, optional vector/single instruction multiple data (SIMD) circuits 3403, load/store circuits 3405, branch/jump circuits 3407, and/or Floating-point unit (FPU) circuits 3409. ALU circuits 3401 perform integer arithmetic and/or Boolean operations. Vector/SIMD circuits 3403 perform vector/SIMD operations on packed data (such as SIMD/vector registers). Load/store circuits 3405 execute load and store instructions to load data from memory into registers or store from registers to memory. Load/store circuits 3405 may also generate addresses. Branch/jump circuits 3407 cause a branch or jump to a memory address depending on the instruction. FPU circuits 3409 perform floating-point arithmetic. The width of the execution unit(s) circuitry 3362 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

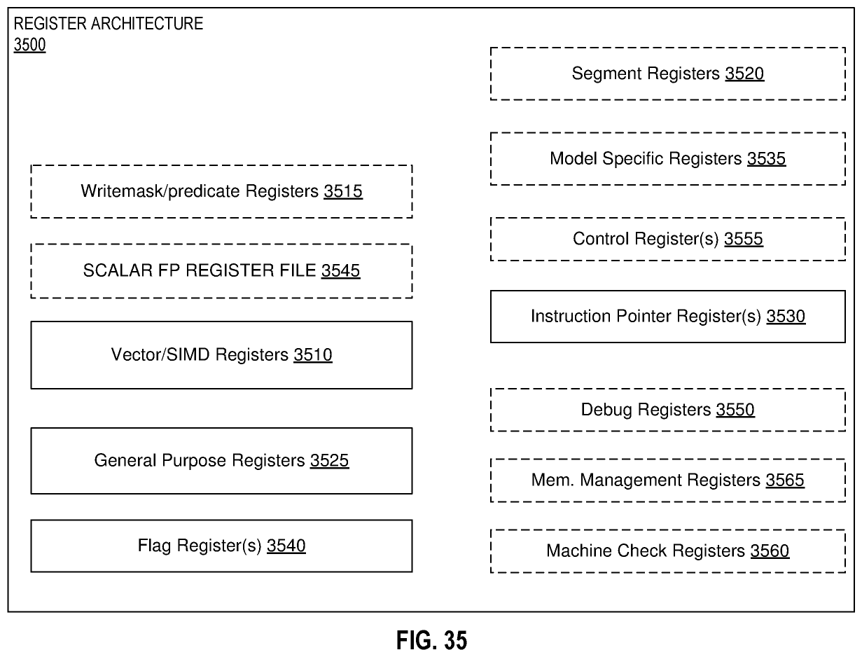

FIG. 35 is a block diagram of a register architecture 3500 according to some examples. As illustrated, the register architecture 3500 includes vector/SIMD registers 3510 that vary from 128-bit to 1,024 bits width. In some examples, the vector/SIMD registers 3510 are physically 512-bits and, depending upon the mapping, only some of the lower bits are used. For example, in some examples, the vector/SIMD registers 3510 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 3500 includes writemask/predicate registers 3515. For example, in some examples, there are 8 writemask/predicate registers (sometimes called k0 through k7) that are each 16-bit, 32-bit, 64-bit, or 128-bit in size. Writemask/predicate registers 3515 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 3515 corresponds to a data element position of the destination. In other examples, the writemask/predicate registers 3515 are scalable and consists of a set number of enable bits for a given vector element (e.g., 8 enable bits per 64-bit vector element).

The register architecture 3500 includes a plurality of general-purpose registers 3525. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 3500 includes scalar floating-point (FP) register file 3545 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 3540 (e.g., EFLAGS, RFLAGS, etc.) store status and control information for arithmetic, compare, and system operations. For example, the one or more flag registers 3540 may store condition code information such as carry, parity, auxiliary carry, zero, sign, and overflow. In some examples, the one or more flag registers 3540 are called program status and control registers.

Segment registers 3520 contain segment points for use in accessing memory. In some examples, these registers are referenced by the names CS, DS, SS, ES, FS, and GS.

Model specific registers or machine specific registers (MSRs) 3535 control and report on processor performance. Most MSRs 3535 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 3560 consist of control, status, and error reporting MSRs that are used to detect and report on hardware errors. Control register(s) 3555 (e.g., CR0-CR4) determine the operating mode of a processor (e.g., processor 2670, 2680, 2638, 2615, and/or 2700) and the characteristics of a currently executing task. In some examples, MSRs 3535 are a subset of control registers 3555.

One or more instruction pointer register(s) 3530 store an instruction pointer value. Debug registers 3550 control and allow for the monitoring of a processor or core's debugging operations.

Memory (mem) management registers 3565 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 3500 may, for example, be used in register file/memory ‘ISAB08, or physical register file(s) circuitry 3358.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

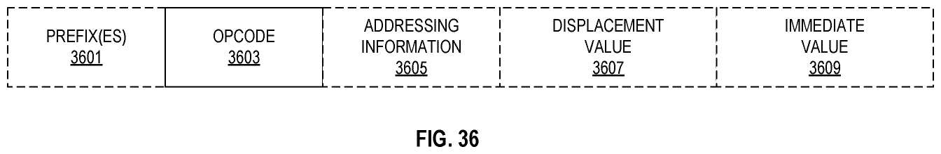

FIG. 36 illustrates examples of an instruction format. As illustrated, an instruction may include multiple components including, but not limited to, one or more fields for: one or more prefixes 3601, an opcode 3603, addressing information 3605 (e.g., register identifiers, memory addressing information, etc.), a displacement value 3607, and/or an immediate value 3609. Note that some instructions utilize some or all the fields of the format whereas others may only use the field for the opcode 3603. In some examples, the order illustrated is the order in which these fields are to be encoded, however, it should be appreciated that in other examples these fields may be encoded in a different order, combined, etc.

The prefix(es) field(s) 3601, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 3603 is used to at least partially define the operation to be performed upon a decoding of the instruction. In some examples, a primary opcode encoded in the opcode field 3603 is one, two, or three bytes in length. In other examples, a primary opcode can be a different length. An additional 3-bit opcode field is sometimes encoded in another field.

The addressing information field 3605 is used to address one or more operands of the instruction, such as a location in memory or one or more registers. FIG. 37 illustrates examples of the addressing information field 3605. In this illustration, an optional MOD R/M byte 3702 and an optional Scale, Index, Base (SIB) byte 3704 are shown. The MOD R/M byte 3702 and the SIB byte 3704 are used to encode up to two operands of an instruction, each of which is a direct register or effective memory address. Note that both of these fields are optional in that not all instructions include one or more of these fields. The MOD R/M byte 3702 includes a MOD field 3742, a register (reg) field 3744, and R/M field 3746.

The content of the MOD field 3742 distinguishes between memory access and non-memory access modes. In some examples, when the MOD field 3742 has a binary value of 11 (11b), a register-direct addressing mode is utilized, and otherwise a register-indirect addressing mode is used.

The register field 3744 may encode either the destination register operand or a source register operand or may encode an opcode extension and not be used to encode any instruction operand. The content of register field 3744, directly or through address generation, specifies the locations of a source or destination operand (either in a register or in memory). In some examples, the register field 3744 is supplemented with an additional bit from a prefix (e.g., prefix 3601) to allow for greater addressing.

The R/M field 3746 may be used to encode an instruction operand that references a memory address or may be used to encode either the destination register operand or a source register operand. Note the R/M field 3746 may be combined with the MOD field 3742 to dictate an addressing mode in some examples.

The SIB byte 3704 includes a scale field 3752, an index field 3754, and a base field 3756 to be used in the generation of an address. The scale field 3752 indicates a scaling factor. The index field 3754 specifies an index register to use. In some examples, the index field 3754 is supplemented with an additional bit from a prefix (e.g., prefix 3601) to allow for greater addressing. The base field 3756 specifies a base register to use. In some examples, the base field 3756 is supplemented with an additional bit from a prefix (e.g., prefix 3601) to allow for greater addressing. In practice, the content of the scale field 3752 allows for the scaling of the content of the index field 3754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 3607 provides this value. Additionally, in some examples, a displacement factor usage is encoded in the MOD field of the addressing information field 3605 that indicates a compressed displacement scheme for which a displacement value is calculated and stored in the displacement field 3607.

In some examples, the immediate value field 3609 specifies an immediate value for the instruction. An immediate value may be encoded as a 1-byte value, a 2-byte value, a 4-byte value, etc.

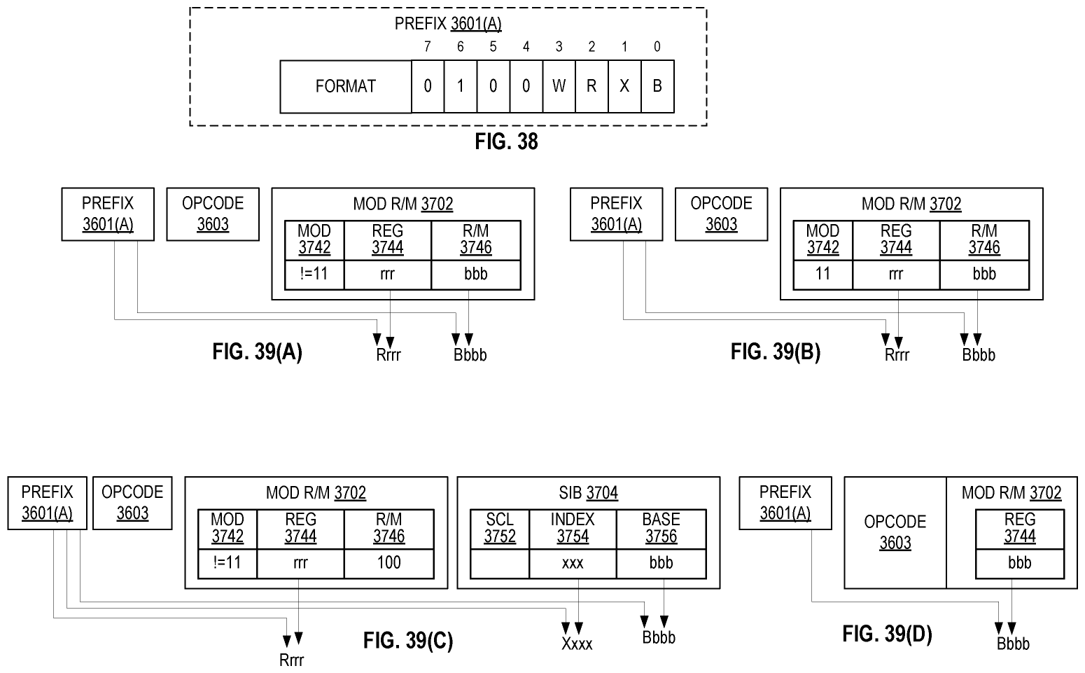

FIG. 38 illustrates examples of a first prefix 3601(A). In some examples, the first prefix 3601(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 3601(A) may specify up to three registers using 3-bit fields depending on the format: 1) using the reg field 3744 and the R/M field 3746 of the MOD R/M byte 3702; 2) using the MOD R/M byte 3702 with the SIB byte 3704 including using the reg field 3744 and the base field 3756 and index field 3754; or 3) using the register field of an opcode.

In the first prefix 3601(A), bit positions of the payload byte 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 3744 and MOD R/M R/M field 3746 alone can each only address 8 registers.

In the first prefix 3601(A), bit position 2 (R) may be an extension of the MOD R/M reg field 3744 and may be used to modify the MOD R/M reg field 3744 when that field encodes a general-purpose register, a 64-bit packed data register (e.g., a SSE register), or a control or debug register. R is ignored when MOD R/M byte 3702 specifies other registers or defines an extended opcode.

Bit position 1 (X) may modify the SIB byte index field 3754.

Bit position 0 (B) may modify the base in the MOD R/M R/M field 3746 or the SIB byte base field 3756; or it may modify the opcode register field used for accessing general purpose registers (e.g., general purpose registers 3525).

FIGS. 39(A)-(D) illustrate examples of how the R, X, and B fields of the first prefix 3601(A) are used. FIG. 39(A) illustrates R and B from the first prefix 3601(A) being used to extend the reg field 3744 and R/M field 3746 of the MOD R/M byte 3702 when the SIB byte 3704 is not used for memory addressing. FIG. 39(B) illustrates R and B from the first prefix 3601(A) being used to extend the reg field 3744 and R/M field 3746 of the MOD R/M byte 3702 when the SIB byte 3704 is not used (register-register addressing). FIG. 39(C) illustrates R, X, and B from the first prefix 3601(A) being used to extend the reg field 3744 of the MOD R/M byte 3702 and the index field 3754 and base field 3756 when the SIB byte 3704 being used for memory addressing. FIG. 39(D) illustrates B from the first prefix 3601(A) being used to extend the reg field 3744 of the MOD R/M byte 3702 when a register is encoded in the opcode 3603.

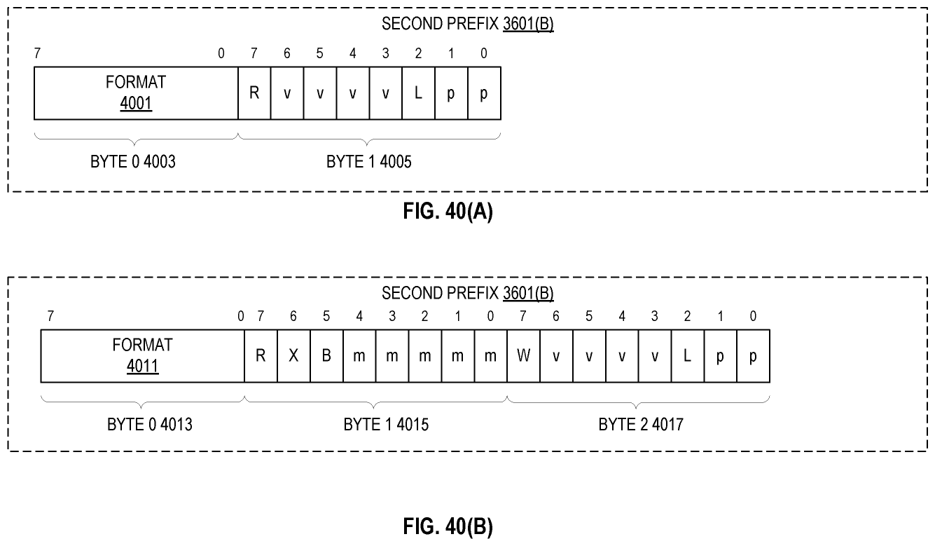

FIGS. 40(A)-(B) illustrate examples of a second prefix 3601(B). In some examples, the second prefix 3601(B) is an example of a VEX prefix. The second prefix 3601(B) encoding allows instructions to have more than two operands, and allows SIMD vector registers (e.g., vector/SIMD registers 3510) to be longer than 64-bits (e.g., 128-bit and 256-bit). The use of the second prefix 3601(B) provides for three-operand (or more) syntax. For example, previous two-operand instructions performed operations such as A=A+B, which overwrites a source operand. The use of the second prefix 3601(B) enables operands to perform nondestructive operations such as A=B+C.

In some examples, the second prefix 3601(B) comes in two forms—a two-byte form and a three-byte form. The two-byte second prefix 3601(B) is used mainly for 128-bit, scalar, and some 256-bit instructions; while the three-byte second prefix 3601(B) provides a compact replacement of the first prefix 3601(A) and 3-byte opcode instructions.

FIG. 40(A) illustrates examples of a two-byte form of the second prefix 3601(B). In some examples, a format field 4001 (byte 0 4003) contains the value C5H. In some examples, byte 1 4005 includes an “R” value in bit[7]. This value is the complement of the “R” value of the first prefix 3601(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 3746 to encode the instruction operand that references a memory address or encode either the destination register operand or a source register operand.

Instructions that use this prefix may use the MOD R/M reg field 3744 to encode either the destination register operand or a source register operand, or to be treated as an opcode extension and not used to encode any instruction operand.

For instruction syntax that support four operands, vvvv, the MOD R/M R/M field 3746 and the MOD R/M reg field 3744 encode three of the four operands. Bits[7:4] of the immediate value field 3609 are then used to encode the third source register operand.

FIG. 40(B) illustrates examples of a three-byte form of the second prefix 3601(B). In some examples, a format field 4011 (byte 0 4013) contains the value C4H. Byte 1 4015 includes in bits[7:5] “R,” “X,” and “B” which are the complements of the same values of the first prefix 3601(A). Bits[4:0] of byte 1 4015 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 4017 is used similar to W of the first prefix 3601(A) including helping to determine promotable operand sizes. Bit[2] is used to dictate the length (L) of the vector (where a value of 0 is a scalar or 128-bit vector and a value of 1 is a 256-bit vector). Bits[1:0]provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 3746 to encode the instruction operand that references a memory address or encode either the destination register operand or a source register operand.

Instructions that use this prefix may use the MOD R/M reg field 3744 to encode either the destination register operand or a source register operand, or to be treated as an opcode extension and not used to encode any instruction operand.

For instruction syntax that support four operands, vvvv, the MOD R/M R/M field 3746, and the MOD R/M reg field 3744 encode three of the four operands. Bits[7:4] of the immediate value field 3609 are then used to encode the third source register operand.

FIG. 41 illustrates examples of a third prefix 3601(C). In some examples, the third prefix 3601(C) is an example of an EVEX prefix. The third prefix 3601(C) is a four-byte prefix.

The third prefix 3601(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 35) or predication utilize this prefix.

Opmask register allow for conditional processing or selection control. Opmask instructions, whose source/destination operands are opmask registers and treat the content of an opmask register as a single value, are encoded using the second prefix 3601(B).

The third prefix 3601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 3601(C) is a format field 4111 that has a value, in some examples, of 62H. Subsequent bytes are referred to as payload bytes 4115-4119 and collectively form a 24-bit value of P[23:0] providing specific capability in the form of one or more fields (detailed herein).

In some examples, P[1:0] of payload byte 4119 are identical to the low two mm bits. P[3:2] are reserved in some examples. Bit P[4] (R′) allows access to the high 16 vector register set when combined with P[7] and the MOD R/M reg field 3744. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 3744 and MOD R/M R/M field 3746. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 3601(A) and second prefix 3611(B) and may serve as an opcode extension bit or operand size promotion.

P[18:16] specify the index of a register in the opmask (writemask) registers (e.g., writemask/predicate registers 3515). In some examples, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other some examples, preserving the old value of each element of the destination where the corresponding mask bit has a 0. In contrast, when zeroing vector masks allow any set of elements in the destination to be zeroed during the execution of any operation (specified by the base operation and the augmentation operation); in some examples, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20]encodes multiple functionalities, which differs across different classes of instructions and can affect the meaning of the vector length/rounding control specifier field (P[22:21]). P[23]indicates support for merging-writemasking (e.g., when set to 0) or support for zeroing and merging-writemasking (e.g., when set to 1).

Example examples of encoding of registers in instructions using the third prefix 3601(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

### Graphics Execution Units

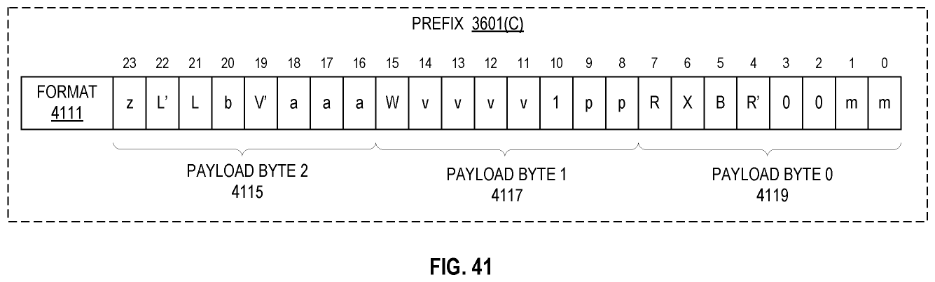

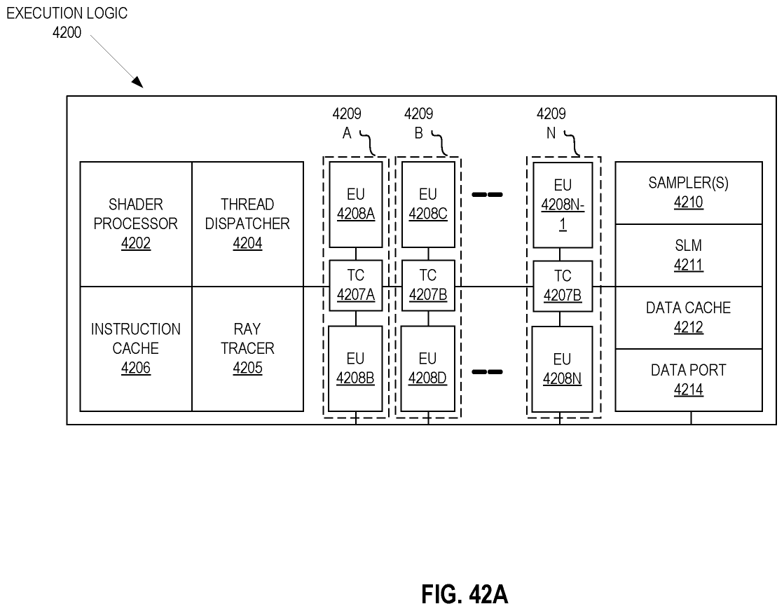

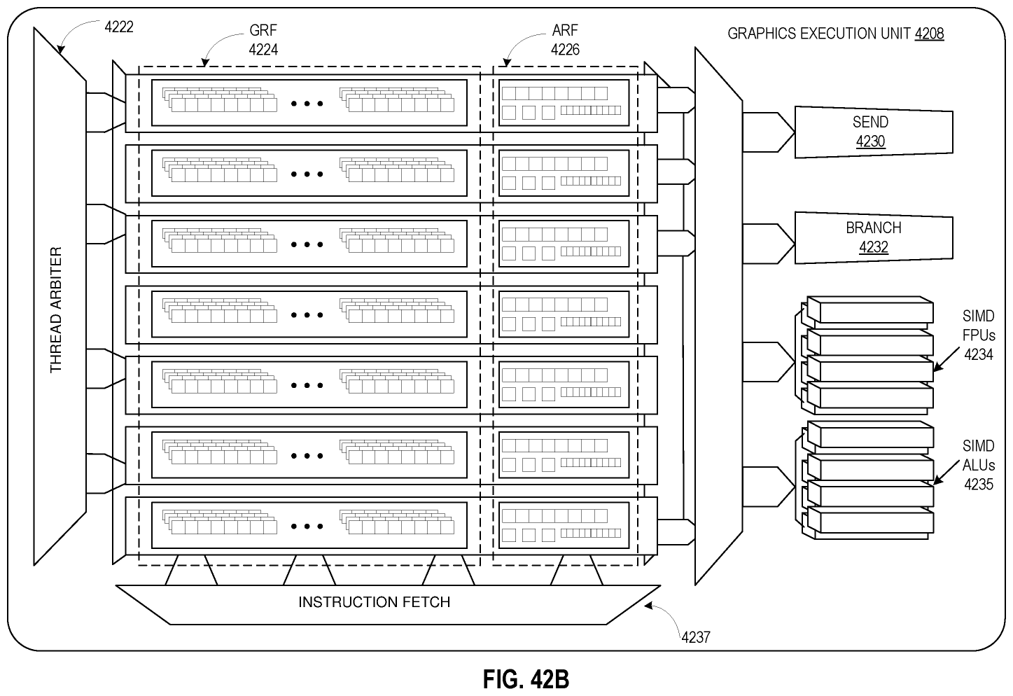

FIGS. 42A-42B illustrate thread execution logic 4200 including an array of processing elements employed in a graphics processor core according to examples described herein.

Elements of FIGS. 42A-42B having the same reference numbers (or names) as the elements of any other figure herein can operate or function in any manner similar to that described elsewhere herein, but are not limited to such. FIG. 42A is representative of an execution unit within a general-purpose graphics processor, while FIG. 42B is representative of an execution unit that may be used within a compute accelerator.

As illustrated in FIG. 42A, in some examples thread execution logic 4200 includes a shader processor 4202, a thread dispatcher 4204, instruction cache 4206, a scalable execution unit array including a plurality of execution units 4208A-4208N, a sampler 4210, shared local memory 4211, a data cache 4212, and a data port 4214. In some examples the scalable execution unit array can dynamically scale by enabling or disabling one or more execution units (e.g., any of execution units 4208A, 4208B, 4208C, 4208D, through 4208N-1 and 4208N) based on the computational requirements of a workload. In some examples the included components are interconnected via an interconnect fabric that links to each of the components. In some examples, thread execution logic 4200 includes one or more connections to memory, such as system memory or cache memory, through one or more of instruction cache 4206, data port 4214, sampler 4210, and execution units 4208A-4208N. In some examples, each execution unit (e.g. 4208A) is a stand-alone programmable general-purpose computational unit that is capable of executing multiple simultaneous hardware threads while processing multiple data elements in parallel for each thread. In various examples, the array of execution units 4208A-4208N is scalable to include any number individual execution units.

In some examples, the execution units 4208A-4208N are primarily used to execute shader programs. A shader processor 4202 can process the various shader programs and dispatch execution threads associated with the shader programs via a thread dispatcher 4204. In some examples the thread dispatcher includes logic to arbitrate thread initiation requests from the graphics and media pipelines and instantiate the requested threads on one or more execution unit in the execution units 4208A-4208N. For example, a geometry pipeline can dispatch vertex, tessellation, or geometry shaders to the thread execution logic for processing. In some examples, thread dispatcher 4204 can also process runtime thread spawning requests from the executing shader programs.

In some examples, the execution units 4208A-4208N support an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders). Each of the execution units 4208A-4208N is capable of multi-issue single instruction multiple data (SIMD) execution and multi-threaded operation enables an efficient execution environment in the face of higher latency memory accesses. Each hardware thread within each execution unit has a dedicated high-bandwidth register file and associated independent thread-state. Execution is multi-issue per clock to pipelines capable of integer, single and double precision floating point operations, SIMD branch capability, logical operations, transcendental operations, and other miscellaneous operations. While waiting for data from memory or one of the shared functions, dependency logic within the execution units 4208A-4208N causes a waiting thread to sleep until the requested data has been returned. While the waiting thread is sleeping, hardware resources may be devoted to processing other threads. For example, during a delay associated with a vertex shader operation, an execution unit can perform operations for a pixel shader, fragment shader, or another type of shader program, including a different vertex shader. Various examples can apply to use execution by use of Single Instruction Multiple Thread (SIMT) as an alternate to use of SIMD or in addition to use of SIMD. Reference to a SIMD core or operation can apply also to SIMT or apply to SIMD in combination with SIMT.

Each execution unit in execution units 4208A-4208N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some examples, execution units 4208A-4208N support integer and floating-point data types.

The execution unit instruction set includes SIMD instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

In some examples one or more execution units can be combined into a fused execution unit 4209A-4209N having thread control logic (4207A-4207N) that is common to the fused EUs. Multiple EUs can be fused into an EU group. Each EU in the fused EU group can be configured to execute a separate SIMD hardware thread. The number of EUs in a fused EU group can vary according to examples. Additionally, various SIMD widths can be performed per-EU, including but not limited to SIMD8, SIMD16, and SIMD32. Each fused graphics execution unit 4209A-4209N includes at least two execution units. For example, fused execution unit 4209A includes a first EU 4208A, second EU 4208B, and thread control logic 4207A that is common to the first EU 4208A and the second EU 4208B. The thread control logic 4207A controls threads executed on the fused graphics execution unit 4209A, allowing each EU within the fused execution units 4209A-4209N to execute using a common instruction pointer register.

One or more internal instruction caches (e.g., 4206) are included in the thread execution logic 4200 to cache thread instructions for the execution units. In some examples, one or more data caches (e.g., 4212) are included to cache thread data during thread execution. Threads executing on the execution logic 4200 can also store explicitly managed data in the shared local memory 4211. In some examples, a sampler 4210 is included to provide texture sampling for 3D operations and media sampling for media operations. In some examples, sampler 4210 includes specialized texture or media sampling functionality to process texture or media data during the sampling process before providing the sampled data to an execution unit.

During execution, the graphics and media pipelines send thread initiation requests to thread execution logic 4200 via thread spawning and dispatch logic. Once a group of geometric objects has been processed and rasterized into pixel data, pixel processor logic (e.g., pixel shader logic, fragment shader logic, etc.) within the shader processor 4202 is invoked to further compute output information and cause results to be written to output surfaces (e.g., color buffers, depth buffers, stencil buffers, etc.). In some examples, a pixel shader or fragment shader calculates the values of the various vertex attributes that are to be interpolated across the rasterized object. In some examples, pixel processor logic within the shader processor 4202 then executes an application programming interface (API)-supplied pixel or fragment shader program. To execute the shader program, the shader processor 4202 dispatches threads to an execution unit (e.g., 4208A) via thread dispatcher 4204. In some examples, shader processor 4202 uses texture sampling logic in the sampler 4210 to access texture data in texture maps stored in memory. Arithmetic operations on the texture data and the input geometry data compute pixel color data for each geometric fragment, or discards one or more pixels from further processing.

In some examples, the data port 4214 provides a memory access mechanism for the thread execution logic 4200 to output processed data to memory for further processing on a graphics processor output pipeline. In some examples, the data port 4214 includes or couples to one or more cache memories (e.g., data cache 4212) to cache data for memory access via the data port.

In some examples, the execution logic 4200 can also include a ray tracer 4205 that can provide ray tracing acceleration functionality. The ray tracer 4205 can support a ray tracing instruction set that includes instructions/functions for ray generation.

FIG. 42B illustrates exemplary internal details of an execution unit 4208, according to examples. A graphics execution unit 4208 can include an instruction fetch unit 4237, a general register file array (GRF) 4224, an architectural register file array (ARF) 4226, a thread arbiter 4222, a send unit 4230, a branch unit 4232, a set of SIMD floating point units (FPUs) 4234, and in some examples a set of dedicated integer SIMD ALUs 4235. The GRF 4224 and ARF 4226 includes the set of general register files and architecture register files associated with each simultaneous hardware thread that may be active in the graphics execution unit 4208. In some examples, per thread architectural state is maintained in the ARF 4226, while data used during thread execution is stored in the GRF 4224. The execution state of each thread, including the instruction pointers for each thread, can be held in thread-specific registers in the ARF 4226.

In some examples the graphics execution unit 4208 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per execution unit, where execution unit resources are divided across logic used to execute multiple simultaneous threads. The number of logical threads that may be executed by the graphics execution unit 4208 is not limited to the number of hardware threads, and multiple logical threads can be assigned to each hardware thread.

In some examples, the graphics execution unit 4208 can co-issue multiple instructions, which may each be different instructions. The thread arbiter 4222 of the graphics execution unit thread 4208 can dispatch the instructions to one of the send unit 4230, branch unit 4232, or SIMD FPU(s) 4234 for execution. Each execution thread can access 128 general-purpose registers within the GRF 4224, where each register can store 32 bytes, accessible as a SIMD 8-element vector of 32-bit data elements. In some examples, each execution unit thread has access to 4 Kbytes within the GRF 4224, although examples are not so limited, and greater or fewer register resources may be provided in other examples. In some examples the graphics execution unit 4208 is partitioned into seven hardware threads that can independently perform computational operations, although the number of threads per execution unit can also vary according to examples. For example, in some examples up to 16 hardware threads are supported. In an example in which seven threads may access 4 Kbytes, the GRF 4224 can store a total of 28 Kbytes. Where 16 threads may access 4Kbytes, the GRF 4224 can store a total of 64Kbytes. Flexible addressing modes can permit registers to be addressed together to build effectively wider registers or to represent strided rectangular block data structures.

In some examples, memory operations, sampler operations, and other longer-latency system communications are dispatched via “send” instructions that are executed by the message passing send unit 4230. In some examples, branch instructions are dispatched to a dedicated branch unit 4232 to facilitate SIMD divergence and eventual convergence.

In some examples the graphics execution unit 4208 includes one or more SIMD floating point units (FPU(s)) 4234 to perform floating-point operations. In some examples, the FPU(s) 4234 also support integer computation. In some examples the FPU(s) 4234 can SIMD execute up to M number of 32-bit floating-point (or integer) operations, or SIMD execute up to 2M 16-bit integer or 16-bit floating-point operations. In some examples, at least one of the FPU(s) provides extended math capability to support high-throughput transcendental math functions and double precision 64-bit floating-point. In some examples, a set of 8-bit integer SIMD ALUs 4235 are also present, and may be specifically optimized to perform operations associated with machine learning computations.

In some examples, arrays of multiple instances of the graphics execution unit 4208 can be instantiated in a graphics sub-core grouping (e.g., a sub-slice). For scalability, product architects can choose the exact number of execution units per sub-core grouping. In some examples the execution unit 4208 can execute instructions across a plurality of execution channels. In a further example, each thread executed on the graphics execution unit 4208 is executed on a different channel.

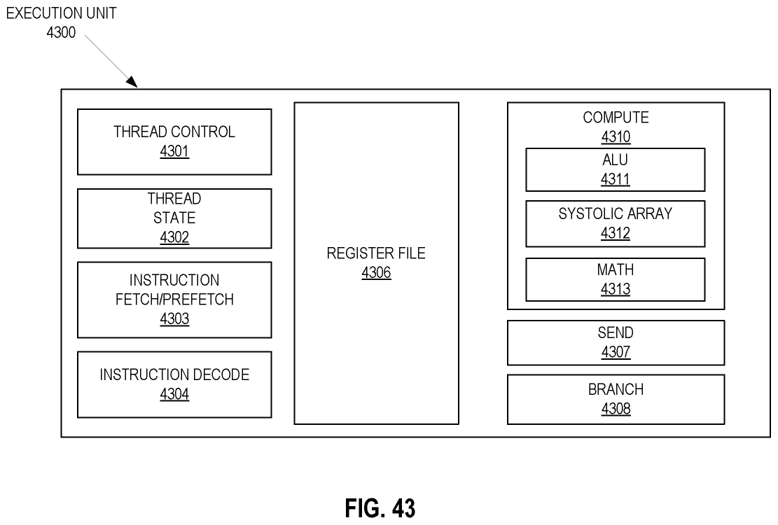

FIG. 43 illustrates an additional execution unit 4300, according to an example. In some examples, the execution unit 4300 includes a thread control unit 4301, a thread state unit 4302, an instruction fetch/prefetch unit 4303, and an instruction decode unit 4304. The execution unit 4300 additionally includes a register file 4306 that stores registers that can be assigned to hardware threads within the execution unit. The execution unit 4300 additionally includes a send unit 4307 and a branch unit 4308. In some examples, the send unit 4307 and branch unit 4308 can operate similarly as the send unit 4230 and a branch unit 4232 of the graphics execution unit 4208 of FIG. 42B.

The execution unit 4300 also includes a compute unit 4310 that includes multiple different types of functional units. In some examples the compute unit 4310 includes an ALU unit 4311 that includes an array of arithmetic logic units. The ALU unit 4311 can be configured to perform 64-bit, 32-bit, and 16-bit integer and floating point operations. Integer and floating point operations may be performed simultaneously. The compute unit 4310 can also include a systolic array 4312, and a math unit 4313. The systolic array 4312 includes a W wide and D deep network of data processing units that can be used to perform vector or other data-parallel operations in a systolic manner. In some examples the systolic array 4312 can be configured to perform matrix operations, such as matrix dot product operations. In some examples the systolic array 4312 support 16-bit floating point operations, as well as 8-bit and 4-bit integer operations.

In some examples the systolic array 4312 can be configured to accelerate machine learning operations. In such examples, the systolic array 4312 can be configured with support for the bfloat 16-bit floating point format. In some examples, a math unit 4313 can be included to perform a specific subset of mathematical operations in an efficient and lower-power manner than then ALU unit 4311. The math unit 4313 can include a variant of math logic that may be found in shared function logic of a graphics processing engine provided by other examples. In some examples the math unit 4313 can be configured to perform 32-bit and 64-bit floating point operations.

The thread control unit 4301 includes logic to control the execution of threads within the execution unit. The thread control unit 4301 can include thread arbitration logic to start, stop, and preempt execution of threads within the execution unit 4300. The thread state unit 4302 can be used to store thread state for threads assigned to execute on the execution unit 4300. Storing the thread state within the execution unit 4300 enables the rapid pre-emption of threads when those threads become blocked or idle. The instruction fetch/prefetch unit 4303 can fetch instructions from an instruction cache of higher level execution logic (e.g., instruction cache 4206 as in FIG. 42A). The instruction fetch/prefetch unit 4303 can also issue prefetch requests for instructions to be loaded into the instruction cache based on an analysis of currently executing threads. The instruction decode unit 4304 can be used to decode instructions to be executed by the compute units. In some examples, the instruction decode unit 4304 can be used as a secondary decoder to decode complex instructions into constituent micro-operations.

The execution unit 4300 additionally includes a register file 4306 that can be used by hardware threads executing on the execution unit 4300. Registers in the register file 4306 can be divided across the logic used to execute multiple simultaneous threads within the compute unit 4310 of the execution unit 4300. The number of logical threads that may be executed by the graphics execution unit 4300 is not limited to the number of hardware threads, and multiple logical threads can be assigned to each hardware thread. The size of the register file 4306 can vary across examples based on the number of supported hardware threads. In some examples, register renaming may be used to dynamically allocate registers to hardware threads.

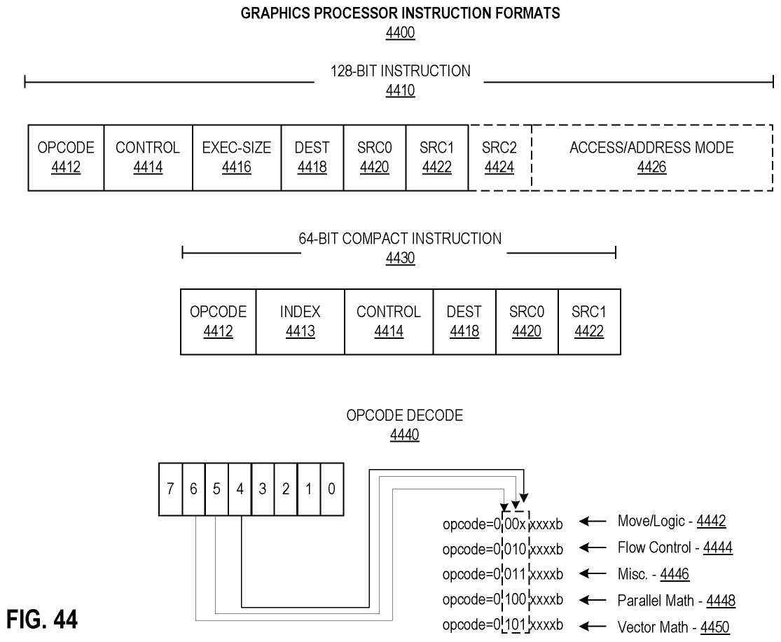

FIG. 44 is a block diagram illustrating a graphics processor instruction formats 4400 according to some examples. In one or more example, the graphics processor execution units support an instruction set having instructions in multiple formats. The solid lined boxes illustrate the components that are generally included in an execution unit instruction, while the dashed lines include components that are optional or that are only included in a sub-set of the instructions. In some examples, instruction format 4400 described and illustrated are macro-instructions, in that they are instructions supplied to the execution unit, as opposed to micro-operations resulting from instruction decode once the instruction is processed.

In some examples, the graphics processor execution units natively support instructions in a 128-bit instruction format 4410. A 64-bit compacted instruction format 4430 is available for some instructions based on the selected instruction, instruction options, and number of operands. The native 128-bit instruction format 4410 provides access to all instruction options, while some options and operations are restricted in the 64-bit format 4430. The native instructions available in the 64-bit format 4430 vary by example. In some examples, the instruction is compacted in part using a set of index values in an index field 4413. The execution unit hardware references a set of compaction tables based on the index values and uses the compaction table outputs to reconstruct a native instruction in the 128-bit instruction format 4410. Other sizes and formats of instruction can be used.

For each format, instruction opcode 4412 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some examples, instruction control field 4414 enables control over certain execution options, such as channels selection (e.g., predication) and data channel order (e.g., swizzle). For instructions in the 128-bit instruction format 4410 an exec-size field 4416 limits the number of data channels that will be executed in parallel. In some examples, exec-size field 4416 is not available for use in the 64-bit compact instruction format 4430.

Some execution unit instructions have up to three operands including two source operands, src0 4420, src1 4422, and one destination 4418. In some examples, the execution units support dual destination instructions, where one of the destinations is implied. Data manipulation instructions can have a third source operand (e.g., SRC2 4424), where the instruction opcode 4412 determines the number of source operands. An instruction's last source operand can be an immediate (e.g., hard-coded) value passed with the instruction.

In some examples, the 128-bit instruction format 4410 includes an access/address mode field 4426 specifying, for example, whether direct register addressing mode or indirect register addressing mode is used. When direct register addressing mode is used, the register address of one or more operands is directly provided by bits in the instruction.

In some examples, the 128-bit instruction format 4410 includes an access/address mode field 4426, which specifies an address mode and/or an access mode for the instruction. In some examples the access mode is used to define a data access alignment for the instruction. Some examples support access modes including a 16-byte aligned access mode and a 1-byte aligned access mode, where the byte alignment of the access mode determines the access alignment of the instruction operands. For example, when in a first mode, the instruction may use byte-aligned addressing for source and destination operands and when in a second mode, the instruction may use 16-byte-aligned addressing for all source and destination operands.

In some examples, the address mode portion of the access/address mode field 4426 determines whether the instruction is to use direct or indirect addressing. When direct register addressing mode is used bits in the instruction directly provide the register address of one or more operands. When indirect register addressing mode is used, the register address of one or more operands may be computed based on an address register value and an address immediate field in the instruction.

In some examples instructions are grouped based on opcode 4412 bit-fields to simplify Opcode decode 4440. For an 8-bit opcode, bits 4, 5, and 6 allow the execution unit to determine the type of opcode. The precise opcode grouping shown is merely an example. In some examples, a move and logic opcode group 4442 includes data movement and logic instructions (e.g., move (mov), compare (cmp)). In some examples, move and logic group 4442 shares the five most significant bits (MSB), where move (mov) instructions are in the form of 0000xxxxb and logic instructions are in the form of 0001xxxxb. A flow control instruction group 4444 (e.g., call, jump (jmp)) includes instructions in the form of 0010xxxxb (e.g., 0x20). A miscellaneous instruction group 4446 includes a mix of instructions, including synchronization instructions (e.g., wait, send) in the form of 0011xxxxb (e.g., 0x30). A parallel math instruction group 4448 includes component-wise arithmetic instructions (e.g., add, multiply (mul)) in the form of 0100xxxxb (e.g., 0x40). The parallel math group 4448 performs the arithmetic operations in parallel across data channels. The vector math group 4450 includes arithmetic instructions (e.g., dp4) in the form of 0101xxxxb (e.g., 0x50). The vector math group performs arithmetic such as dot product calculations on vector operands. The illustrated opcode decode 4440, in some examples, can be used to determine which portion of an execution unit will be used to execute a decoded instruction. For example, some instructions may be designated as systolic instructions that will be performed by a systolic array. Other instructions, such as ray-tracing instructions (not shown) can be routed to a ray-tracing core or ray-tracing logic within a slice or partition of execution logic.

### Graphics Pipeline

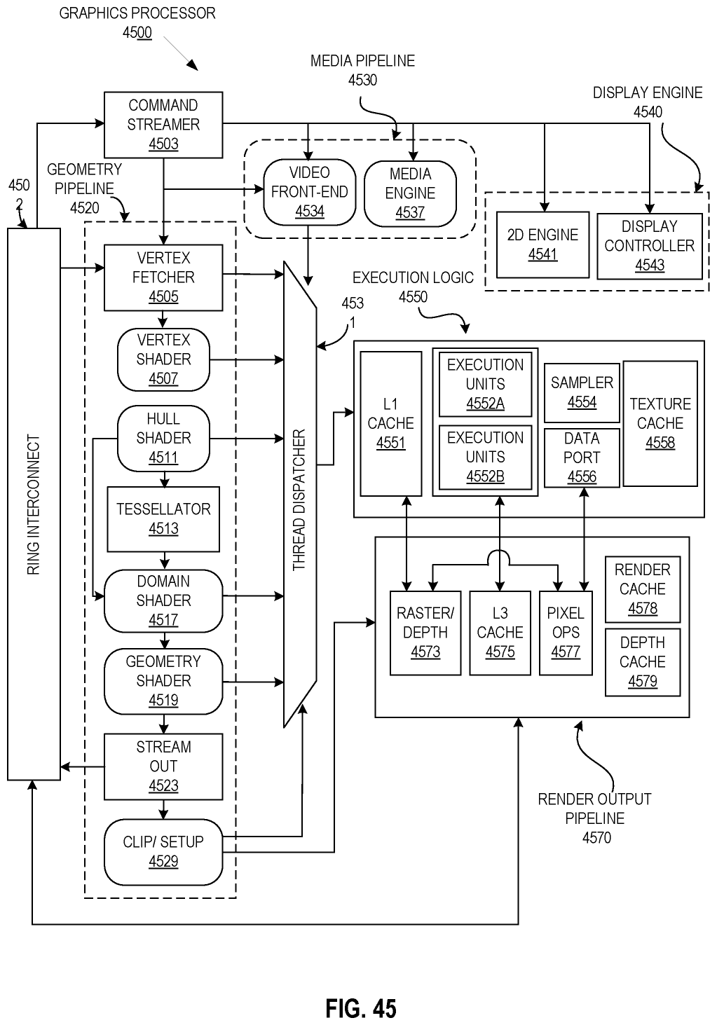

FIG. 45 is a block diagram of another example of a graphics processor 4500. Elements of FIG. 45 having the same reference numbers (or names) as the elements of any other figure herein can operate or function in any manner similar to that described elsewhere herein, but are not limited to such.

In some examples, graphics processor 4500 includes a geometry pipeline 4520, a media pipeline 4530, a display engine 4540, thread execution logic 4550, and a render output pipeline 4570. In some examples, graphics processor 4500 is a graphics processor within a multi-core processing system that includes one or more general-purpose processing cores. The graphics processor is controlled by register writes to one or more control registers (not shown) or via commands issued to graphics processor 4500 via a ring interconnect 4502. In some examples, ring interconnect 4502 couples graphics processor 4500 to other processing components, such as other graphics processors or general-purpose processors. Commands from ring interconnect 4502 are interpreted by a command streamer 4503, which supplies instructions to individual components of the geometry pipeline 4520 or the media pipeline 4530.

In some examples, command streamer 4503 directs the operation of a vertex fetcher 4505 that reads vertex data from memory and executes vertex-processing commands provided by command streamer 4503. In some examples, vertex fetcher 4505 provides vertex data to a vertex shader 4507, which performs coordinate space transformation and lighting operations to each vertex. In some examples, vertex fetcher 4505 and vertex shader 4507 execute vertex-processing instructions by dispatching execution threads to execution units 4552A-4552B via a thread dispatcher 4531.

In some examples, execution units 4552A-4552B are an array of vector processors having an instruction set for performing graphics and media operations. In some examples, execution units 4552A-4552B have an attached L1 cache 4551 that is specific for each array or shared between the arrays. The cache can be configured as a data cache, an instruction cache, or a single cache that is partitioned to contain data and instructions in different partitions.

In some examples, geometry pipeline 4520 includes tessellation components to perform hardware-accelerated tessellation of 3D objects. In some examples, a programmable hull shader 4511 configures the tessellation operations. A programmable domain shader 4517 provides back-end evaluation of tessellation output. A tessellator 4513 operates at the direction of hull shader 4511 and contains special purpose logic to generate a set of detailed geometric objects based on a coarse geometric model that is provided as input to geometry pipeline 4520. In some examples, if tessellation is not used, tessellation components (e.g., hull shader 4511, tessellator 4513, and domain shader 4517) can be bypassed.

In some examples, complete geometric objects can be processed by a geometry shader 4519 via one or more threads dispatched to execution units 4552A-4552B, or can proceed directly to the clipper 4529. In some examples, the geometry shader operates on entire geometric objects, rather than vertices or patches of vertices as in previous stages of the graphics pipeline. If the tessellation is disabled the geometry shader 4519 receives input from the vertex shader 4507. In some examples, geometry shader 4519 is programmable by a geometry shader program to perform geometry tessellation if the tessellation units are disabled.

Before rasterization, a clipper 4529 processes vertex data. The clipper 4529 may be a fixed function clipper or a programmable clipper having clipping and geometry shader functions. In some examples, a rasterizer and depth test component 4573 in the render output pipeline 4570 dispatches pixel shaders to convert the geometric objects into per pixel representations. In some examples, pixel shader logic is included in thread execution logic 4550. In some examples, an application can bypass the rasterizer and depth test component 4573 and access un-rasterized vertex data via a stream out unit 4523.

The graphics processor 4500 has an interconnect bus, interconnect fabric, or some other interconnect mechanism that allows data and message passing amongst the major components of the processor. In some examples, execution units 4552A-4552B and associated logic units (e.g., L1 cache 4551, sampler 4554, texture cache 4558, etc.) interconnect via a data port 4556 to perform memory access and communicate with render output pipeline components of the processor. In some examples, sampler 4554, caches 4551, 4558 and execution units 4552A-4552B each have separate memory access paths. In some examples the texture cache 4558 can also be configured as a sampler cache.

In some examples, render output pipeline 4570 contains a rasterizer and depth test component 4573 that converts vertex-based objects into an associated pixel-based representation. In some examples, the rasterizer logic includes a windower/masker unit to perform fixed function triangle and line rasterization. An associated render cache 4578 and depth cache 4579 are also available in some examples. A pixel operations component 4577 performs pixel-based operations on the data, though in some instances, pixel operations associated with 2D operations (e.g. bit block image transfers with blending) are performed by the 2D engine 4541, or substituted at display time by the display controller 4543 using overlay display planes. In some examples, a shared L3 cache 4575 is available to all graphics components, allowing the sharing of data without the use of main system memory.

In some examples, graphics processor media pipeline 4530 includes a media engine 4537 and a video front-end 4534. In some examples, video front-end 4534 receives pipeline commands from the command streamer 4503. In some examples, media pipeline 4530 includes a separate command streamer. In some examples, video front-end 4534 processes media commands before sending the command to the media engine 4537. In some examples, media engine 4537 includes thread spawning functionality to spawn threads for dispatch to thread execution logic 4550 via thread dispatcher 4531.

In some examples, graphics processor 4500 includes a display engine 4540. In some examples, display engine 4540 is external to processor 4500 and couples with the graphics processor via the ring interconnect 4502, or some other interconnect bus or fabric. In some examples, display engine 4540 includes a 2D engine 4541 and a display controller 4543. In some examples, display engine 4540 contains special purpose logic capable of operating independently of the 3D pipeline. In some examples, display controller 4543 couples with a display device (not shown), which may be a system integrated display device, as in a laptop computer, or an external display device attached via a display device connector.

In some examples, the geometry pipeline 4520 and media pipeline 4530 are configurable to perform operations based on multiple graphics and media programming interfaces and are not specific to any one application programming interface (API). In some examples, driver software for the graphics processor translates API calls that are specific to a particular graphics or media library into commands that can be processed by the graphics processor. In some examples, support is provided for the Open Graphics Library (OpenGL), Open Computing Language (OpenCL), and/or Vulkan graphics and compute API, all from the Khronos Group. In some examples, support may also be provided for the Direct3D library from the Microsoft Corporation. In some examples, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

### Graphics Pipeline Programming

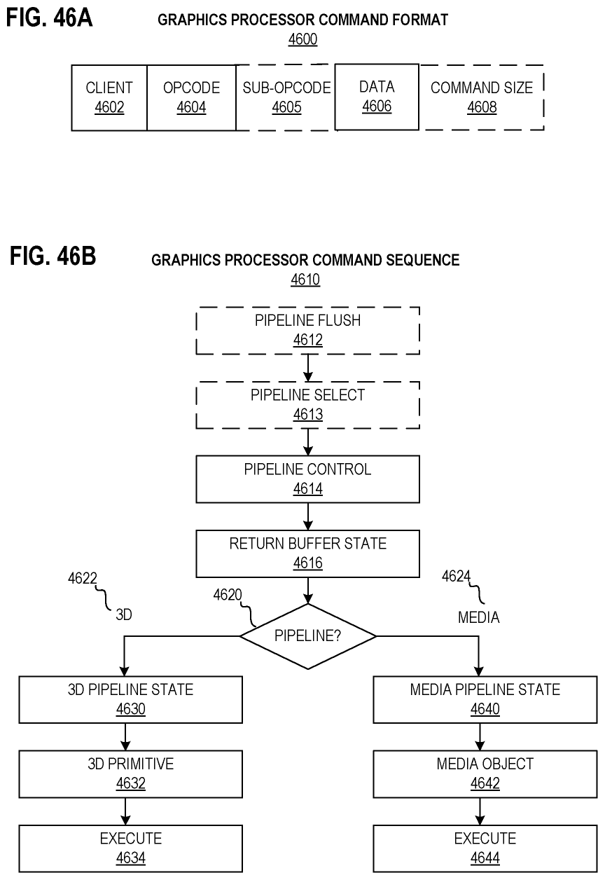

FIG. 46A is a block diagram illustrating a graphics processor command format 4600 according to some examples. FIG. 46B is a block diagram illustrating a graphics processor command sequence 4610 according to an example. The solid lined boxes in FIG. 46A illustrate the components that are generally included in a graphics command while the dashed lines include components that are optional or that are only included in a sub-set of the graphics commands. The exemplary graphics processor command format 4600 of FIG. 46A includes data fields to identify a client 4602, a command operation code (opcode) 4604, and data 4606 for the command. A sub-opcode 4605 and a command size 4608 are also included in some commands.

In some examples, client 4602 specifies the client unit of the graphics device that processes the command data. In some examples, a graphics processor command parser examines the client field of each command to condition the further processing of the command and route the command data to the appropriate client unit. In some examples, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 4604 and, if present, sub-opcode 4605 to determine the operation to perform. The client unit performs the command using information in data field 4606. For some commands an explicit command size 4608 is expected to specify the size of the command. In some examples, the command parser automatically determines the size of at least some of the commands based on the command opcode. In some examples commands are aligned via multiples of a double word. Other command formats can be used.

The flow diagram in FIG. 46B illustrates an exemplary graphics processor command sequence 4610. In some examples, software or firmware of a data processing system that features an example of a graphics processor uses a version of the command sequence shown to set up, execute, and terminate a set of graphics operations. A sample command sequence is shown and described for purposes of example only as examples are not limited to these specific commands or to this command sequence. Moreover, the commands may be issued as batch of commands in a command sequence, such that the graphics processor will process the sequence of commands in at least partially concurrence.

In some examples, the graphics processor command sequence 4610 may begin with a pipeline flush command 4612 to cause any active graphics pipeline to complete the currently pending commands for the pipeline. In some examples, the 3D pipeline 4622 and the media pipeline 4624 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some examples, pipeline flush command 4612 can be used for pipeline synchronization or before placing the graphics processor into a low power state.

In some examples, a pipeline select command 4613 is used when a command sequence requires the graphics processor to explicitly switch between pipelines. In some examples, a pipeline select command 4613 is required only once within an execution context before issuing pipeline commands unless the context is to issue commands for both pipelines. In some examples, a pipeline flush command 4612 is required immediately before a pipeline switch via the pipeline select command 4613.

In some examples, a pipeline control command 4614 configures a graphics pipeline for operation and is used to program the 3D pipeline 4622 and the media pipeline 4624. In some examples, pipeline control command 4614 configures the pipeline state for the active pipeline. In some examples, the pipeline control command 4614 is used for pipeline synchronization and to clear data from one or more cache memories within the active pipeline before processing a batch of commands.

In some examples, return buffer state commands 4616 are used to configure a set of return buffers for the respective pipelines to write data. Some pipeline operations require the allocation, selection, or configuration of one or more return buffers into which the operations write intermediate data during processing. In some examples, the graphics processor also uses one or more return buffers to store output data and to perform cross thread communication. In some examples, the return buffer state 4616 includes selecting the size and number of return buffers to use for a set of pipeline operations.

The remaining commands in the command sequence differ based on the active pipeline for operations. Based on a pipeline determination 4620, the command sequence is tailored to the 3D pipeline 4622 beginning with the 3D pipeline state 4630 or the media pipeline 4624 beginning at the media pipeline state 4640.

The commands to configure the 3D pipeline state 4630 include 3D state setting commands for vertex buffer state, vertex element state, constant color state, depth buffer state, and other state variables that are to be configured before 3D primitive commands are processed. The values of these commands are determined at least in part based on the particular 3D API in use. In some examples, 3D pipeline state 4630 commands are also able to selectively disable or bypass certain pipeline elements if those elements will not be used.

In some examples, 3D primitive 4632 command is used to submit 3D primitives to be processed by the 3D pipeline. Commands and associated parameters that are passed to the graphics processor via the 3D primitive 4632 command are forwarded to the vertex fetch function in the graphics pipeline. The vertex fetch function uses the 3D primitive 4632 command data to generate vertex data structures. The vertex data structures are stored in one or more return buffers. In some examples, 3D primitive 4632 command is used to perform vertex operations on 3D primitives via vertex shaders. To process vertex shaders, 3D pipeline 4622 dispatches shader execution threads to graphics processor execution units.

In some examples, 3D pipeline 4622 is triggered via an execute 4634 command or event. In some examples, a register write triggers command execution. In some examples execution is triggered via a ‘go’ or ‘kick’ command in the command sequence. In some examples, command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some examples, the graphics processor command sequence 4610 follows the media pipeline 4624 path when performing media operations. In general, the specific use and manner of programming for the media pipeline 4624 depends on the media or compute operations to be performed. Specific media decode operations may be offloaded to the media pipeline during media decode. In some examples, the media pipeline can also be bypassed and media decode can be performed in whole or in part using resources provided by one or more general-purpose processing cores. In some examples, the media pipeline also includes elements for general-purpose graphics processor unit (GPGPU) operations, where the graphics processor is used to perform SIMD vector operations using computational shader programs that are not explicitly related to the rendering of graphics primitives.

In some examples, media pipeline 4624 is configured in a similar manner as the 3D pipeline 4622. A set of commands to configure the media pipeline state 4640 are dispatched or placed into a command queue before the media object commands 4642. In some examples, commands for the media pipeline state 4640 include data to configure the media pipeline elements that will be used to process the media objects. This includes data to configure the video decode and video encode logic within the media pipeline, such as encode or decode format. In some examples, commands for the media pipeline state 4640 also support the use of one or more pointers to “indirect” state elements that contain a batch of state settings.

In some examples, media object commands 4642 supply pointers to media objects for processing by the media pipeline. The media objects include memory buffers containing video data to be processed. In some examples, all media pipeline states must be valid before issuing a media object command 4642. Once the pipeline state is configured and media object commands 4642 are queued, the media pipeline 4624 is triggered via an execute command 4644 or an equivalent execute event (e.g., register write). Output from media pipeline 4624 may then be post processed by operations provided by the 3D pipeline 4622 or the media pipeline 4624. In some examples, GPGPU operations are configured and executed in a similar manner as media operations.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

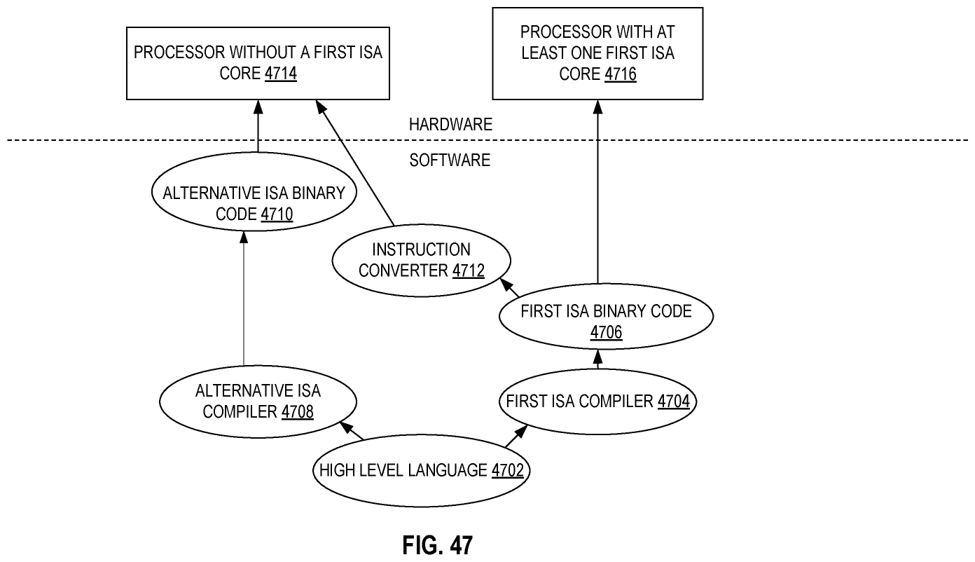

FIG. 47 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 47 shows a program in a high-level language 4702 may be compiled using a first ISA compiler 4704 to generate first ISA binary code 4706 that may be natively executed by a processor with at least one first ISA core 4716. The processor with at least one first ISA core 4716 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 4704 represents a compiler that is operable to generate first ISA binary code 4706 (e.g., object code) that can, with or without additional linkage processing, be executed on the processor with at least one first ISA core 4716. Similarly, FIG. 47 shows the program in the high-level language 4702 may be compiled using an alternative ISA compiler 4708 to generate alternative ISA binary code 4710 that may be natively executed by a processor without a first ISA core 4714. The instruction converter 4712 is used to convert the first ISA binary code 4706 into code that may be natively executed by the processor without a first ISA core 4714. This converted code is not necessarily to be the same as the alternative ISA binary code 4710; however, the converted code will accomplish the general operation and be made up of instructions from the alternative ISA. Thus, the instruction converter 4712 represents software, firmware, hardware, or a combination thereof that, through emulation, simulation or any other process, allows a processor or other electronic device that does not have a first ISA processor or core to execute the first ISA binary code 4706.

### IP Core Implementations

One or more aspects of at least some examples may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the examples described herein.

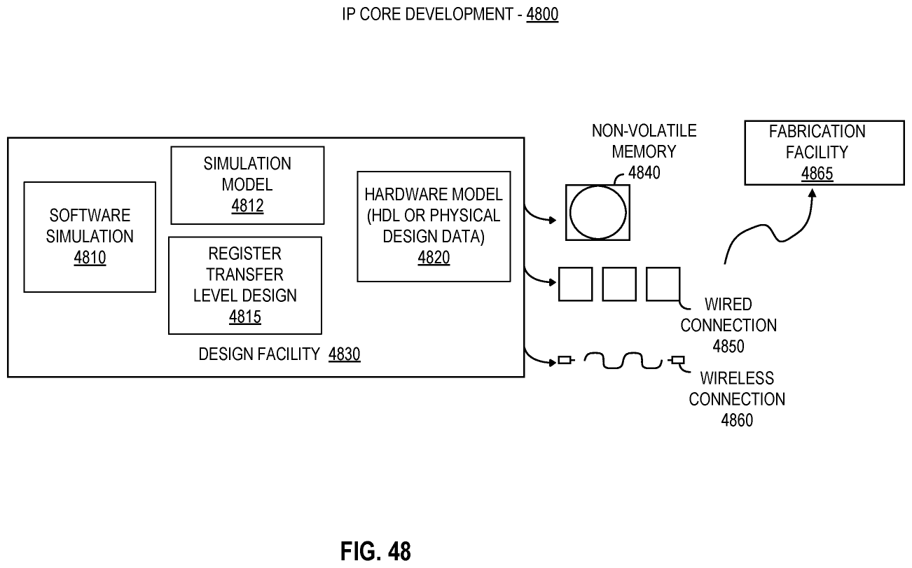

FIG. 48 is a block diagram illustrating an IP core development system 4800 that may be used to manufacture an integrated circuit to perform operations according to some examples. The IP core development system 4800 may be used to generate modular, re-usable designs that can be incorporated into a larger design or used to construct an entire integrated circuit (e.g., an SOC integrated circuit). A design facility 4830 can generate a software simulation 4810 of an IP core design in a high-level programming language (e.g., C/C++). The software simulation 4810 can be used to design, test, and verify the behavior of the IP core using a simulation model 4812. The simulation model 4812 may include functional, behavioral, and/or timing simulations. A register transfer level (RTL) design 4815 can then be created or synthesized from the simulation model 4812. The RTL design 4815 is an abstraction of the behavior of the integrated circuit that models the flow of digital signals between hardware registers, including the associated logic performed using the modeled digital signals. In addition to an RTL design 4815, lower-level designs at the logic level or transistor level may also be created, designed, or synthesized. Thus, the particular details of the initial design and simulation may vary.

The RTL design 4815 or equivalent may be further synthesized by the design facility into a hardware model 4820, which may be in a hardware description language (HDL), or some other representation of physical design data. The HDL may be further simulated or tested to verify the IP core design. The IP core design can be stored for delivery to a 3^{rd} party fabrication facility 4865 using non-volatile memory 4840 (e.g., hard disk, flash memory, or any non-volatile storage medium). Alternatively, the IP core design may be transmitted (e.g., via the Internet) over a wired connection 4850 or wireless connection 4860. The fabrication facility 4865 may then fabricate an integrated circuit that is based at least in part on the IP core design. The fabricated integrated circuit can be configured to perform operations in accordance with at least some examples described herein.

Examples include, but are not limited to:
1. An apparatus comprising:
   at least one reconfigurable butterfly datapath comprising:
      a multiplier coupled to a first input and a second input to multiply the first and second input to, when enabled, generate a multiplication output,
      a first multiplexer coupled to an output of the multiplier and to the first input to output a selection between the output of the multiplier and the first input,
      an adder to add, when enabled, a third input to the selected output of the first multiplexer,
      a subtractor to subtract, when enabled, an output of the multiplier from the third input, and
      a second multiplexer coupled to an output of the multiplier and to the first input to, when enabled, output a selection between the output of the multiplier and the subtractor; and
   memory to store one or more inputs.
2. The apparatus of example 1, wherein to perform modular addition, only the first multiplexer and the adder are enabled.
3. The apparatus of example 1, wherein to perform modular multiplication, only the second multiplexer and the multiplier are enabled.
4. The apparatus of example 3, wherein the multiplier is a modified Montgomery multiplier that is to utilize a modulus having a property of 1 mod 2′.
5. The apparatus of example 4, wherein the modified Montgomery multiplier is to not use carry propagation.
6. The apparatus of any of examples 1-5, wherein the multiplier is to use a carry-save format.
7. The apparatus of example 1, wherein to perform modular multiply-accumulate, only the first multiplexer, the adder, and the multiplier are enabled.
8. The apparatus of any of examples 1-7, wherein the adder is a carry-save adder.
9. The apparatus of any of examples 1-8, further comprising decoder circuitry configured to decode instances one or more polynomial-based instructions.
10. The apparatus of example 9, wherein one of the one or more polynomial-based instructions is a polynomial load instruction to load data from memory into a register file of the apparatus.
11. The apparatus of example 9, wherein one of the one or more polynomial-based instructions is a polynomial load instruction to load data from external memory into memory of the apparatus.
12. The apparatus of example 9, wherein one of the one or more polynomial-based instructions is a polynomial store instruction to store data to external memory from the apparatus.
13. The apparatus of example 9, wherein one of the one or more polynomial-based instructions is a polynomial addition instruction to add two polynomials using at least one reconfigurable butterfly datapath.
14. The apparatus of example 9, wherein one of the one or more polynomial-based instructions is a polynomial multiplication instruction to multiply two polynomials using at least one reconfigurable butterfly datapath.
15. The apparatus of example 9, wherein one of the one or more polynomial-based instructions is a polynomial Number Theoretic Transform (NTT) multiplication instruction to perform a NTT operation using at least one reconfigurable butterfly datapath.
16. The apparatus of example 9, wherein one of the one or more polynomial-based instructions is a polynomial inverse Number Theoretic Transform (iNTT) multiplication instruction to perform a iNTT operation using at least one reconfigurable butterfly datapath.
17. The apparatus of any of examples 1-16, wherein the at least one reconfigurable butterfly datapath is a 32-bit datapath.
18. A system comprising:
   a processor core; and
   at least one reconfigurable butterfly datapath, that is a part of a fully homomorphic encryption accelerator coupled to the processor core, comprising:
      a multiplier coupled to a first input and a second input to multiply the first and second input to, when enabled, generate a multiplication output,
      a first multiplexer coupled to an output of the multiplier and to the first input to output a selection between the output of the multiplier and the first input,
      an adder to add, when enabled, a third input to the selected output of the first multiplexer,
      a subtractor to subtract, when enabled, an output of the multiplier from the third input, and
      a second multiplexer coupled to an output of the multiplier and to the first input to, when enabled, output a selection between the output of the multiplier and the subtractor.
19. The system of example 18, wherein the fully homomorphic encryption accelerator includes high-bandwidth memory.
20. The system of any of examples 18-19, further comprising high-bandwidth memory coupled to the fully homomorphic encryption accelerator.
21. An apparatus comprising:
   memory to store a plurality of data values; and
   a modified Montgomery multiplier to perform compute a modular product of a first value in a Montgomery domain by a second value in the Montgomery domain and reduce the product to be contained within a defined range based on a modulus, wherein the Montgomery multiplier comprises 1 2w-bit multiplier, 2 w-multipliers, 2 2's complement adders, and 2 w-bit adders.
22. The apparatus of example 21, wherein the memory is a register file.
23. The apparatus of any of examples 21-22, wherein w is 16 bits.
24. The apparatus of any of examples 21-23, wherein to compute a modular product comprises a multiple-stage reduction w-bit reduction.
25. The apparatus of example 24, wherein the w-bit reduction stages are to use a carry-save format.
26. The apparatus of example 24, wherein the w-bit reduction stages at least comprise cascaded carry-save adders.
27. The apparatus of any of examples 21-26, wherein the Montgomery multiplier is a part of a datapath for a Number Theoretic Transform (NTT) operation.
28. The apparatus of any of examples 21-26, wherein the Montgomery multiplier is a part of a datapath for an inverse Number Theoretic Transform (iNTT) operation.
29. The apparatus of any of examples 21-26, wherein the Montgomery multiplier is a part of a datapath for performing polynomial multiply-accumulate.
30. The apparatus of any of examples 21-26, wherein the Montgomery multiplier is a part of a datapath for performing polynomial addition.
31. The apparatus of any of examples 21-26, wherein the Montgomery multiplier is a part of a datapath for a wherein the Montgomery multiplier is a part of a datapath for performing polynomial multiplication.
32. The apparatus of any of examples 21-31, wherein the modulus (q) has a property that satisfies a constraint q mod 2^{w}=1.
33. The apparatus of any of examples 21-31, wherein the data values are to be in a double Chinese Remainder Theorem (CRT) format.
34. A system comprising:
   memory to store a plurality of input data values; and
   at least one reconfigurable butterfly datapath comprising:
      a multiplier coupled to a first input and a second input to multiply the first and second input to, when enabled, generate a multiplication output,
      a first multiplexer coupled to an output of the multiplier and to the first input to output a selection between the output of the multiplier and the first input,
      an adder to add, when enabled, a third input to the selected output of the first multiplexer,
      a subtractor to subtract, when enabled, an output of the multiplier from the third input, and
      a second multiplexer coupled to an output of the multiplier and to the first input to, when enabled, output a selection between the output of the multiplier and the subtractor, wherein the multiplier is a modified Montgomery multiplier to perform compute a modular product of a first value in a Montgomery domain by a second value in the Montgomery domain and reduce the product to be contained within a defined range based on a modulus, wherein the Montgomery multiplier comprises 1 2w-bit multiplier, 2 w-multipliers, 2 2's complement adders, and 2 w-bit adders.
35. The system of example 34, wherein the memory is a register file.
36. The system of any of examples 34-35, wherein w is 16 bits.
37. The system of any of examples 34-36, wherein to compute a modular product comprises multiple-stage reduction w-bit reduction.
38. The system of example 37, wherein the w-bit reduction stages are to use a carry-save format.
39. The system of any of examples 34-37, wherein the Montgomery multiplier is a part of a datapath for a Number Theoretic Transform (NTT) operation.
40. The system of any of examples 34-39, wherein the modulus (q) has a property that satisfies a constraint q mod 2^{w=1.}
41. An apparatus comprising:
   a register file to at least store polynomials to be processed; and
   a plurality of butterfly compute datapaths coupled to the register file to process stored polynomials comprising:
      a multiplier coupled to a first input and a second input to multiply the first and second input to, when enabled, generate a multiplication output,
      a first multiplexer coupled to an output of the multiplier and to the first input to, when enabled, output a selection between the output of the multiplier and the first input,
      an adder to add, when enabled, a third input to the selected output of the first multiplexer,
      a subtractor to subtract, when enabled, an output of the multiplier from the third input, and
      a second multiplexer coupled to an output of the multiplier and to the first input to, when enabled, output a selection between the output of the multiplier and the subtractor.
42. The apparatus of example 41, wherein the polynomials include operands to be operated on by the butterfly compute datapaths.
43. The apparatus of any of examples 41-42, wherein the polynomials include twiddle factors.
44. The apparatus of any of examples 41-43, wherein the polynomials include key information.
45. The apparatus of any of examples 41-44, wherein the register file is divided into dedicated banks for each reconfigurable butterfly compute unit.
46. The apparatus of example 45, wherein the dedicated banks and associated reconfigurable butterfly compute unit comprise a compute tile.
47. The apparatus of example 46, wherein a number of compute tiles is scalable.
48. The apparatus of any of examples 41-47, further comprising:
   scratchpad memory to provide and receive data to/from the register file.
49. The apparatus of example 48, further comprising:
   high-bandwidth memory to provide data to the register file or scratchpad memory.
50. The apparatus of example 48, wherein the scratchpad memory is to provide and receive data to/from register file banks of the register file are not servicing a butterfly compute unit.
51. The apparatus of any of examples 41-50, wherein the polynomial to be processed comprise ciphertexts.
52. The apparatus of example 51, wherein the ciphertexts are stored in a double-Chinese Remainder Theorem format.
53. A system comprising:
   a processor core to generate polynomials; and
   an accelerator coupled to the processor core, the accelerator at least comprising:
      a register file to at least store polynomials generated by the processor core to be processed; and
      a plurality of butterfly compute datapaths coupled to the register file to process stored polynomial values comprising:
         a multiplier coupled to a first input and a second input to multiply the first and second input to, when enabled, generate a multiplication output,
         a first multiplexer coupled to an output of the multiplier and to the first input to output a selection between the output of the multiplier and the first input,
         an adder to add, when enabled, a third input to the selected output of the first multiplexer,
         a subtractor to subtract, when enabled, an output of the multiplier from the third input, and
         a second multiplexer coupled to an output of the multiplier and to the first input to, when enabled, output a selection between the output of the multiplier and the subtractor.
54. The system of example 53, wherein the polynomials include operands to be operated on by the butterfly compute datapaths.
55. The system of any of examples 53-54, wherein the polynomials include twiddle factors.
56. The system of any of examples 53-55, wherein the polynomials include key information.
57. The system of any of examples 53-56, wherein the register file is divided into dedicated banks for each reconfigurable butterfly compute unit.
58. The system of example 57, wherein the dedicated banks and associated reconfigurable butterfly compute unit comprise a compute tile.
59. The system of example 58, wherein a number of compute tiles is scalable.
60. The system of any of examples 53-59, wherein the polynomials include ciphertexts are stored in a double-Chinese Remainder Theorem format.
61. An apparatus comprising:
   a first Number Theoretic Transforms (NTT)-based network comprising a plurality of coupled butterfly datapaths to generate an intermediate output in a first order;
   bit reversal logic to bit reverse the intermediate output into a second order input; and
   a second NTT-based network, coupled to the bit reversal logic, comprising a plurality of coupled butterfly datapaths to generate a final output from the second order input.
62. The apparatus of example 61, wherein the first NTT-based network and the second NTT-based network are to implement decimation-in-time (DIT) operations.
63. The apparatus of example 62, wherein the butterfly datapaths logically comprise:
   a multiplier coupled to a first input and a second input to multiply the first and second input to generate a multiplication output,
   an adder to add a third input to the multiplication output, and
   a subtractor to subtract an output of the multiplier from the third input.
64. The apparatus of example 61, wherein the first NTT-based network and the second NTT-based network are to implement decimation-in-frequency (DIF) operations.
65. The apparatus of example 62, wherein the butterfly datapaths logically comprise:
   an adder to add a first input to a second input,
   a subtractor to subtract the second input from the first input, and
   a multiplier coupled to subtractor to multiply an output from the subtractor to a third input.
66. The apparatus of any of examples 61-65, wherein the NTT-based networks comprise three stages with each stage comprising four butterfly datapaths.
67. The apparatus of example 66, wherein the bit reversal logic is an implicit reordering based on reading bit-reversed values from a local register file.
68. The apparatus of example 67, wherein the local register file is divided into a plurality of banks.
69. The apparatus of example 68, wherein which of the plurality of banks to read from is determined by the stage.
70. The apparatus of any of examples 61-69, wherein the butterfly datapaths are modular.
71. The apparatus of any of examples 61-70, wherein the bit reversal logic is circuitry.
72. A system comprising:
   memory to store input data;
   a first Number Theoretic Transforms (NTT)-based network comprising a plurality of coupled butterfly datapaths to generate an intermediate output in a first order from the input data;
   bit reversal logic to bit reverse the intermediate output into a second order input; and
   a second NTT-based network, coupled to the bit reversal circuitry, comprising a plurality of coupled butterfly datapaths to generate a final output from the second order input.
73. The system of example 72, wherein the first NTT-based network and the second NTT-based network are to implement decimation-in-time (DIT) operations.
74. The system of example 73, wherein the butterfly datapaths logically comprise:
   a multiplier coupled to a first input and a second input to multiply the first and second input to generate a multiplication output,
   an adder to add a third input to the multiplication output, and
   a subtractor to subtract an output of the multiplier from the third input.
75. The system of example 72, the first NTT-based network and the second NTT-based network are to implement decimation-in-frequency (DIF) operations.
76. The system of example 75, wherein the butterfly datapaths logically comprise:
   an adder to add a first input to a second input,
   a subtractor to subtract the second input from the first input, and
   a multiplier coupled to subtractor to multiply an output from the subtractor to a third input.
77. The system of any of examples 72-76, wherein the NTT-based networks comprise three stages with each stage comprising four butterfly datapaths.
78. The system of example 77, wherein the bit reversal logic is an implicit reordering based on reading bit-reversed values from a local register file.
79. The system of example 78, wherein the local register file is divided into a plurality of banks.
80. The system of any of examples 72-79, wherein the butterfly datapaths are modular.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
a register file to at least store polynomials to be processed; and
a plurality of butterfly compute datapaths coupled to the register file to process the polynomials comprising:
a multiplier coupled to a first input and a second input to multiply the first and second input to, when enabled, generate a multiplication output,
a first multiplexer coupled to an output of the multiplier and to the first input to, when enabled, output a selection between the output of the multiplier and the first input,
an adder to add, when enabled, a third input to the selected output of the first multiplexer,
a subtractor to subtract, when enabled, an output of the multiplier from the third input, and
a second multiplexer coupled to an output of the multiplier and to the first input to, when enabled, output a selection between the output of the multiplier and the subtractor.

2. The apparatus of claim 1, wherein the polynomials include operands to be operated on by the butterfly compute datapaths.

3. The apparatus of claim 1, wherein the polynomials include twiddle factors.

4. The apparatus of claim 1, wherein the polynomials include key information.

5. The apparatus of claim 1, wherein the register file is divided into dedicated banks for each reconfigurable butterfly compute unit.

6. The apparatus of claim 5, wherein the dedicated banks and associated reconfigurable butterfly compute unit comprise a compute tile.

7. The apparatus of claim 6, wherein a number of compute tiles is scalable.

8. The apparatus of claim 1, further comprising:
scratchpad memory to provide and receive data to/from the register file.

9. The apparatus of claim 8, further comprising:
high-bandwidth memory to provide data to the register file or scratchpad memory.

10. The apparatus of claim 8, wherein the scratchpad memory is to provide and receive data to/from register file banks of the register file are not servicing a butterfly compute unit.

11. The apparatus of claim 1, wherein the polynomial to be processed comprise ciphertexts.

12. The apparatus of claim 11, wherein the ciphertexts are stored in a double-Chinese Remainder Theorem format.

13. A system comprising:
a processor core to generate polynomials; and
an accelerator coupled to the processor core, the accelerator at least comprising:
a register file to at least store polynomials generated by the processor core to be processed; and
a plurality of butterfly compute datapaths coupled to the register file to process stored polynomial values comprising:
a multiplier coupled to a first input and a second input to multiply the first and second input to, when enabled, generate a multiplication output,
a first multiplexer coupled to an output of the multiplier and to the first input to output a selection between the output of the multiplier and the first input,
an adder to add, when enabled, a third input to the selected output of the first multiplexer,
a subtractor to subtract, when enabled, an output of the multiplier from the third input, and
a second multiplexer coupled to an output of the multiplier and to the first input to, when enabled, output a selection between the output of the multiplier and the subtractor.

14. The system of claim 13, wherein the polynomials include operands to be operated on by the butterfly compute datapaths.

15. The system of claim 13, wherein the polynomials include twiddle factors.

16. The system of claim 13, wherein the polynomials include key information.

17. The system of claim 13, wherein the register file is divided into dedicated banks for each reconfigurable butterfly compute unit.

18. The system of claim 17, wherein the dedicated banks and associated reconfigurable butterfly compute unit comprise a compute tile.

19. The system of claim 18, wherein a number of compute tiles is scalable.

20. The system of claim 13, wherein the polynomials include ciphertexts are stored in a double-Chinese Remainder Theorem format.
